(19) United States
(12) Patent Application Publication
(10) Pub. No.: US 2009/0163740 A1
(43) Pub. Date: Jun. 25, 2009

(54) LIGANDS FOR METALS AS CATALYSTS FOR CARBON-CARBON BOND FORMATION

(75) Inventor: Lan-Chang LIANG, Kaohsiung (TW)

Correspondence Address: LADAS & PARRY LLP, 26 WEST 61ST STREET, NEW YORK, NY, 10023, US

(73) Assignee: NATIONAL SUN YAT-SEN UNIVERSITY

(21) Appl. No.: 12/329,184

(22) Filed: Dec. 5, 2008

Related U.S. Application Data
(63) Continuation-in-part of application No. 10/875,071, filed on Jun. 23, 2004, now abandoned.

(51) Int. Cl. C07F 9/28

(52) U.S. Cl. 564/15

(57) ABSTRACT

The present invention provides a family of novel and stable ligands which chelate with a metal to form a complex. The ligand contains a t-butyl group or a ring, particularly a substituted aromatic group, linked to a nitrogen atom. The nitrogen atom further links to PR¹R², PR¹R²R⁹, P(═O)R¹R², NR¹R², OR¹, SR¹, or AsR¹R² group with a saturated or unsaturated hydrocarbon such that the structure of the ligand can be stabilized.

### BACKGROUND OF THE INVENTION

1. Field of the Invention

The present invention relates to a family of ligands which can form metal complexes that are suitable for catalyzing carbon-carbon bond formation between saturated and saturated, saturated and unsaturated, and unsaturated and unsaturated bonds.

2. Description of the Related Art

Metal complexes are commonly used as catalysts for unusual chemical transformation in chemical industry, petrochemical industry, pharmaceutical industry, lubricant material and polymer material. One remarkable example in this aspect is the chelating amido phosphine derivatives that contain the —SiMe₂CH₂— ligand backbone as depicted in formula i.

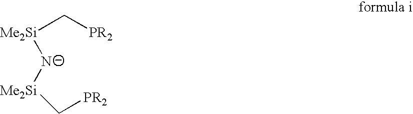

The tridentate ligands of this type have shown widespread reactivity with metals of the periodic table. These ligands, however, are prone to phosphine dissociation under certain circumstances due to the flexibility of the backbone. With the silyl linker, the ligands may become reactive, as cleavage of both N—Si and C—H bonds has been observed in the ligand depicted in formula i.

A ligand represented by the formula ii is disclosed in U.S. Pat. No. 6,395,916.

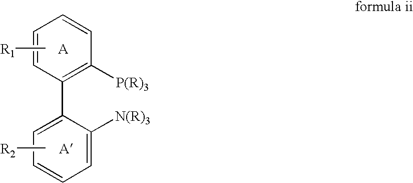

The amino group and phosphine groups are located in different phenyl group for stabling the linkage of the ligand by the electrons in the phenyl group.

A ligand represented by the formula iii is disclosed in U.S. Pat. No. 6,562,989,

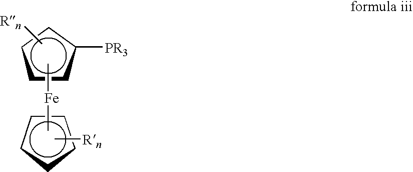

wherein the metal ion is linked to the two different rings for stabling the linkage of the ligand by the electrons in the rings.

Furthermore, a ligand represented by the formula iv is disclosed in U.S. Pat. No. 6,573,345,

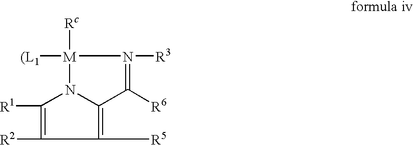

wherein the pyrrolyl group renders the linkage of the ligand stable. The ligand is mainly used for catalyzing olefin oligomerization and polymerization.

A series of ligands represented by the formulae Ia, Ib, and Ic are also disclosed by Yin (Yin, Metal Complex Containing Chelating Amidophosphine Ligands, Sep. 11, 2002). The ligand represented by the formula Ia is bis(2-diphenylphosphinophenyl)amine (H[PNP]):

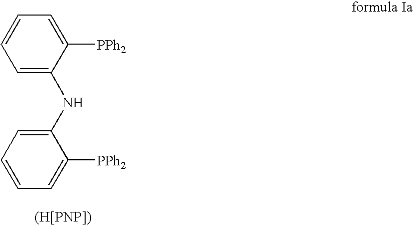

wherein Ph represents phenyl group.

The ligand represented by the formula Ib is N-(2-diphenylphosphinophenyl)-2,6-diisopropylaniline (H[NP], H[ⁱPr—NP]) or N-(2-diphenylphosphinophenyl)-2,6-dimethylaniline (H[Me-NP]):

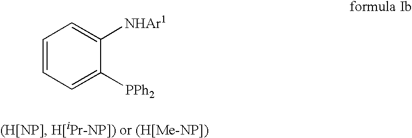

wherein:
Ar¹ represents 2,6-C₆H₃ⁱPr₂ or 2,6-C₆H₃Me₂;
Ph represents phenyl group;
ⁱPr represents isopropyl group; and
Me represents methyl group.

The ligand L represented by the formula Ic is shown below:

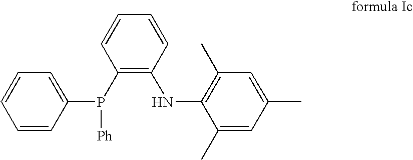

wherein Ph represents phenyl group.

### SUMMARY OF THE INVENTION

The present invention provides a family of novel and stable ligands which chelate with a metal to form a complex. The ligand contains a t-butyl group or a ring, particularly a substituted aromatic group, linked to a nitrogen atom. The nitrogen atom further links to PR¹R², PR²R⁹, P(═O)R¹R², NR¹R², OR¹, SR¹, or AsR¹R² group with a saturated or unsaturated hydrocarbon such that the structure of the ligand can be stabilized.

The ligand L according to the invention is represented by the following general formula I:

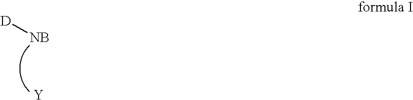

wherein:
B represents H or a bond;
D represents A ring or t-butyl group;
A represents a ring or heterocyclic ring, and said ring or heterocyclic ring is unsubstituted or substituted with Xⁿ;
Xⁿ for each occurrence independently represents one or more groups selected from the group consisting of hydrocarbons, PR¹R², NR¹R², OR¹, SR¹, and AsR¹R²;
Y represents a group selected from the group consisting of PR¹R², PR¹R²R⁹, P(═O)R¹R², NR¹R², OR¹, SR¹, and AsR¹R²;
n represents an integer larger than or equal to 1;
R¹, R² and R⁹ for each occurrence independently represent saturated or unsaturated hydrocarbon or aromatic groups with or without heteroatoms of O, S, N, P or As; and
the linkage between N—Y is a saturated or unsaturated hydrocarbon or aromatic group with or without substituents and
wherein; the ligand L is not (a) bis(2-diphenylphosphinophenyl)amine represented by the following formula Ia:

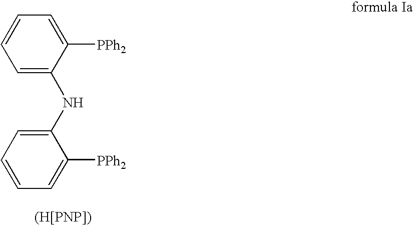

wherein Ph represents phenyl group; or
the ligand L is not (b)
N-(2-diphenylphosphinophenyl)-2,6-diisopropylaniline or
N-(2-diphenylphosphinophenyl)-2,6-dimethylaniline represented by the following formula Ib:

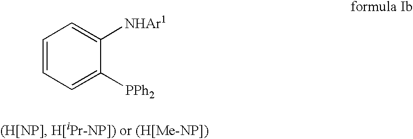

wherein:
Ar¹ represents 2,6-C₆H₃ⁱPr₂ or 2,6-C₆H₃Me₂;
Ph represents phenyl group;
ⁱPr represents isopropyl group; and
Me represents methyl group; or
the ligand L is not (c) represented by the following formula Ic:

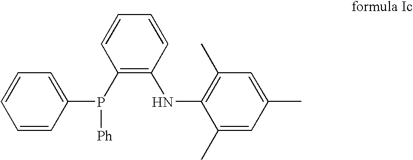

wherein Ph represents phenyl group.

The present invention also provides a method for synthesizing the ligand L comprising the steps of:
(a1) conducting a cross-coupling reaction of a bromine, iodine or chlorine substituted fluoride and a fluorine substituted amine to form an amine with multiple fluorine substituents; or

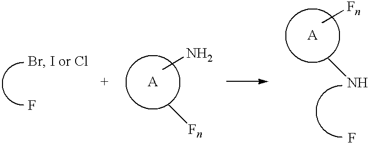

(a2) conducting a cross-coupling reaction of an iodine or chlorine substituted bromide and a bromine substituted amine to form an amine with multiple bromine substituents; and

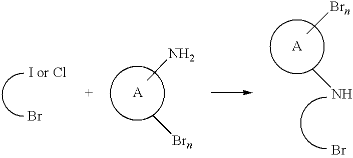

(b) conducting a nucleophilic reaction of the amine with multiple fluorine in (a1) or bromine substituents (a2), M²Xⁿ and M²Y to form the ligand represented by the formula I;
   wherein:
   the linkage between fluorine and bromine, iodine or chlorine of the fluoride in (a1), or the linkage between iodine or chlorine substituted bromide in (a2), is a saturated or unsaturated hydrocarbon or aromatic group with or without substituents;
   M² is a metal selected from the group consisting of Li, Na and K; and
   A, n, Xⁿ and Y are as defined as above.

A second method for synthesizing the ligand L according to the invention is also provided, which comprises the steps of:
(a) conducting a cross-coupling reaction of a bromine, iodine or chlorine substituted fluoride represented by the following formula IX and a substituted amine represented by the following formula X to form a compound represented by the following formula XI according to scheme IV; and

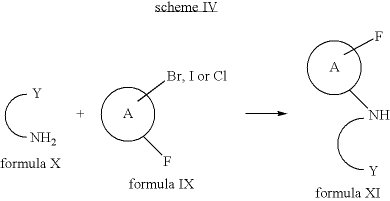

(b) conducting a nucleophilic reaction of the compound represented by the general formula XI, M²Xⁿ and M²Y to form the ligand represented by the formula I;
   wherein:
   the linkage between Y and NH₂ of the amine represented by formula X is a saturated or unsaturated hydrocarbon or aromatic group with or without substituents;
   M² is a metal selected from the group consisting of Li, Na and K; and
   A, n, Xⁿ and Y are as defined as above.

Also, the invention provides a third method for synthesizing the ligand L according to the invention comprising the steps of:
(a) conducting a cross-coupling reaction of a compound represented by the following formula XII and a compound represented by the following formula XIII to form a compound represented by the following formula XIV according to scheme V; and

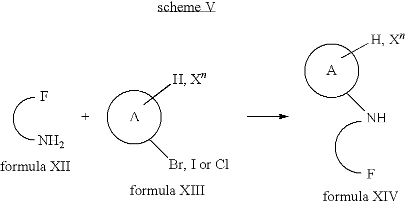

(b) conducting a nucleophilic reaction of the compound represented by the general formula XIV and M²Y to form the ligand represented by the formula I;
   wherein:
   the linkage between F and NH₂ of the compound represented by formula XII is a saturated or unsaturated hydrocarbon or aromatic group with or without substituents;
   M² is a metal selected from the group consisting of Li, Na and K; and
   A, n, Xⁿ and Y are as defined in ligand L.

The invention also provided a fourth method for synthesizing the ligand according to the invention comprising the steps of:
(a) conducting a cross-coupling reaction of a substituted amine represented by the following formula X and a compound represented by the following formula XV to form a compound represented by the following formula XVI according to scheme VI; and

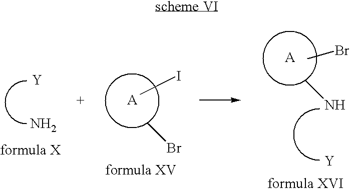

(b) reacting the compound represented by the general formula XVI with a base and then with Hal⁵Xⁿ to form the ligand represented by the formula I;
   wherein:
   the linkage between Y and NH₂ of the amine represented by formula X is a saturated or unsaturated hydrocarbon or aromatic group with or without substituents;
   Hal⁵ represents halogen; and
   A, n, Xⁿ and Y are as defined in ligand L.

The invention also provided a fifth method for synthesizing the ligand according to the invention comprising the steps depicted below:

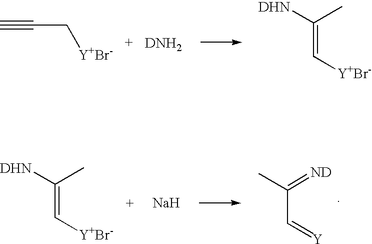

### BRIEF DESCRIPTION OF THE DRAWINGS

FIG. 1 illustrates the molecular structure of H[PNN] represented by formula Id.

FIG. 2 illustrates the molecular structure of [NP]₂Zn.

FIG. 3 illustrates the molecular structure of [Me-NP]Li(THF)₂.

FIG. 4 illustrates the molecular structure of [ⁱPr—NP]NiCl(PMe₃).

FIG. 5 illustrates the molecular structure of [ⁱPr—NP]NiMe(PMe₃).

FIG. 6 illustrates two views of the molecular structure of [ⁱPr—NP]NiPh(PMe₃).

FIG. 7 illustrates the molecular structure of [ⁱPr—NP]Ni(η³-CH₂Ph).

FIG. 8 illustrates the molecular structure of [Me-NP]Ni(η³-CH₃-Ph).

FIG. 9 illustrates the molecular structure of [Me-NP]AlCl₂ (THF).

FIG. 10 illustrates the molecular structure of [Me-NP]AlEt₂.

FIG. 11 illustrates the molecular structure of [ⁱPr—NP]AlMe₂.

FIG. 12 illustrates the molecular structure of [PNP]PdCl.

### DETAILED DESCRIPTION OF THE INVENTION

The ligand L according to the invention is represented by the following general formula I.

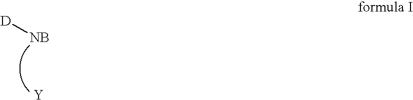

D represents A ring or t-butyl group. Preferably, D is A ring.

A represents a ring or heterocyclic ring, and said ring or heterocyclic ring is unsubstituted or substituted with Xⁿ. Preferably, A is substituted with halogen. If A is an unsubstituted ring, A is only linked to hydrogen atom. In one preferred embodiment, A is an unsubstituted or substituted heterocyclic ring comprising N, O, S, or P atom. In another preferred embodiment, A is an unsubstituted or substituted aromatic ring. In another aspect, A is preferably a five or six membered ring or a five or six membered heterocyclic ring. In still another aspect, A is a bicyclic or polycyclic ring. In still another preferred embodiment, A is an unsubstituted ring. In one more preferred embodiment, A is an unsubstituted or substituted phenyl group.

According to the invention, when A is a substituted ring, the substituent is Xⁿ. Xⁿ for each occurrence independently represents one or more groups selected from the group consisting of hydrocarbons, PR¹R², NR¹R², OR¹, SR¹, and AsR¹R²; and preferably, Xⁿ is PR¹R² or OR¹.

In formula I, Y represents a group selected from the group consisting of PR¹R², PR¹R²R⁹, P(═O)R¹R², NR¹R², OR¹, SR¹, and AsR¹R²; and preferably, Y is PR¹R² or NR¹R².

In one embodiment of the invention, Xⁿ and Y are both PR¹R².

In formula I, n represents an integer larger than or equal to 1. If A has the substituent Xⁿ, n represents the number of the substituents. Preferably, n is equal to 1.

In the substituents, R¹, R² and R⁹ for each occurrence independently represent saturated or unsaturated hydrocarbon or aromatic groups with or without heteroatoms of O, S, N, P or As. In one preferred embodiment of the invention, R¹, R² and R⁹ for each occurrence independently represent phenyl group with or without substituents, or alkyl group having one to four carbon atoms. In another preferred embodiment of the invention, R¹, R² or R⁹ is substituted with halogen.

In formula I, the linkage between N—Y is a saturated or unsaturated hydrocarbon or aromatic group with or without substituents; and preferably, the linkage between N—Y is an alkyl with or without substituents; and more preferably, when the linkage between N—Y is saturated, it is ethyl or propyl group with or without substituent; and when the linkage between N—Y is unsaturated, it is phenyl group with or without substituents.

B represents H or a bond. Preferably, the ligand according to the invention is a monoanion when B represents a bond.

In one preferred embodiment of the invention, the ligand is N-(dimethylaminoethyl)-2-diphenylphosphinoaniline (H[PNN]) represented by the following formula Id:

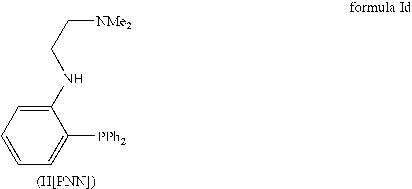

wherein Me represents methyl group.

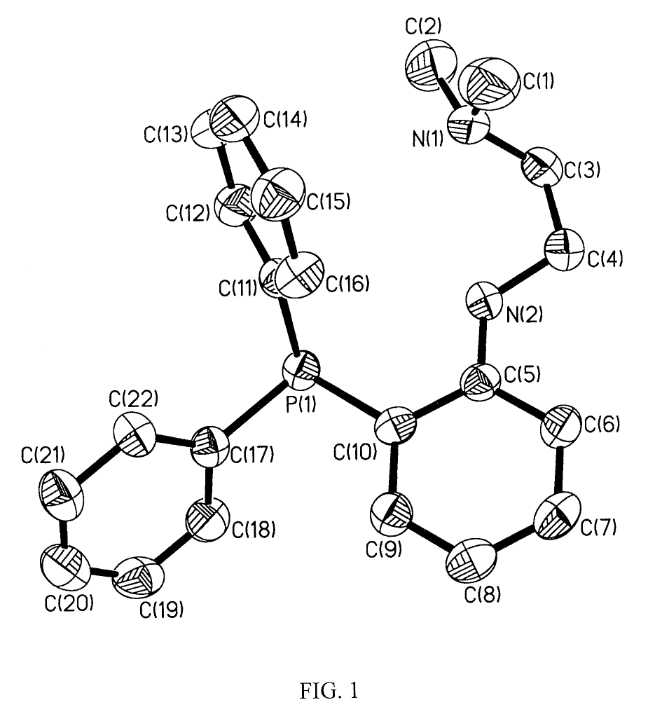

The molecular structure of H[PNN] is shown in FIG. 1.

In one preferred embodiment of the invention, the ligand is represented by the following formula Ie:

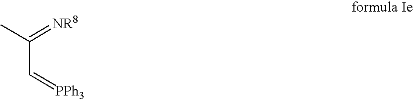

wherein R⁸ is selected from the group consisting of 2,6-C₆H₃ⁱPr₂, 2,6-C₆H₃Me₂, Ph, and t-butyl group.

The possible isomeric structure of the ligand represented by the formula Ie is listed below:

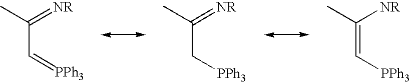

In one preferred embodiment of the invention, the ligand is represented by the following formula If:

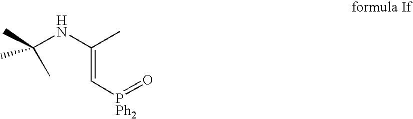

In one still preferred embodiment of the invention, the ligand is represented by the following formula Ig:

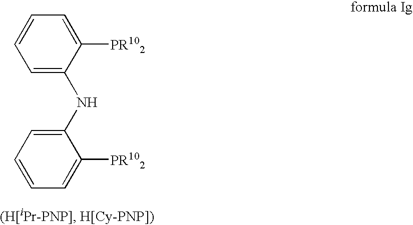

wherein R¹⁰ is selected from the group consisting of isopropyl group (H[ⁱPr—PNP]) and cyclohexyl group (H[Cy-PNP]).

In one still preferred embodiment of the invention, the ligand is represented by the following formula Ih:

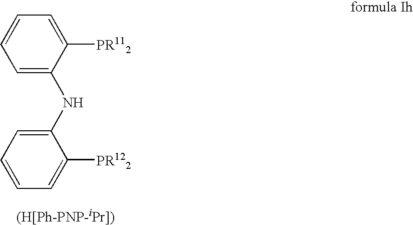

wherein:

R¹¹ represents isopropyl group; and

R¹² represents phenyl group.

In one still preferred embodiment of the invention, the ligand is represented by the following formula Ii:

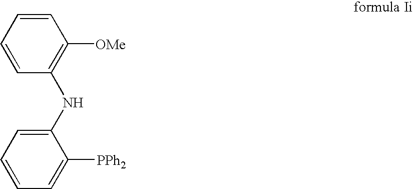

In one still preferred embodiment of the invention, the ligand is represented by the following formula Ij:

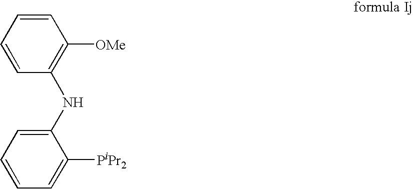

In one still preferred embodiment of the invention, the ligand is represented by the following formula Ik:

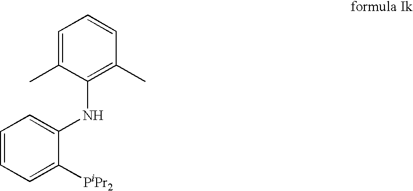

In one still preferred embodiment of the invention, the ligand is represented by the following formula Il:

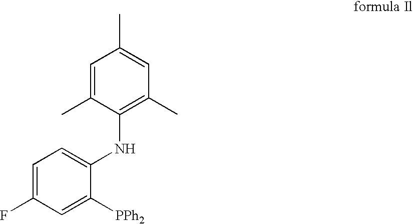

In one still preferred embodiment of the invention, the ligand is represented by the following formula Im:

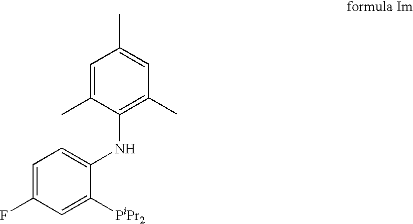

In one still preferred embodiment of the invention, the ligand is represented by the following formula In:

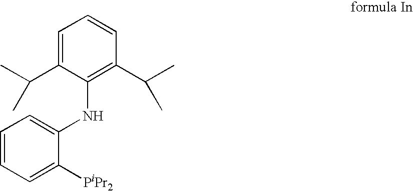

In one still preferred embodiment of the invention, the ligand is represented by the following formula Io:

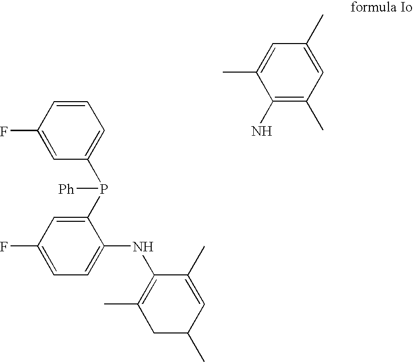

The invention also provide a method for synthesizing the ligand L comprising the steps of:
(a1) conducting a cross-coupling reaction of a bromine, iodine or chlorine substituted fluoride and a fluorine substituted amine to form an amine with multiple fluorine substituents; or

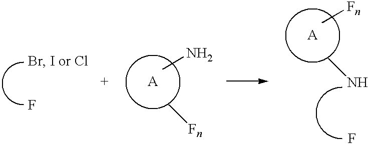

(a2) conducting a cross-coupling reaction of an iodine or chlorine substituted bromide and a bromine substituted amine to form an amine with multiple bromine substituents; and

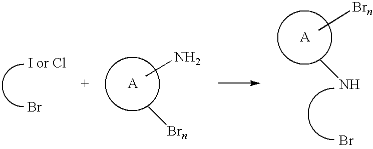

(b) conducting a nucleophilic reaction of the amine with multiple fluorine in (a1) or bromine substituents (a2), M²Xⁿ and M²Y to form the ligand represented by the formula I;
   wherein:
   the linkage between fluorine and bromine, iodine or chlorine of the fluoride in (a1), or the linkage between iodine or chlorine substituted bromide in (a2), is a saturated or unsaturated hydrocarbon or aromatic group with or without substituents;
   M² is a metal selected from the group consisting of Li, Na and K; and wherein preferably is K; and
   A, n, Xⁿ and Y are as defined in ligand L.

One embodiment of the method is depicted below:

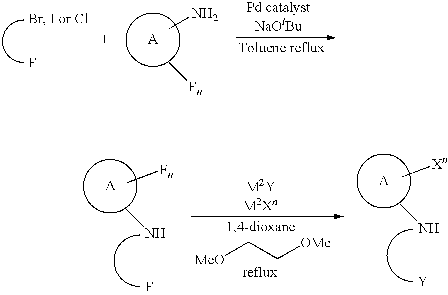

The ligand synthesis includes two straightforward steps from relatively inexpensive, commercially available starting materials.

According to the invention, step (a) is a palladium-catalyzed cross-coupling reaction in the presence of sodium tert-butoxide in refluxing toluene to produce the intermediate represented by formula IV. The number and position of the substituent F of A in the starting material depends on that of the Xⁿ substituent in the desired final product. Palladium catalyst is a common catalyst for use in synthesis (Wolfe, J. P.; Wagaw, S.; Marcoux, J. F.; Buchwald, S. L. Acc. Chem. Res. 1998, 31, 805; Hartwig, J. F. Acc. Chem. Res. 1998, 31, 852; Sadighi, J. P.; Harris, M. C.; Buchwald, S. L. Tetrahedron Lett. 1998, 39, 5327.). In one embodiment of the invention, palladium catalyst comprises Pd(OAc)₂ and [2-(diphenylphosphino)phenyl]ether (DPEphosbis).

Step (b) of the method comprises reacting the intermediate represented by formula IV, M²Xⁿ and M²Y in 1,4-dioxane or MeO—CH₂CH₂—MeO refluxing to obtain the final product represented by formula I.

The method for synthesizing the ligand H[ⁱPr—PNP] or H[Cy-PNP]) is depicted below.

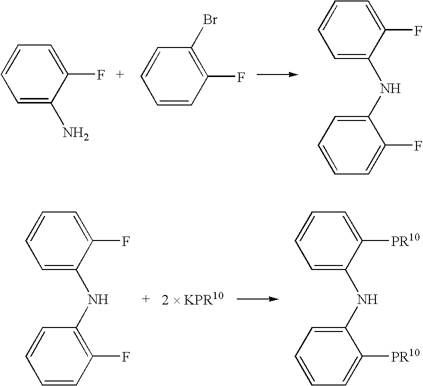

The another method for synthesizing the ligand H[ⁱPr—PNP] or H[Cy-PNP]) is depicted below:

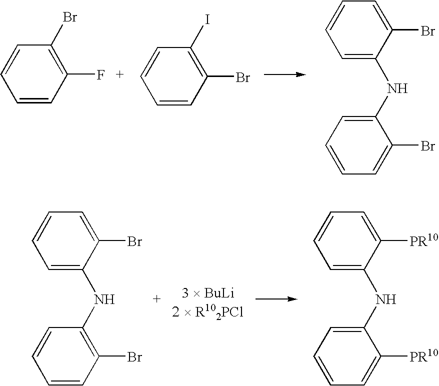

The method for synthesizing the ligand H[Ph-PNP-ⁱPr] is depicted below:

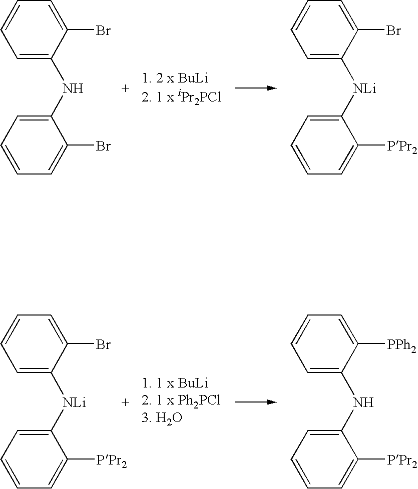

The present invention provides a second method for synthesizing the ligand L comprising the steps of:
(a) conducting a cross-coupling reaction of a bromine, iodine or chlorine substituted fluoride represented by the following formula IX and a substituted amine represented by the following formula X to form a compound represented by the following formula XI according to scheme IV; and

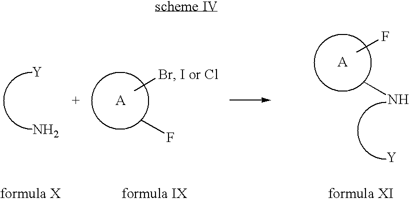

(b) conducting a nucleophilic reaction of the compound represented by the general formula X¹, M²Xⁿ and M²Y to form the ligand represented by the formula I;
   wherein:
   the linkage between Y and NH₂ of the amine represented by formula X is a saturated or unsaturated hydrocarbon or aromatic group with or without substituents;
   M² is a metal selected from the group consisting of Li, Na and K; and wherein preferably is K; and
   A, n, Xⁿ and Y are as defined in ligand L.

In one preferred embodiment of the invention, the second method comprises the steps of:
(a) conducting a cross-coupling reaction of 1-bromo-2-fluorobenzene and N,N-dimethylethylenediamine to form N-(dimethylaminoethyl)-2-fluoroaniline; preferably in the presence of Pd catalyst and sodium tert-butoxide; and
(b) reacting N-(dimethylaminoethyl)-2-fluoroaniline and KPPh₂ to form the ligand N-(dimethylaminoethyl)-2-diphenylphosphinoaniline; preferably in the presence of 1,4-dioxane or DME;
wherein Ph represents phenyl group.

The method for synthesis of H[PNN] is depicted below:

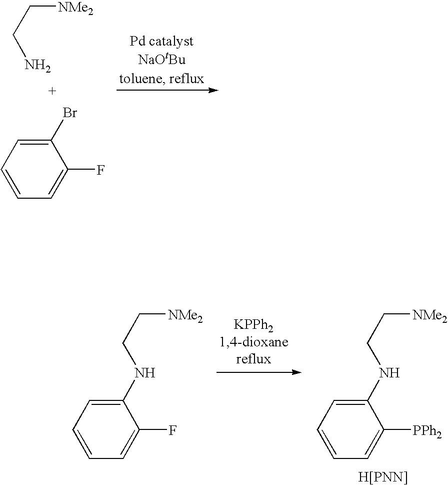

A third method for synthesizing the ligand L according to the present invention comprises the steps of:
(a) conducting a cross-coupling reaction of a compound represented by the following formula XII and a compound represented by the following formula XIII to form a compound represented by the following formula XIV according to scheme V; and

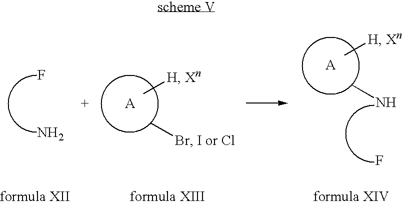

(b) conducting a nucleophilic reaction of the compound represented by the general formula XIV and M²Y to form the ligand represented by the formula I;
   wherein:
   the linkage between F and NH₂ of the compound represented by formula XII is a saturated or unsaturated hydrocarbon or aromatic group with or without substituents; and
   M² is a metal selected from the group consisting of Li, Na and K; and wherein preferably is K;
   A, n, Xⁿ and Y are as defined in ligand L.

The present invention also provide a fourth method for synthesizing the ligand L comprising the steps of:
(a) conducting a cross-coupling reaction of a substituted amine represented by the following formula X and a compound represented by the following formula XV to form a compound represented by the following formula XVI according to scheme VI; and

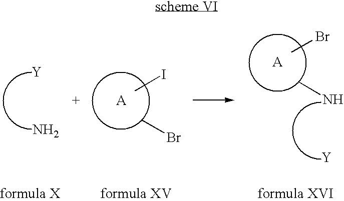

(b) reacting the compound represented by the general formula XVI with a base and then with Hal⁵Xⁿ to form the ligand represented by the formula I;
   wherein:
   the linkage between Y and NH₂ of the amine represented by formula X is a saturated or unsaturated hydrocarbon or aromatic group with or without substituents;
   Hal⁵ represents halogen; and
   A, n, Xⁿ and Y are as defined in ligand L.

According to the fourth method of the invention, the base is preferably BuLi, ⁱPrMgCl or Mg, wherein ⁱPr represents isopropyl group.

The invention also provided a fifth method for synthesizing the ligand according to the invention comprising the steps depicted below:

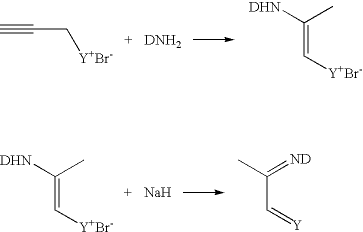

In one preferred embodiment of the invention, the method for synthesizing the ligand represented by formula Ie comprising the steps depicted below:

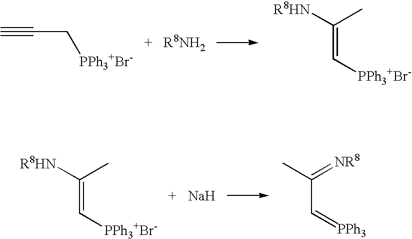

Preferably, the method for synthesizing the ligand represented by formula If comprising the steps depicted below:

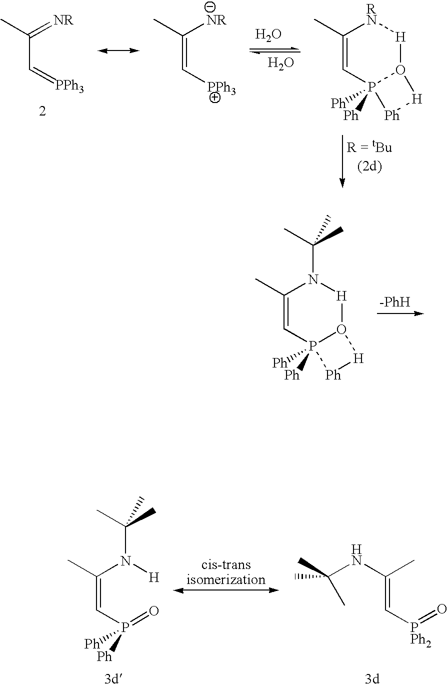

The ligand L can complex with a metal center M¹ to form a chelated complex. M¹ is selected from the group consisting of transition metal, Li, Na, K, Mg, Ca, Al, and Ga; and preferably, M¹ is selected from the group consisting of Zn, Pd, Al, and Ni.

In one embodiment of the invention, the ligand is coordinated to the metal center through two coordinate bonds. One of the coordinate bond is between M¹ and N and the other is between M¹ and Y. The complex is represented by the following general formula V:

L_{b}M¹Z¹_{c} formula V

wherein:
the number of ligand L is b;
the number of Z¹ is c;
the number of the coordination number of M¹ is a; and
Z¹ is coordinated to metal M¹ through d coordinate bonds;
Z¹ represents a group; and wherein preferably, Z¹ is selected from the group consisting of an unsubstituted or substituted hydrocarbon group, unsubstituted or substituted aromatic group, halogen group and ligand L; and more preferably, Z¹ represents ligand L;

2b+cd≦a; and

the linkage between L and M¹ is represented by the following general formula Va:

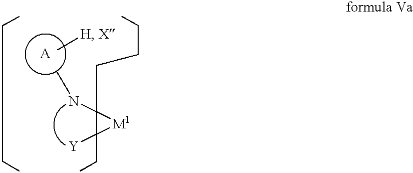

In one embodiment of the invention, the complex is represented by the following formula Vb;

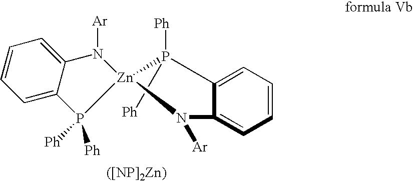

wherein:

Ar² represents 2,6-C₆H₃ⁱPr₂;

Ph represents phenyl group; and

ⁱPr represents isopropyl group.

In one embodiment of the invention, the complex is represented by the following formula Vc:

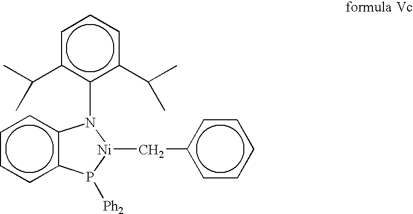

wherein Ph represents phenyl group.

In another embodiment of the invention, the complex is represented by the following formula Vd:

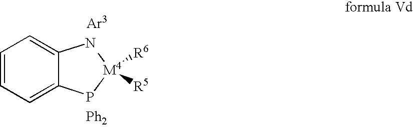

wherein
Ar³ represents 2,6-C₆H₃ⁱPr₂ or 2,6-C₆H₃Me₂;
ⁱPr represents isopropyl group;
R⁵ and R⁶ independently represent methyl group, ethyl group, CH₂SiMe₃, phenyl group, PMe₃, or halogen; and R⁵ and R⁶ taken together optionally represent the group represented by the following formula VII; and

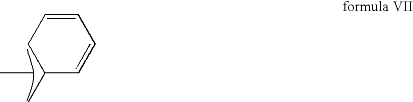

M⁴ represents the metal center of Ni or Al.

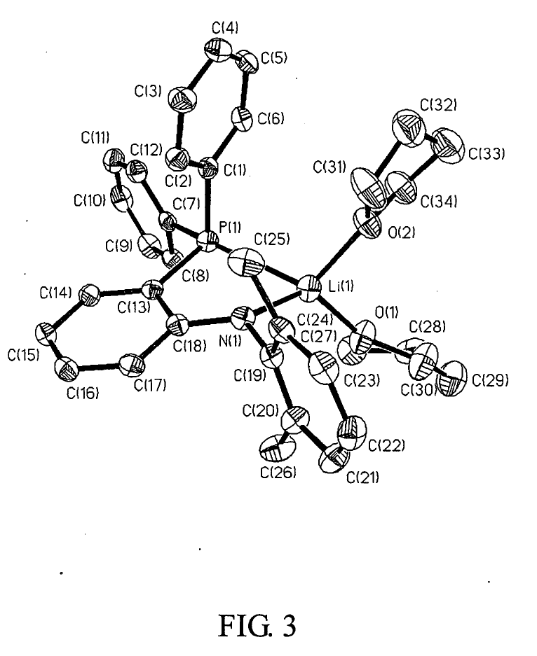

The molecular structure of [Me-NP]Li(THF)₂ is shown in FIG. 3.

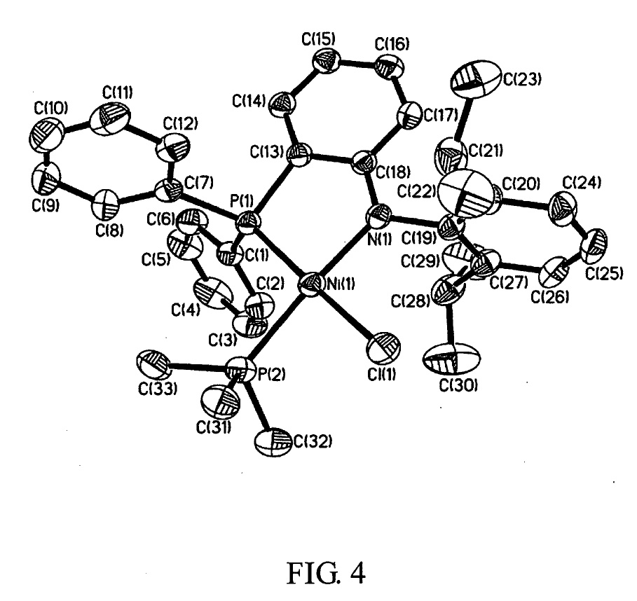

The molecular structure of [ⁱPr—NP]NiCl(PMe₃) is shown in FIG. 4.

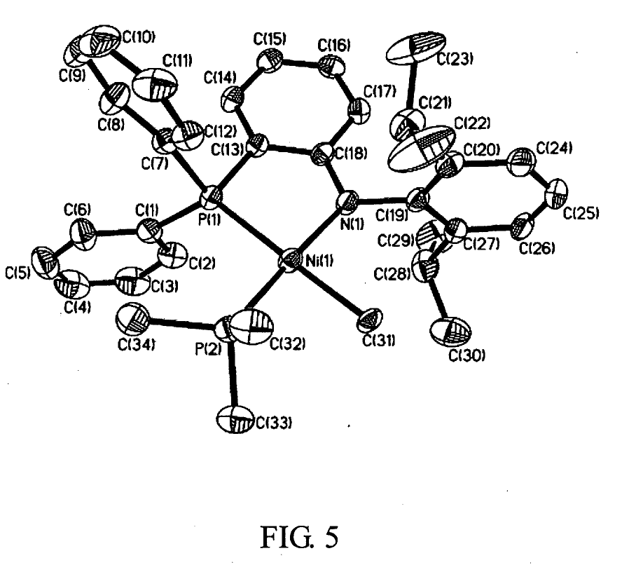

The molecular structure of [ⁱPr—NP]NiMe(PMe₃) is shown in FIG. 5.

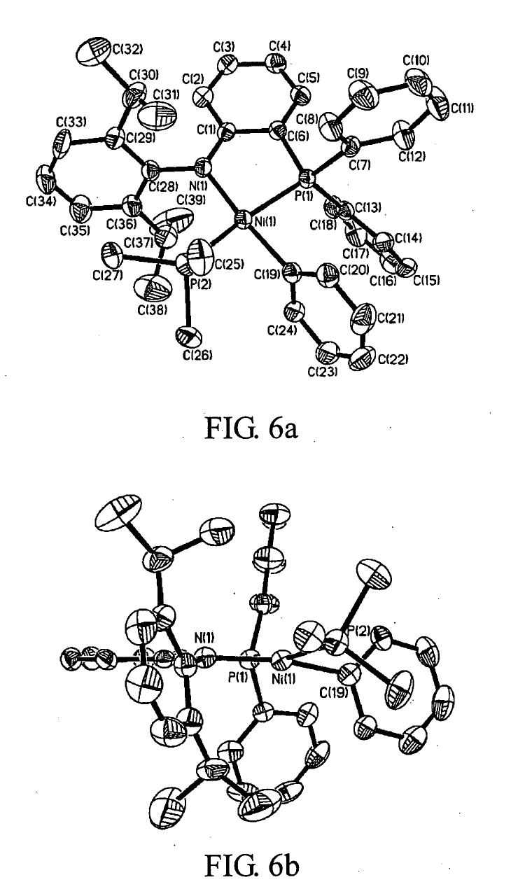

The molecular structure of [ⁱPr—NP]NiPh(PMe₃) is shown in FIG. 6.

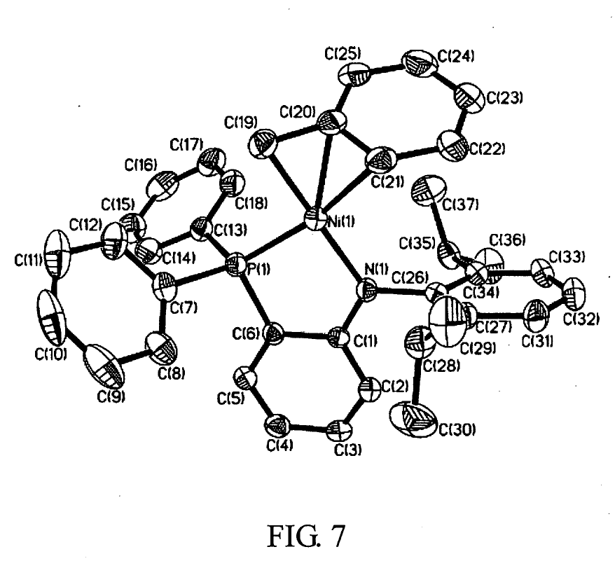

The molecular structure of [ⁱPr—NP]Ni(η³-CH₂Ph) is shown in FIG. 7.

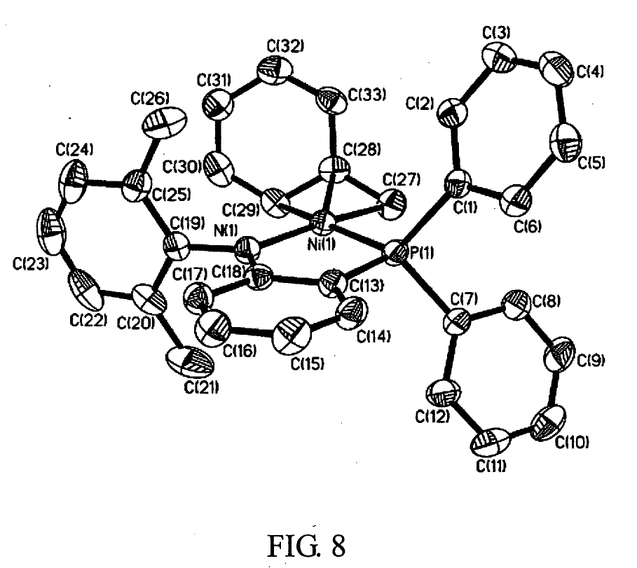

The molecular structure of [Me-NP]Ni(η³-CH₃-Ph) is shown in FIG. 8.

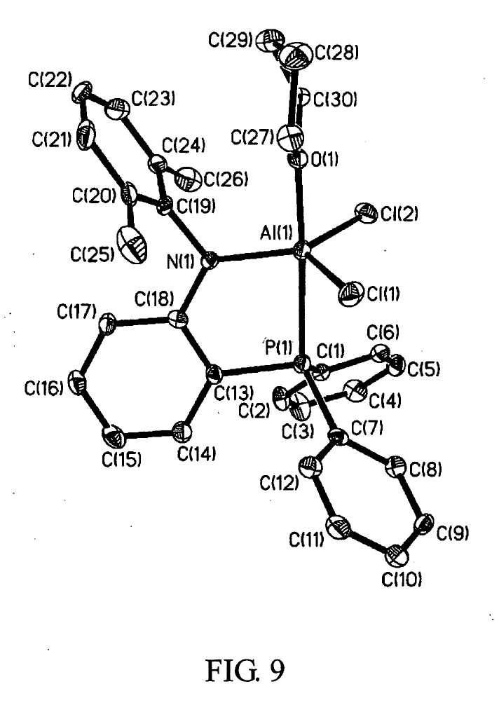

The molecular structure of [Me-NP]AlCl₂ (THF) is shown in FIG. 9.

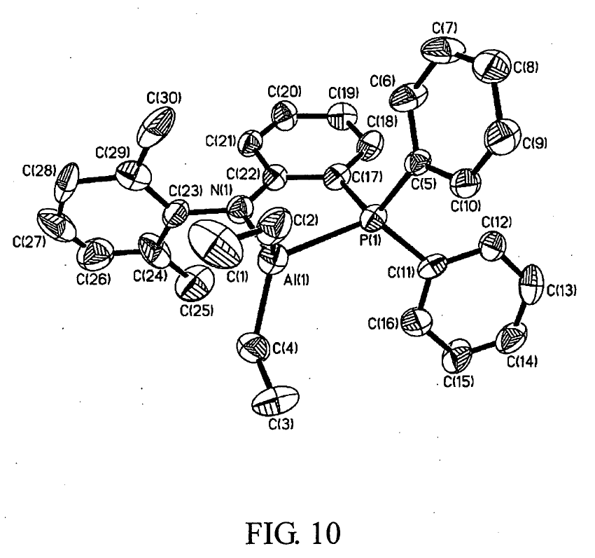

The molecular structure of [Me-NP]AlEt₂ is shown in FIG. 10.

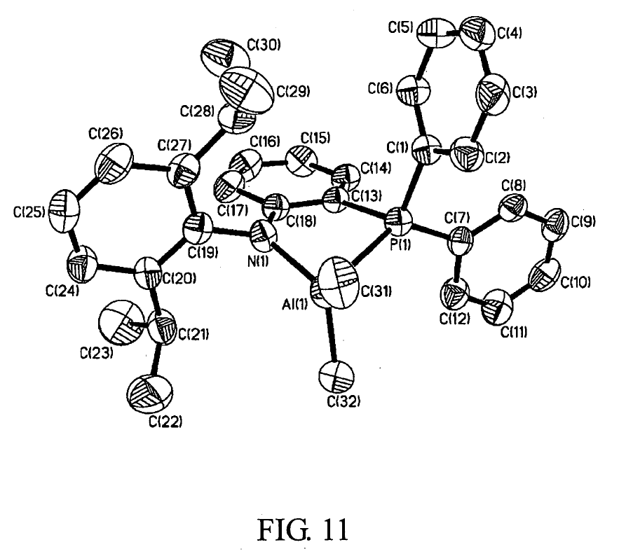

The molecular structure of [ⁱPr—NP] AlMe₂ is shown in FIG. 11.

In another embodiment of the invention, the ligand is coordinated to the metal center through three coordinate bonds. One of the coordinate bond is between M¹ and N, the other is between M¹ and Y; another is between M¹ and the substituent X. The complex is represented by the following general formula VI:

LₑM¹Z²_{f} formula VI
wherein:
the number of ligand L is e;
the number of Z² is f;
the number of the coordination number of M¹ is a; and
Z² is coordinated to metal M¹ through g coordinate bonds;
Z² represents a group; and wherein preferably, Z² is selected from the group consisting of an unsubstituted or substituted hydrocarbon group, unsubstituted or substituted aromatic group, halogen group and ligand L; more preferably, Z² represents ligand L;

3e+fg≦a; and
the linkage between L and M¹ is represented by the following general formula VIa:

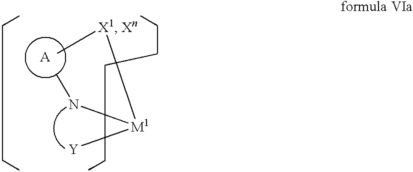

In one embodiment of the invention, the complex is represented by the following general formula VIb;

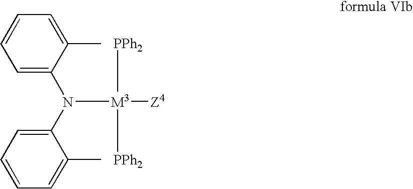

wherein
M³ represents Ni or Pd;
Z⁴ represents a group; and preferably, Z⁴ is selected from the group consisting of an unsubstituted or substituted hydrocarbon group, unsubstituted or substituted aromatic group, and halogen group; and more preferably, Z⁴ is selected from methyl, ethyl, n-butyl, i-butyl, CH₂SiMe₃, Cl, OAc and phenyl group; and
Ph represents phenyl group.

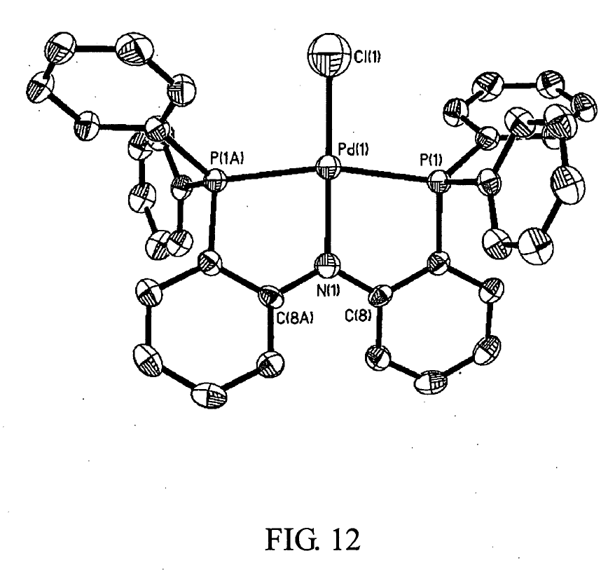

The molecular structure of [PNP]PdCl is shown in FIG. 12.

The synthesis of the complex comprising the ligand of the invention is well known to the artisans skilled in this field.

For example, a method for synthesizing the complex according to the invention comprises reacting M¹E and the ligand L to form the complex as depicted below:

M¹E+LH→[M¹L]+HE scheme VII
wherein:
E represents alkyl, aryl, amide, or alkoxide group.

In one embodiment, the method comprises the steps of:
(a) reacting M⁵E and the ligand to eliminate HE and form the complex [M⁵L]; and

M⁵E+LH→[M⁵L]+HE scheme VIII
(b) reacting [M⁵L] and M¹Hal⁶ to form [M¹L];
   wherein:
   M⁶ is selected from the group consisting of transition metal, Li, Na, K, Mg, Ca, Al, and Ga;
   E represents alkyl, aryl, amide, or alkoxide group; and
   Hal⁵ represents halogen.

In another embodiment, the method comprises the steps of:
(a) reacting the ligand L and M¹Z³ to form LM¹Z³ in the presence of diethyl ether or THF; and
(b) reacting the ligand L and LM¹Z³ by heating to form L²M¹,
   wherein Z³ represents a group; preferably, Z³ is selected from the group consisting of an unsubstituted or substituted hydrocarbon group, or unsubstituted or substituted aromatic group, and halogen group; and more preferably, Z³ is methyl group or ethyl group.

A method for use in synthesizing the complex represented by formula Vb is shown in the following scheme. The method comprises the steps of:
(a) reacting N-(2-diphenylphosphinophenyl)-2,6-diisopropylaniline H[NP] and ZnZ³ to form [NP]ZnZ³ in the presence of diethyl ether or THF; and
(b) reacting N-(2-diphenylphosphinophenyl)-2,6-diisopropylaniline (H[NP]) and [NP]ZnZ³ by heat to form [NP]₂Zn,
wherein Z³ represents a group; preferably, Z³ is selected from the group consisting of an unsubstituted or substituted hydrocarbon group, or unsubstituted or substituted aromatic group, and halogen group; and more preferably, Z³ is methyl group or ethyl group.

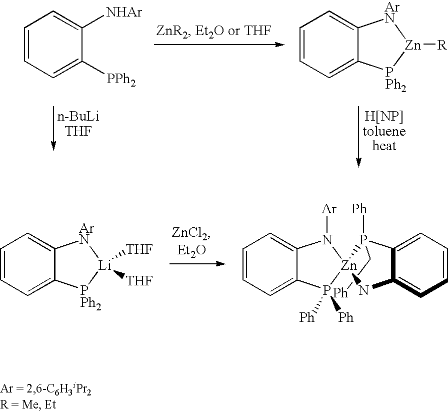

Preferably, step (b) is conducted in toluene refluxing.

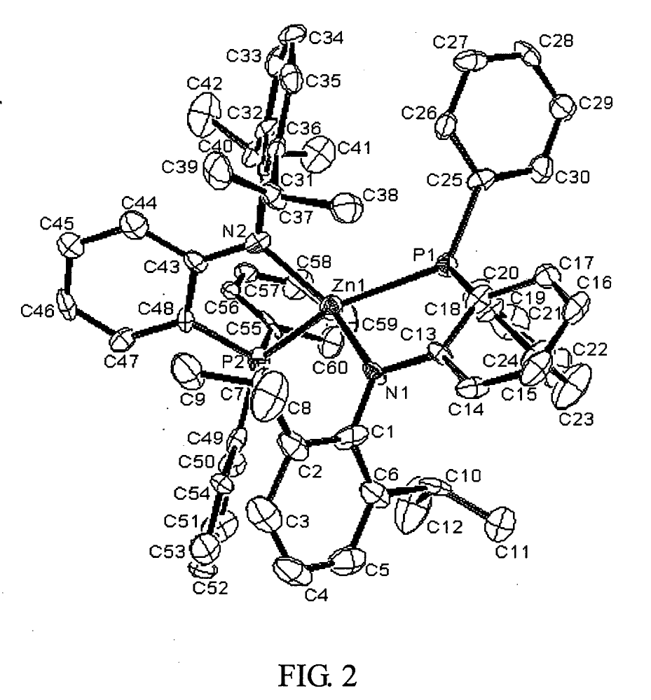

The molecular structure of [NP]₂Zn is shown in FIG. 2.

A second method for synthesizing the complex according to the invention comprises the steps of:
(a) reacting the ligand L and n-butyllithium to form LLi(THF)₂ in the presence of THF; and
(b) reacting LLi(THF)₂ and M¹Cl₂ to form LM¹.

A third method for synthesizing the complex according to the invention comprises the steps of:
(a) reacting the ligand L and n-butyllithium to form LLi(THF)₂ in the presence of THF;
(b) reacting LLi(THF)₂ and M¹Cl₂(DME) to form LM¹Cl; and
(c) reacting LM¹Cl and Z¹MgC¹ or Z²MgCl to form LM¹Z¹ or LM¹Z²,
   wherein Z¹ or Z² represent a group.

One embodiment of the method comprises the steps of:
(a) reacting bis(2-diphenylphosphinophenyl)amine (H[PNP]) and n-butyllithium to form [PNP]Li(THF)₂ in the presence of THF;
(b) reacting [PNP]Li(THF)₂ and NiCl₂(DME) to form [PNP]NiCl; and
(c) reacting [PNP]NiCl and Z¹MgC¹ or Z²MgCl to form [PNP]NiZ¹ or [PNP]NiZ²,

wherein Z¹ or Z² represent a group; and preferably, Z¹ or Z² is selected from the group consisting of an unsubstituted or substituted hydrocarbon group, unsubstituted or substituted aromatic group, halogen group and ligand L; more preferably, Z¹ or Z² represents methyl, ethyl, n-butyl, i-butyl, CH₃SiMe₃ or phenyl group.

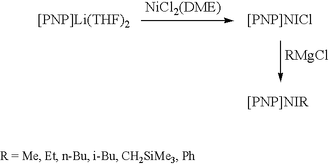

A fourth method for synthesizing the complex according to the invention comprises the steps of:
(a) reacting the ligand L and n-butyllithium to form LLi(THF)₂ in the presence of THF;
(b) reacting LLi(THF)₂ and M¹Cl₃ in the presence of toluene to form LM¹Cl₂; and
(c) reacting LMⁱCl₂ and LiZ¹ or LiZ² to form the complex,
wherein Z¹ or Z² represent a group.

In one embodiment of the invention, the method for the synthesis of the complex represented by formula Vd is depicted below:

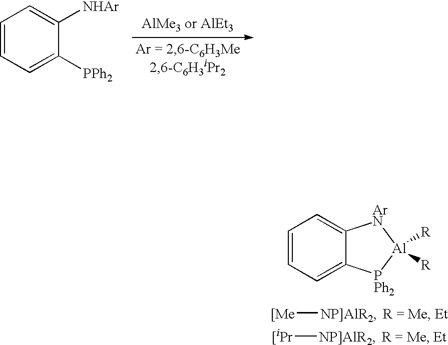

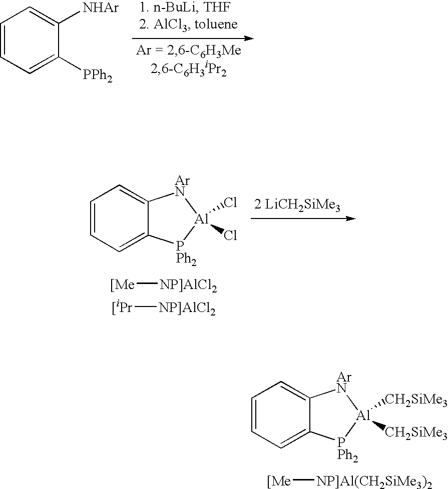

In another embodiment of the invention, the method for the synthesis of the complex represented by formula Vd is depicted below:

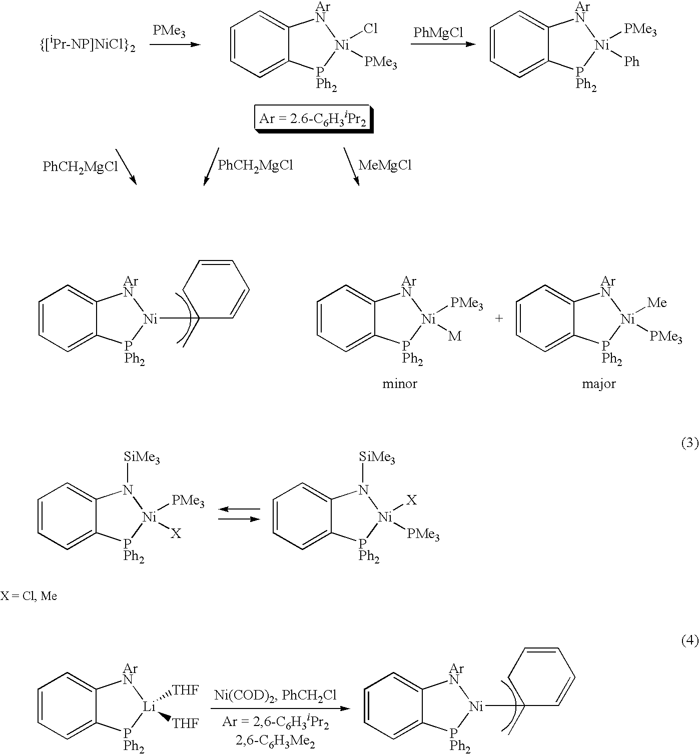

The complex comprising the ligand L of the invention is used for catalyzing carbon-carbon bond formation.

In one embodiment of the invention, the carbon-carbon bond formation comprises cross-coupling:

R-G+R′-J→R-R′ scheme IX
wherein:
R and R′ independently represent saturated or unsaturated hydrocarbon or aromatic groups; and
G and J independently represent a group.

In one embodiment of the invention, the carbon-carbon bond formation comprises Kumada coupling reaction which is the reaction of R³Hal¹ and R⁴MgHal² to form R³-R⁴ bond:

R³Ha¹+R⁴MgHal²→R³-R⁴ Scheme XI
wherein:
R³ and R⁴ independently represent hydrocarbon group or aromatic group; and
Hal¹ and Hal² independently represent halogen atom.

One example of Kumada coupling reaction is depicted below:

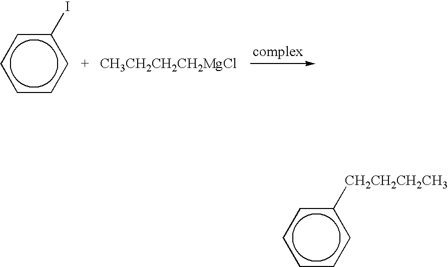

The catalyst used is the complex represented by formula VIb.

In another embodiment of the invention, the carbon-carbon bond formation comprises ethylene oligomerization which involves reacting ethyne to form 6 to 24 carbon alkenes. Preferably, the catalyst used is the complex represented by formula VIc.

In still another embodiment of the invention, the carbon-carbon bond formation comprises Heck reaction which comprises reacting Ar⁴Hal³ and alkene represented by the following formula VII to form aromatic alkene represented by the following formula VIII:

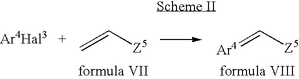

wherein:
Ar⁴ represents aromatic group; and preferably phenyl group;
Hal³ represents halogen group; and preferably I; and
Z⁵ represents a group; and preferably phenyl group.

One example of Heck coupling reaction is depicted below:

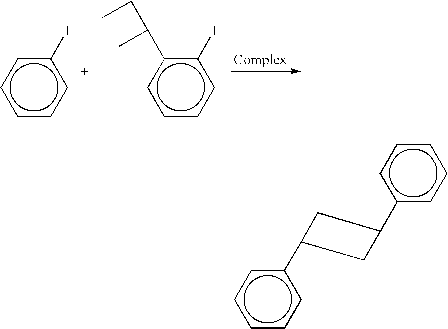

The catalyst used is the complex represented by formula VIc.

Another example of Heck coupling reaction comprises coupling aryl halides with styrene:

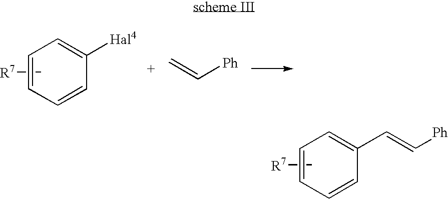

wherein:
R⁷ represents H, NO₂, CHO, C(O)R¹, halogen, OR¹, or NR¹;
Hal⁴ represents halogen; and
R¹ represents saturated or unsaturated hydrocarbon group with or without substituents or saturated or unsaturated aromatic group with or without substituents.

In still another embodiment of the invention, the carbon-carbon bond formation comprises Suzuki coupling reaction which comprises coupling aryl halides with styrene:

RB(OH)₂+R′Hal⁷→R-R′ scheme X
wherein Hal⁷ represents halogen.

In still another embodiment of the invention, the carbon-carbon bond formation comprises ring-open polymerization:

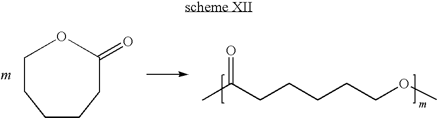

wherein m represents an integer larger than or equal to 1.

The following examples are given for the purpose of illustration only but not intended to limit the scope of the present invention.

### EXAMPLE 1

### Synthesis of [NP]₂Zn

General Procedures. Unless otherwise specified, all experiments were performed under nitrogen using standard Schlenk or glovebox techniques. All solvents were reagent grade or better and purified by standard methods. All other chemicals were used as received from commercial vendors. The NMR spectra were recorded on Varian instruments. Chemical shifts (δ) are listed as parts per million downfield from tetramethylsilane and coupling constants (J) are in hertz. ¹H NMR spectra are referenced using the residual solvent peak at δ 7.16 for C₆D₆, and δ7.27 for CDCl₃. ¹³C NMR spectra are referenced using the residual solvent peak at δ 128.39 for C₆D₆, and δ 77.23 for CDCl₃. The assignment of the carbon atoms for all new compounds is based on the DEPT ¹³C NMR spectroscopy. ¹⁹F, ³¹P and ⁷Li NMR spectra are referenced externally using CFCl₃ in CHCl₃ at δ0, 85% H₃PO₄ at δ0, and LiCl in D₂O at δ0, respectively. Routine coupling constants are not listed. All NMR spectra were recorded at room temperature in specified solvents. Elemental analysis was performed on a Heraeus CHN—O Rapid analyzer.

X-ray crystallography. Data for compounds H[NP], [NP]ZnEt, and [NP]₂Zn were collected on a Bruker SMART 1000 CCD diffractometer with graphite monochromated Mo-Kα radiation (λ=0.7107 Å). Structures were solved by direct methods and refined by full matrix least squares procedures against F² using SHELXTL. All full-weight non-hydrogen atoms were refined anisotropically. Hydrogen atoms were placed in calculated positions. In [NP]₂Zn, the solvent molecule (diethyl ether) is disordered and cannot be resolved properly.

Synthesis of N-(2-fluorophenyl)-2,6-diisopropylaniline. A Schlenk flask was charged with 1-bromo-2-fluorobenzene (5.47 mL, 50.0 mmol), 2,6-diisopropyllaniline (9.43 mL, 50 mmol), Pd(OAc)₂ (56 mg, 0.25 mmol, 0.5% equiv), bis[2-(diphenylphosphino)phenyl]ether (DPEphos, 200 mg, 0.375 mmol, 0.75% equiv), sodium tert-butoxide (6.70 g, 70 mmol, 1.4 equiv), and toluene (15 mL) under nitrogen. The flask was sealed with a rubber septum and heated to 95° C. with stirring for 5 d. Toluene was removed in vacuo and the reaction was quenched with deionized water (75 mL). The product was extracted with CH₂Cl₂ (75 mL) and the organic portion was separated from the aqueous layer, which was further extracted with CH₂Cl₂ (20 mL×2). The combined organic solution was dried over MgSO₄ and filtered. All volatiles were removed in vacuo to yield an orange viscous oil, which was subjected to flash column chromatography on silica gel (9:1 Hexanes/Et₂O). The first band (pale yellow) was collected. Solvents were removed in vacuo to give pale yellow oil; yield 12.65 g (93%). ¹H NMR (CDCl₃, 200 MHz) δ 7.24-7.35 (m, 3, Ar), 7.05 (m, 1, Ar), 6.85 (t, 1, Ar), 6.65 (m, 1, Ar), 6.22 (t, 1, Ar), 5.34 (br s, 1, NH), 3.21 (septet, 2, CHMe₂), 1.17 (d, 12, CHMe₂). ¹⁹F NMR (CDCl₃, 470.5 MHz) δ−138.32. ¹³C NMR (CDCl₃, 125.5 MHz) δ 151.02 (J_{CF}=237.0, CF), 147.73, 136.41 (J_{CF}=10.89), 134.12, 127.59 (CH), 124.40 (J_{CF}=3.64, CH), 123.89 (CH), 116.99 (J_{CF}=7.27, CH), 114.56 (J_{CF}=18.20, CH), 113.11 (J_{CF}=2.64, CH), 28.19 (CHMe₂), 23.84 (CHMe₂). Anal. Calcd. for C₁₈H₂₂FN: C, 79.67; H, 8.17; N, 5.16. Found: C, 79.42; H, 8.20; N, 5.17.

Synthesis of N-(2-diphenylphosphinophenyl)-2,6-diisopropylaniline, H[NP]. A 250-mL Schlenk flask equipped with a condenser was flashed with nitrogen thoroughly. To this flask was added KPPh₂ (73 mL, 0.5 M in THF solution, Aldrich, 36.9 mmol). THF was removed in vacuo and a solution of N-(2-fluorophenyl)-2,6-diisopropylaniline (10 g, 36.9 mmol) in 1,4-dioxane (40 mL) was added with a syringe. The transparent, ruby reaction solution was heated to reflux for 5 d, during which time the reaction condition was monitored by ³¹P{¹H} NMR spectroscopy. All volatiles were removed from the resulting orange solution under reduced pressure and degassed deionized water (100 mL) was added. The product was extracted with deoxygenated dichloromethane (100 mL). The dichloromethane solution was separated from the aqueous layer, from which the product was further extracted with dichloromethane (20 mL×2). The combined organic solution was dried over MgSO₄ and filtered. All volatiles were removed in vacuo to yield the product as pale yellow oil. The product was purified by washing it with boiling EtOH (10 mL×4) until it became white powder; yield 15.2 g (94%). ¹H NMR (CDCl3, 200 MHz) δ 7.39 (m, 10, PC6H5), 7.0-7.22 (m, 4, Ar), 6.82 (m, 1, Ar), 6.65 (t, 1, Ar), 6.15 (m, 1, Ar), 5.95 (d, 1, J_{HP}=8, NH), 2.90 (septet, 2, CHMe₂), 1.06 (d, 6, CHMe₂), 0.94 (d, 6, CHMe₂). ¹H NMR (C₆D₆, 200 MHz) δ 7.48 (m, 4, Ar), 6.60-7.15 (m, 10, Ar), 6.92 (m, 1, Ar), 6.59 (t, 1, Ar), 6.34 (m, 1, Ar), 6.26 (d, 1, J_{HP}=8, NH), 3.13 (septet, 2, CHMe₂), 1.09 (d, 6, CHMe₂), 0.97 (d, 6, CHMe₂). ³¹P{¹H}NMR (C₆D₆, 202 MHz) δ−20.11. ³¹P{¹H} NMR (Et₂O, 121.5 MHz) δ−19.87. ³¹P{¹H} NMR (CDCl₃, 121.5 MHz) δ −20.17. 13C NMR (CDCl₃, 75.3 MHz) δ 150.57 (J=17.1), 147.41, 135.35, 135.26, 135.24, 133.93 (J_{CP}=19.6), 130.28, 128.92, 128.47 (J_{CP}=7.5), 127.14, 123.70, 118.71, 117.63, 111.60, 28.18 (CHMe₂), 24.40 (CHMe₂), 23.03 (CHMe₂). Anal. Calcd. for C₃₀H₃₂NP: C, 82.35; H, 7.37; N, 3.20. Found: C, 82.32; H, 7.36; N, 3.28.

Synthesis of [NP]ZnMe. Solid N-(2-diphenylphosphinophenyl)-2,6-diisopropylaniline (218.8 mg, 0.5 mmol) was dissolved in diethyl ether (5 mL) and cooled to −35° C. To this was added a solution of ZnMe₂, which was prepared in situ from the reaction of ZnCl₂ (68.1 mg, 0.5 mmol) and MeMgCl (0.33 mL, 3 M in THF solution, Aldrich, 1 mmol) in diethyl ether at −35° C. The reaction solution was naturally warmed to room temperature and stirred for 2 d. After being filtered through a pad of Celite, the solution was concentrated to ca. 1 mL and cooled to −35° C. to afford pale yellow crystals, which were isolated from the solution and dried in vacuo; yield 248 mg (96%). ¹H NMR (C₆D₆, 500 MHz) δ 7.38 (m, 4, Ar), 7.24-7.28 (m, 2, Ar), 6.95-7.08 (m, 9, Ar), 6.38 (t, 1, Ar), 6.26 (t, 1, Ar), 3.40 (septet, 2, CHMe₂), 1.17 (d, 6, CHMe₂), 1.11 (d, 6, CHMe₂), −0.13 (br s, 3, ZnCH₃). ³¹P{¹H} NMR (C₆D₆, 202.5 MHz) δ −27.34. ¹³C NMR (C₆D₆, 125.5 MHz) δ 163.13 (J_{CP}=17.32), 147.99, 146.08, 134.71 (CH), 134.11 (J_{CP}=14.43, CH), 133.99 (CH), 130.71 (CH), 129.57 (J_{CP}=10.04, CH), 129.31 (J_{CP}=7.28, CH), 125.54 (CH), 124.66 (CH), 114.46, 110.42, 110.10, 28.61 (CHMe₂), 25.21 (CHMe₂), 24.44 (CHMe₂), −12.79 (br s, ZnCH₃). Anal. Calcd. for C₃₁H₃₄NPZn: C, 72.02; H, 6.63; N, 2.71. Found: C, 72.36; H, 6.73; N, 2.755.

Synthesis of [NP]ZnEt. Solid N-(2-diphenylphosphinophenyl)-2,6-diisopropylaniline (200 mg, 0.457 mmol) was dissolved in diethyl ether (5 mL) and cooled to −35° C. To this was added a solution of ZnEt₂ (0.457 mL, 1.0 M in hexane, Aldrich, 0.457 mmol). The reaction solution was naturally warmed to room temperature and stirred for 2 d. After being filtered through a pad of Celite, the solution was evaporated to dryness, affording the desired product as a pale yellow solid which is pure by ¹H and ³¹P{¹H} NMR spectroscopy; yield 241 mg (99%). Recrystallization of the solid from diethyl ether at −35° C. afforded colorless, X-ray quality crystals; yield 168 mg (69%). ¹H NMR (C₆D₆, 500 MHz) δ 7.26-7.30 (m, 4, Ar), 7.12-7.17 (m, 3, Ar), 6.86-6.95 (m, 8, Ar), 6.29 (t, 1, Ar), 6.16 (t, 1, Ar), 3.29 (septet, 2, CHMe₂), 1.30 (t, 3, ZnCH₂CH₃), 1.07 (d, 6, CHMe₂), 1.02 (d, 6, CHMe₂), 0.69 (q, 2, ZnCH₂). ³¹P{¹H} NMR (C₆D₆, 202.5 MHz) δ −27.15. ¹³C NMR (C₆D₆, 125.5 MHz) δ 162.73 (J_{CP}=18.32), 145.94, 134.87 (CH), 134.05 (J_{CP}=14.68, CH), 130.80 (CH), 130.58, 129.64 (J_{CP}=10.04, CH), 128.99 (J_{CP}=7.27, CH), 125.72 (CH), 124.57 (CH), 114.77 (J_{CP}=5.52, CH), 114.1.2 (J_{CP}=5.52, CH), 110.25, 109.92, 28.73 (CHMe₂), 25.12 (CHMe₂), 24.26 (CHMe₂), 13.10 (ZnCH₂CH₃), 1.82 (²J_{CP}=35.64, ZnCH₂). Anal. Calcd. for C₃₂H₃₆NPZn: C, 72.38; H, 6.83; N, 2.64. Found: C, 69.62; H, 6.64; N, 2.61.

Synthesis of lithium N-(2-diphenylphosphinophenyl)-2,6-diisopropylanilide, [NP]Li(THF)₂. To a solution of N-(2-diphenylphosphinophenyl)-2,6-diisopropylaniline (3.085 g, 7.05 mmol) in THF (40 mL) at −35° C. was added n-BuLi (4.406 mL, 7.05 mmol, 1 equiv). The reaction mixture was naturally warmed to room temperature and stirred for 3 h. All volatiles were removed in vacuo. The red viscous residue was triturated with pentane (5 mL) to yield a yellow solid. The yellow solid was isolated from the orange solution, washed with pentane (3 mL×2), and dried in vacuo; yield 3.73 g (90%). Recrystallization of the yellow solid from a mixture of ether and pentane solution at −35° C. gave yellow crystals. ¹H NMR (C₆D₆, 500 MHz) δ 7.55 (m, 4, Ar), 7.28 (d, 2, Ar), 7.05-7.18 (m, 9, Ar), 6.32 (t, 1, Ar), 6.20 (t, 1, Ar), 3.43 (septet, 2, CHMe₂), 3.34 (s, 8, OCH₂CH₂), 1.31 (d, 6, CHMe₂), 1.22 (m, 8, OCH₂CH₂), 0.99 (d, 6, CHMe₂). ⁷Li{¹H} NMR (C₆D₆, 194 MHz) δ 1.37 (d, ¹J_{LiP}=38). ³¹P{¹H} NMR (C₆D₆, 202 MHz) δ −11.99 (1:1:1:1 q, ¹J_{Lip}=38). ¹³C NMR (C₆D₆, 125.5 MHz) δ 165.39 (J_{CP}=21.25), 152.23 (J_{CP}=3.63), 145.10, 138.45 (J_{CP}=7.25), 135.29, 134.41 (J_{CP}=17.13, CH), 132.43 (CH), 128.95 (CH), 128.87 (J_{CP}=7.13, CH), 124.04 (CH), 122.04 (CH), 114.02 (J_{CP}=4.5, CH), 113.74 (J_{CP}=2.63, CH), 109.94 (CH), 68.76 (OCH₂CH₂), 28.08 (CHMe₂), 25.68 (OCH₂CH₂), 25.66 (CHMe₂), 24.86 (CHMe₂).

Synthesis of [NP]₂Zn. Anhydrous ZnCl₂ (50 mg, 0.3653 mmol) was suspended in diethyl ether (5 mL) and cooled to −35° C. A solution of [NP]Li(THF)₂ (0.4289 mg, 0.7306 mmol, 2 equiv) in diethyl ether (10 mL) at −35° C. was added dropwise. The reaction mixture was stirred at room temperature overnight and passed through a pad of Celite to remove insoluble materials. The ether solution was concentrated in vacuo to ˜3 mL and cooled to −35° C. to afford pale yellow crystals; yield 137.7 mg (40%). Analogous condition was employed for the 1:1 reaction, affording crystals of [NP]₂Zn in 38% yield. ¹H NMR (C₆D₆, 500 MHz) δ 7.30 (m, 2, Ar), 7.08 (m, 10, Ar), 7.04 (m, 2, Ar), 6.89 (m, 4, Ar), 6.76 (m, 6, Ar), 6.41 (t, 2, Ar), 6.29 (m, 4, Ar), 6.17 (m, 4, Ar), 4.22 (septet, 2, CHMe₂), 3.18 (septet, 2, CHMe₂), 1.43 (d, 6, CHMe₂), 1.18 (d, 6, CHMe₂), 0.81 (d, 6, CHMe₂), 0.16 (d, 6, CHMe₂). ¹³C NMR (C₆D₆, 125.679 MHz) δ 164.71, 148.14, 147.98, 146.97, 133.75 (CH), 131.95, 130.91 (CH), 130.64, 128.08 (CH), 126.02 (CH), 2125.51 (CH), 124.67 (CH), 118.97 (CH), 116.62 (CH), 114.35 (CH), 110.85 (CH), 28.19 (CHMe), 28.20 (CHMe), 26.92 (CHMe), 24.90 (CHMe), 24.44 (CHMe), 23.75 (CHMe). ³¹P{¹H} NMR (C₆D₆, 202.5 MHz) δ −22.93. Satisfactory analysis was hampered due to the extreme air- and moisture-sensitivity of this compound.

### EXAMPLE 2

### Synthesis of [PNP]NiZ⁴

General Procedures. Unless otherwise specified, all experiments were performed under nitrogen using standard Schlenk or glovebox techniques. All solvents were reagent grade or better and purified by standard methods. All other chemicals were used as received from commercial vendors. The NMR spectra were recorded on Varian instruments. Chemical shifts (δ) are listed as parts per million downfield from tetramethylsilane and coupling constants (J) are in hertz. ¹H NMR spectra are referenced using the residual solvent peak at δ 7.16 for C₆D₆, and δ 7.27 for CDCl₃. ¹³C NMR spectra are referenced using the residual solvent peak at δ 128.39 for C₆D₆, and δ 77.23 for CDCl₃. The assignment of the carbon atoms for all new compounds is based on the DEPT ¹³C NMR spectroscopy. ¹⁹F, ³¹P and ⁷Li NMR spectra are referenced externally using CFCl₃ in CHCl₃ at δ0, 85% H₃PO₄ at δ 0, and LiCl in D₂O at δ 0, respectively. Routine coupling constants are not listed. All NMR spectra were recorded at room temperature in specified solvents. Mass spectra were recorded on a Finnigan MAT 95XL Mass Spectrometer. Elemental analysis was performed on a Heraeus CHN—O Rapid analyzer. For some hydrocarbyl derivatives, the carbon analyses were reproducibly lower by ca. 1-2% than the expected values after several attempts, due likely to formation of carbides upon combustion of these compounds.

X-ray crystallography. Data for compounds H[PNP] and [PNP]Li(THF)₂ were collected on a Bruker SMART 1000 CCD diffractometer with graphite monochromated Mo-Kα radiation (λ=0.7107 Å). Structures were solved by direct methods and refined by full matrix least squares procedures against F² using SHELXTL. All full-weight non-hydrogen atoms were refined anisotropically. Hydrogen atoms were placed in calculated positions.

Synthesis of di(2-fluorophenyl)amine. A Schlenk flask was charged with 2-fluoroaniline (5.55 g, 50 mmol), 1-bromo-2-fluorobenzene (8.75 g, 50 mmol), Pd(OAc)₂ (0.020 g, 0.089 mmol, 0.5% equiv), DPEPhos (0.216 g, 0.401 mmol, 0.75% equiv), NaO^{t}Bu (7.185 g, 74.84 mmol, 1.4 equiv), and toluene (45 mL) under nitrogen. The reaction mixture was heated to reflux with stirring. The reaction was monitored by GC, which showed complete formation of the desired product in 1d. After being cooled to room temperature, the reaction was quenched with deionized water (45 mL). The organic portion was separated from the aqueous layer, which was further extracted with toluene (10 mL×2). The combined organic solution was dried over MgSO₄ and filtered. All volatiles were removed in vacuo to yield red oil, which was directly used for the subsequent reaction; yield 9.38 g (91.4%). ¹H NMR (CDCl₃, 500 MHz) δ 7.42 (m, 2, Ar), 7.25 (m, 2, Ar), 7.20 (m, 2, Ar), 7.04 (m, 2, Ar), 6.03 (br s, 1, NH). ¹⁹F NMR (CDCl₃, 470.5 MHz) δ −133.07. ¹³C NMR (CDCl₃, 125 MHz) δ 153.45 (J_{CF}=241, CF), 130.45 (J_{CF}=11.75, CN), 124.14 (J_{CF}=3.63, CH), 121.38 (J_{CF}=7.25, CH), 117.98 (CH), 115.45 (J_{CF}=19.00, CH). LR-MS (EI): calcd. for C₁₂H₉F₂N m/z 205, found m/z 205. Anal. Calcd. for C₁₂H₉F₂N: C, 70.24; H, 4.42; N, 6.83. Found: C, 70.13; H, 4.52; N, 6.69.

Synthesis of bis(2-diphenylphosphinophenyl)amine (H[PNP]). A 100-mL Schlenk flask equipped with a condenser was flashed with nitrogen thoroughly. To this flask was added KPPh₂ (20 mL, 0.5 M in THF solution, Aldrich, 10 mmol). THF was removed in vacuo and a solution of di(2-fluorophenyl)amine (1.00 g, 4.88 mmol) in 1,4-dioxane (8 ml) was added with a syringe. The transparent, ruby reaction solution was heated to reflux with stirring. The reaction condition was monitored by ³¹P{¹H} NMR spectroscopy, which revealed the completion of reaction in 2 d. The resulting yellow solution was evaporated to dryness in vacuo. The residue was treated with degassed deionized water (50 mL) and the product was extracted with deoxygenated dichloromethane (15 mL). The dichloromethane solution was separated from the aqueous layer, from which the product was further extracted with dichloromethane (15 mL×3). The combined organic solution was dried over MgSO₄ and filtered. All volatiles were removed in vacuo to yield the product as a pale yellow crystalline solid; yield 2.1 g (80.15%). ¹H NMR (CDCl₃, 300 MHz) δ 7.10-7.23 (m, 24, Ar), 6.69-6.76 (m, 5, Ar and NH). ³¹P{¹H} NMR (CDCl₃, 121.5 MHz) δ −19.58. ³¹P{¹H} NMR (Et₂O, 121.5 MHz) δ −18.62. ¹³C NMR (CDCl₃, 75 MHz) δ 146.51 (J_{CP}=21.1), 135.78 (J_{CP}=8.0), 134.14, 133.72 (J_{CP}=21.1), 129.64, 128.53 (J_{CP}=12.0), 128.46 (J_{CP}=7.5), 126.34 (J_{CP}=10.1), 121.51, 118.16. Anal. Calcd. for C₃₆H₂₉NP₂: C, 80.43; H, 5.44; N, 2.61. Found: C, 80.04; H, 5.56; N, 2.69.

Synthesis of [PNP]Li(THF)₂. n-Butyllithium (3.35 mL, 1.6 M in hexanes, 5.36 mmol, 1.6 equiv) was added dropwise to a THF solution (20 mL) of H[PNP] (1.80 g, 3.35 mmol) at −35 C with stirring. Gas evolution was observed upon addition of the lithium reagent. The reaction solution was naturally warmed to room temperature and stirred for 2 h. All volatiles were removed in vacuo. The solid residue was triturated with pentane (5 mL×2), providing the product as a pale yellow solid which was isolated and dried in vacuo; yield 1.84 g (78.46%). Single crystals for X-ray diffraction analysis were grown from a concentrated THF solution at room temperature. ¹H NMR (C₆D₆, 500 MHz) δ 7.63 (t, 2, Ar), 7.45 (m, 6, Ar), 6.97-7.17 (m, 18, Ar), 6.52 (t, 2, Ar), 3.48 (m, 8, OCH₂CH₂), 1.25 (m, 8, OCH₂CH₂). ³¹P{¹H} NMR (THF, 121.5 MHz) δ −13.68 (sharp). ³¹P{¹H} NMR (C₆D₆, 202 MHz) δ −14.44 (br s, 3.3 Hz peak width at half-height). ⁷Li{¹H} NMR (C₆D₆, 194.2 MHz) δ 2.42 (br s, 55.93 Hz peak width at half-height). ¹³C NMR (CDCl₃, 125.5 MHz) δ 163.26 (J_{CP}=19.75), 138.47 (CN), 134.84 (CH), 134.29 (J_{CP}=17.00, CH), 131.47 (CH), 128.87 (J_{CP}=6.63, CH), 128.77 (CH), 122.90 (J_{CP}=16.00), 117.89 (CH), 115.78 (CH), 68.70 (OCH₂CH₂), 25.88 (OCH₂CH₂).

Synthesis of [PNP]NiCl. Solid NiCl₂(DME) (172.7 mg, 0.785 mmol) was suspended in THF (10 mL) and cooled to −35° C. A cold solution of [PNP]Li(THF)₂ (540 mg, 0.785 mmol) in THF (10 mL) at −35° C. was added dropwise to the suspension to result in gradual dissolution of solid NiCl₂(DME), and a homogeneous dark green solution formed. The reaction mixture was stirred at room temperature for 2 h. All volatiles were removed in vacuo. The solid residue was extracted with CH₂Cl₂ (20 mL). The green CH₂Cl₂ solution was filtered through a pad of Celite and evaporated to dryness, providing the product as a green solid, yield 464 mg (93.6%). ¹H NMR (C₆D₆, 500 MHz) δ 7.92-7.95 (m, 8, Ar), 7.61 (d, 2, Ar), 6.96-7.04 (m, 14, Ar), 6.83 (t, 2, Ar), 6.35 (t, 2, Ar). ³¹P{¹H} NMR (C₆D₆, 202 MHz) δ 18.77. ¹³C{¹H}NMR (C₆D₆, 125 MHz) δ 163.31 (t, J_{CP}=14.43), 135.15 (CH), 134.38 (t, J_{CP}=5.90, CH), 132.38 (CH), 130.95 (CH), 130.69 (t, J_{CP}=23.97), 129.29 (t, J_{CP}=4.89, CH), 123.65 (t, J_{CP}=23.47), 118.51 (t, J_{CP}=3.14, CH), 117.87 (t, J_{CP}=5.90, CH). Anal. Calcd. for C₃₆H₂₈ClNNiP₂: C, 68.56; H, 4.47; N, 2.22. Found: C, 68.36; H, 4.57; N, 2.18.

General procedures for the synthesis of [PNP]NiR (R=Me, Et, n-Bu, i-Bu, CH₂SiMe₃, Ph). Alkyl magnesium chloride (1 equiv) was added dropwise to a green solution of [PNP]NiCl in THF at −35° C. Upon addition, the solution became red in color. After being stirred at room temperature for 2.5 h, the reaction solution was stripped to dryness, triturated with pentane, extracted with benzene, and passed through a pad of Celite. The solvent was removed in vacuo to afford the desired product. The hydrocarbyl compounds are typically red in color.

Synthesis of [PNP]NiMe. Yield 93%. ¹H NMR (C₆D₆, 499.767 MHZ) δ 7.813 (m, 2, Ar), 7.687 (m, 8, Ar), 7.109 (m, 2, Ar), 6.979 (m, 14, Ar), 6.425 (t, 2, Ar), 0.128 (t, 3, ³J_{HP}=8.5 Hz, NiCH₃). ³¹P{¹H} NMR (C₆D₆, 202.306 MHz) δ 27.605. ³¹P{¹H} NMR (THF, 121.416 MHz) δ 27.270. ³¹P{¹H} NMR (CH₂Cl₂, 121.415 MHz) δ 27.150. ¹³C{¹H} NMR (C₆D₆, 125.678 MHz) δ 162.746 (t, J_{CP}=14.1 Hz, C), 134.932 (s, CH), 134.107 (t, J_{CP}=5.9 Hz, CH), 132.587 (t, J_{CP}=21.9 Hz, C), 132.385 (s, CH), 130.416 (s, CH), 129.237 (t, J_{CP}=4.5 Hz, CH), 125.091 (t, J_{CP}=22.7 Hz, C), 117.153 (s, CH), 116.386 (s, CH), −15.365 (t, J_{CP}=21.9 Hz, NiCH₃). Anal. Calcd. for C₃₇H₃₁NNiP₂: C, 72.82; H, 5.12; N, 2.30. Found: C, 71.49; H, 5.39; N, 2.27.

Synthesis of [PNP]NiEt. Yield 93%. ¹H NMR (C₆D₆, 499.767 MHz) δ 7.759 (m, 10, Ar), 7.175 (m, 2, Ar), 7.029 (m, 12, Ar), 6.969 (t, 2, Ar), 6.439 (t, 2, Ar), 1.074 (qt, 2, ³J_{HP}=2 Hz, ³J_{HH}=7.5 Hz, NiCH₂), 0.755 (t, 3, CH₃). ³¹P{¹H} NMR (THF, 121.416 MHz) δ 27.578. ³¹P{¹H} NMR (C₆D₆, 202.310 MHz) δ 26.418. ¹³C{¹H} NMR (C₆D₆, 125.678 MHz) δ 162.554 (t, J_{CP}=13.64 Hz, C), 134.476 (s, CH), 134.144 (t, J_{CP}=6.35 Hz, CH), 132.750 (t, J_{CP}=21.37 Hz, C), 132.288 (s, CH), 130.397 (s, CH), 129.191 (t, J_{CP}=4.52 Hz, CH), 125.509 (t, J_{CP}=22.62 Hz, C), 117.026 (t, J_{CP}=3.64 Hz, CH), 116.362 (t, J_{CP}=4.59 Hz, CH), 15.357 (t, ³J_{CP}=2.7 Hz, CH₃), −2.800 (t, ²J_{CP}=19.48 Hz, NiCH₂). Anal. Calcd. for C₃₈H₃₃NNiP₂: C, 73.11; H, 5.33; N, 2.24. Found: C, 70.85; H, 5.33; N, 2.25.

Synthesis of [PNP]Ni(n-Bu). Yield 100%. ¹H NMR (C₆D₆, 499.767 MHZ) δ 7.782 (m, 10, Ar), 7.202 (dt, 2, Ar), 7.036 (m, 12, Ar), 6.969 (t, 2, Ar), 6.446 (t, 2, Ar), 1.090 (m, 2, NiCH₂), 0.980 (m, 4, NiCH₂(CH₂)₂CH₃), 0.587 (t, 3, CH₃). ³¹P{¹H} NMR (THF, 121.416 MHz) δ 26.79. ³¹P{¹H} NMR (C₆D₆, 202.306 MHz) δ 27.056. ¹³C{¹H} NMR (C₆D₆, 125.678 MHz) δ 162.576 (t, J_{CP}=13.57 Hz, C), 134.419 (s, CH), 134.144 (t, J_{CP}=6.35 Hz, CH), 132.816 (t, J_{CP}=21.3 Hz, C), 132.303 (s, CH), 130.412 (s, CH), 129.141 (t, J_{CP}=4.96 Hz, CH), 125.524 (t, J_{CP}=23.19 Hz, C), 117.019 (t, J_{CP}=3.14 Hz, CH), 116.377 (t, J_{CP}=5.03 Hz, CH), 33.285 (s, CH₂), 28.216 (s, CH₂), 14.289 (s, CH₃), 5.243 (t, J_{CP}=19.10 Hz, NiCH₂).

Synthesis of [PNP]Ni(i-Bu). Yield 76%. ¹H NMR (C₆D₆, 499.767 MHz) δ 7.796 (m, 8, Ar), 7.701 (m, 2, Ar), 7.143 (m, 2, Ar), 7.033 (m, 12, Ar), 6.951 (t, 2, Ar), 6.424 (t, 2, Ar), 1.677 (m, 1, CH), 1.019 (q, 2, J=7.5 Hz, NiCH₂), 0.749 (d, 6, CH₃). ³¹P{¹H} NMR (THF, 121.416 MHz) δ 27.578. ³¹P{¹H} NMR (C₆D₆, 202.310 MHz) δ 26.795. ¹³C{¹H} NMR (C₆D₆, 125.679 MHz) δ 162.438 (t, J_{CP}=13.13 Hz, C), 134.303 (s, CH), 134.122 (t, J_{CP}=6.35 Hz, CH), 132.989 (t, J_{CP}=21.3 Hz, C), 132.318 (s, CH), 130.469 (s, CH), 129.141 (t, J_{CP}=4.52 Hz, CH), 125.914 (t, J_{CP}=23.12 Hz, C), 117.033 (s, CH), 116.304 (s, CH), 34.266 (s, NiCH₂CHMe₂), 27.703 (s, NiCH₂CHMe₂), 18.527 (t, ³J_{CP}=19.54 Hz, NiCH₂CHMe₂).

Synthesis of [PNP]NiCH₂SiMe₃. Yield 100%. ¹H NMR (C₆D₆, 500 MHz) δ 7.83-7.87 (m, 8, Ar), 7.70 (d, 2, Ar), 7.23 (m, 2, Ar), 7.03 (m, 12, Ar), 6.94 (t, 2, Ar), 6.46 (t, 2, Ar), −0.08 (t, 2, ³J_{HP}=12, NiCH₂), −0.17 (s, 9, Si(CH₃)₃). ³¹P{¹H} NMR (C₆D₆, 202 MHz) δ 23.90. ¹³C NMR (C₆D₆, 125 MHz) δ 162.27 (t, J_{CP}=14.55), 134.47 (t, J_{CP}=5.5, CH), 134.03 (CH), 132.94 (t, J_{CP}=20.96), 132.15 (CH), 130.50 (CH), 129.12 (t, J_{CP}=4.52, CH), 125.71 (t, J_{CP}=22.84), 117.19 (CH), 116.81 (t, J_{CP}=4.52, CH), 3.55 (SiCH₃), −12.97 (t, ²J_{CP}=18.83, NiCH₂). Anal. Calcd. for C₄₀H₃₉NNiP₂Si: C, 70.40; H, 5.76; N, 2.05. Found: C, 70.09; H, 5.79; N, 2.10.

Synthesis of [PNP]NiPh. Yield 97%. ¹H NMR (C₆D₆, 499.767 MHz) δ 7.935 (dt, 2, Ar), 7.486 (m, 8, Ar), 7.173 (m, 2, Ar), 7.119 (m, 2, Ar), 7.036 (m, 2, Ar), 7.463 (m, 12, Ar), 6.726 (t, 2, Ar), 6.667 (m, 1, Ar), 6.457 (t, 2, Ar). ³¹P{¹H} NMR (C₆D₆, 202.310 MHz) δ 24.446. ¹³C{¹H} NMR (C₆D₆, 125.679 MHz) δ 163.086 (t, J_{CP}=14.1 Hz, C), 150.966 (t, ²J_{CP}=28.2 Hz, NiC), 138.542 (t, J_{CP}=3.6 Hz, CH), 135.351 (s, CH), 133.983 (t, J_{CP}=3 Hz, CH), 132.435 (s, CH), 131.299 (t, J_{CP}=23.6 Hz, C), 129.389 (s, CH), 128.969 (t, J_{CP}=5 Hz, CH), 126.328 (s, CH), 124.758 (t, J_{CP}=22.2 Hz, C), 121.849 (s, CH), 117.493 (s, CH), 116.697 (t, J_{CP}=5 Hz, CH).

### EXAMPLE 3

Synthesis of [MeNP]NiZ or [ⁱPr—NP]NiZ

General Procedures. Unless otherwise specified, all experiments were performed under nitrogen using standard Schlenk or glovebox techniques. All solvents were reagent grade or better and purified by standard methods. The NMR spectra were recorded on Varian instruments. Chemical shifts (δ) are listed as parts per million downfield from tetramethylsilane, and coupling constants (J) and peak widths at halfheight (Δν_{1/2}) Δare in hertz. ¹H NMR spectra are referenced using the residual solvent peak at δ 7.16 for C₆D₆ and δ 2.09 for toluene-d8 (the most upfield resonance). ¹³C NMR spectra are referenced using the residual solvent peak at δ 128.39 for C₆D₆. The assignment of the carbon atoms for all new compounds is based on the DEPT ¹³C NMR spectroscopy. ³¹P and ⁷Li NMR spectra are referenced externally using 85% H₃PO₄ at δ 0 and LiCl in D₂O at δ 0, respectively. Routine coupling constants are not listed. All NMR spectra were recorded at room temperature in specified solvents unless otherwise noted. Elemental analysis was performed on a Heraeus CHN—O Rapid analyzer.

Materials. Compounds N-(2-diphenylphosphinophenyl)-2,6-diisopropylaniline (H[ⁱPr—NP]), N-(2-diphenylphosphinophenyl)-2,6-dimethylaniline (H[Me-NP]), and [ⁱPr—NP]Li(THF)₂ were prepared according to the procedures reported previously. All other chemicals were obtained from commercial vendors and used as received.

X-ray Crystallography. Data for compounds H[ⁱPr—NP] and [Me-NP]Li(THF)₂ were collected on a Bruker SMART 1000 CCD diffractometer with graphite-monochromated Mo Kα radiation (λ=0.7107 Å). Structures were solved by direct methods and refined by full matrix least squares procedures against F² using SHELXTL. All full-weight non-hydrogen atoms were refined anisotropically. Hydrogen atoms were placed in calculated positions. Data for compounds [ⁱPr—NP]NiCl(PMe₃), [ⁱPr—NP]NiMe(PMe₃), [ⁱPr—NP]NiPh(PMe₃), [ⁱPr—NP]Ni(η₃-CH₂Ph), and [Me-NP]Ni-(η₃-CH₂Ph) were collected on a Bruker-Nonius Kappa CCD diffractometer with graphite-monochromated Mo Kα radiation (λ=0.7107 Å). Structures were solved by direct methods and refined by full matrix least squares procedures against F² using the maXus or WinGX crystallographic software package. All full-weight non-hydrogen atoms were refined anisotropically. Hydrogen atoms were placed in calculated positions.

Synthesis of [Me-NP]Li(THF)₂. To a solution of H[Me-NP] (2.0 g, 5.24 mmol) in THF (15 mL) at −35° C. was added n-BuLi (3.3 mL, 5.24 mmol, 1 equiv). The reaction mixture was naturally warmed to room temperature and stirred for 3 h. All volatiles were removed in vacuo. The red viscous residue was triturated with pentane (15 mL) to yield a yellow solid. The yellow solid was isolated from the orange solution, washed with pentane (5 mL_{—}3), and dried in vacuo; yield 2.67 g (99%). Recrystallization of the yellow solid from a concentrated diethyl ether solution at −35° C. gave yellow crystals suitable for X-ray crystallography. ¹H NMR (C₆D₆, 500 MHz): δ 7.58 (m, 4, Ar), 7.23 (d, 2, Ar), 7.07-7.16 (m, 8, Ar), 6.97 (m, 1, Ar), 6.38 (m, 1, Ar), 6.33 (m, 1, Ar), 3.23 (m, 8, OCH₂CH₂), 2.26 (s, 6, CH₃), 1.19 (m, 8, OCH₂CH₂). ³¹P{¹H} NMR (C₆D₆, 202 MHz): δ −13.66 (br s, Δv_{1/2}) 75 Hz}. ³¹P{¹H}NMR (toluened8, 202 MHz): δ−12.96. ³¹P{¹H} NMR (toluene-d8, −20° C., 202 MHz): δ −12.72 (1:1:1:1 q, 1JLiP) 34 Hz}. ⁷Li{¹H} NMR (C₆D₆, 194 MHz): δ 1.37 (br s, Δν_{1/2}) 21 Hz}. ⁷Li{¹H}NMR (toluene-d8, 194 MHz): δ 2.08. ⁷Li{¹H}NMR (toluene-d8, −20° C., 194 MHz): δ 2.12 (d, 1JLiP) 34 Hz). ¹³C NMR (C₆D₆, 125.5 MHz): δ 163.88 (J_{CP}) 21.63, CP), 154.81, 138.20 (PCCN), 135.69 (CH), 134.38 (J_{CP}) 16.25, CH), 134.06, 132.74 (CH), 129.00 (CH), 128.88 (J_{CP}) 6.63, CH), 128.68 (CH), 120.65 (CH), 114.00 (J_{CP}) 3.75 Hz), 113.01 (CH), 110.47 (CH), 68.70 (OCH₂CH₂), 25.61 (OCH₂CH₂), 19.73 (CH₃).

Synthesis of [ⁱPr—NP]NiCl₂. Method 1: Solid NiCl₂-(DME) (400 mg, 1.818 mmol) was suspended in THF (60 mL) and cooled to −35° C. To this was added dropwise a solution of [ⁱPr—NP]Li(THF)₂ (1.0672 g, 1.818 mmol) in THF (20 mL) at −35° C. Upon addition, the reaction mixture became red in color and the suspended NiCl₂(DME) dissolved. The solution was stirred at room temperature overnight. All volatiles were removed in vacuo. The resulting viscous, reddish-brown residue was dissolved in CH₂Cl₂ (15 mL) and passed through a pad of Celite, which was further washed with CH₂Cl₂ (2 mL) until the washings were colorless. The filtrate was evaporated in vacuo to dryness to give the product as a deep red solid, which was gently washed with diethyl ether (3 mL_{—}2) and dried in vacuo; yield 780.6 mg (81%). Method 2: Solid NiCl₂-(DME) (100 mg, 0.454 mmol) was suspended in THF (15 mL) at room temperature. To this was added a THF solution (5 mL) of H[ⁱPr—NP] (198.9 mg, 0.454 mmol). The reaction mixture was stirred at room temperature for 30 min, and NEt₃ (0.095 mL, 0.681 mmol, 1.5 equiv) was added. After being stirred for 1 h, the reaction mixture was evaporated to dryness under reduced pressure. The residue was triturated with pentane (2 mL_{—}2). The product was extracted with CH₂Cl₂ (10 mL) and filtered through a pad of Celite. Solvent was removed in vacuo to afford the crude product as a brick-red solid. The product was purified by dissolving the solid in a minimal amount of THF (ca. 1 mL) followed by addition of pentane (3 mL) to induce the precipitation of a red solid. The red solid was isolated by decantation of the solution, washed with pentane, and dried in vacuo; yield 150 mg (62%). ¹H NMR (C₆D₆, 500 MHz): δ 7.75 (m, 4, Ar), 7.09 (m, 3, Ar), 7.00-7.04 (m, 6, Ar), 6.79 (m, 1, Ar), 6.64 (t, 1, Ar), 6.09 (t, 1, Ar), 5.85 (d, 1, Ar), 3.94 (septet, 2, CHMe₂), 1.51 (d, 6, CHMe₂), 1.11 (d, 6, CHMe₂). ³¹P{¹H}NMR (C₆D₆, 202.5 MHz): δ 32.45 (br s, Δν_{1/2}) 80 Hz}. ³¹P{¹H}NMR (THF, 121.4 MHz): δ 33.06 (br s). ¹³C NMR (C₆D₆, 125.5 MHz): δ 167.63, 147.92, 145.77, 133.88 (CH), 133.64 (CH), 132.81 (CH), 131.27 (CH), 129.92 (J_{CP}) 44.80), 129.26 (CH), 125.93 (CH), 124.12 (CH), 116.71 (CH), 114.05 (CH), 117.5 (J_{CP}) 37.65). Anal. Calcd for (C₃₀H₃₁ClNNiP)₂: C, 67.90; H, 5.89; N, 2.64. Found: C, 68.12; H, 6.44; N, 2.51.

Synthesis of [ⁱPr—NP]NiCl(PMe₃). PMe₃ (0.38 mL, 1.0 M in THF, Aldrich, 0.38 mmol, 1 equiv per nickel) was added to a red solution of [ⁱPr—NP]NiCl₂ (200 mg, 0.19 mmol) in THF (8 mL) at room temperature. The solution became green in color over the course of 30 min. After being stirred at room temperature overnight, the solution was evaporated to dryness under reduced pressure. The product was isolated as a green solid, which was spectroscopically pure by ³¹P{¹H}NMR spectroscopy; yield 186.8 mg (81.6%). Emerald cubic crystals of [ⁱPr—NP]NiCl(PMe₃) suitable for X-ray diffraction analysis were grown by layering pentane on a concentrated THF solution at −35° C. ¹H NMR (C₆D₆, 500 MHz): δ 7.81 (m, 4, Ar), 7.34 (m, 3, Ar), 7.03 (m, 2, Ar), 6.99 (m, 4, Ar), 6.79 (t, 1, Ar), 6.71 (m, 1, Ar), 6.21 (t, 1, Ar), 6.08 (m, 1, Ar), 3.94 (septet, 2, CHMe₂), 1.65 (d, 6, CHMe₂), 1.20 (d, 6, CHMe₂), 0.74 (d, 9, J_{HP}) 9.5, PMe₃}. ³¹P{¹H}NMR (C6D₆, 202.5 MHz): δ 47.29 (d, 2J_{PP}) 88 Hz}, −16.98 (d, 2J_{PP}) 88 Hz}. ³¹P{¹H} NMR (THF, 121.4 MHz): δ 46.89 (d, 2J_{PP}) 88 Hz}, −15.75 (d, 2J_{PP}) 88 Hz}. ¹³C{¹H}NMR (C₆D₆, 125.5 MHz): δ 146.47, 134.24, 134.12, 134.05, 131.91, 131.44, 129.37, 129.20, 125.60, 124.09, 116.20, 113.66, 29.14 (CHMe₂), 25.27 (CHMe₂), 24.97 (CHMe₂), 16.08 (dd, 1J_{CP}) 30.92, 3J_{CP}) 9.17, PMe₃). Anal. Calcd for C₃₃H₄₀ClNNiP₂: C, 65.32; H, 6.64; N, 2.31. Found: C, 64.72; H, 6.71; N, 2.35.

Synthesis of [ⁱPr—NP]NiMe(PMe₃). Solid [ⁱPr—NP]NiCl—(PMe₃) (56.7 mg, 0.094 mmol) was dissolved in THF (3 mL) and cooled to −35° C. To this was added MeMgCl (0.03 mL, 3 M in THF, Aldrich, 0.094 mmol) dropwise. The reaction mixture was naturally warmed to room temperature and stirred overnight. An aliquot was taken and examined by ³¹P-{¹H}NMR spectroscopy, which indicated complete consumption of [ⁱPr—NP]NiCl(PMe₃) and exhibited two pairs of doublet resonances with the relative intensities of ca. 9:1 (2J_{PP}) 30 Hz for major and 2J_{PP}} 302 Hz for minor}. All volatiles were removed in vacuo. The red residue thus obtained was triturated with pentane (2 mL_{—}2), extracted with benzene (6 mL), and filtered through a pad of Celite. The Celite pad was further washed with benzene (1 mL_{—}2) until the washings became colorless. Solvent was removed in vacuo to give the product as a ruby solid. Crystals suitable for X-ray crystallography were grown by slow evaporation of a concentrated benzene solution at room temperature; yield 43.6 mg (79%). The ¹H and ³¹P{¹H}NMR spectra of the X-ray quality crystals indicated the presence of two geometric isomers in a ratio of ca. 3:1 with the major corresponding to a cis relationship between the two phosphorus donors. Spectroscopic data for the major isomer: ¹H NMR (C₆D₆, 500 MHz): δ 7.78 (m, 4, Ar), 7.40 (m, 3, Ar), 7.08 (m, 2, Ar), 7.05 (m, 4, Ar), 6.92 (dt, 1, Ar), 6.87 (dt, 1, Ar), 6.28 (t, 1, Ar), 6.12 (dd, 1, Ar), 3.90 (septet, 2, CHMe₂), 1.46 (d, 6, CHMe₂), 1.24 (d, 6, CHMe₂), 0.70 (d, 9, 2J_{HP}) 9 Hz, PMe₃}, −0.12 (dd, 3, 3J_{HP}NP) 4.0 Hz, 3J_{HP} PMe₃} 7.5 Hz, NiMe}. ³¹P{¹H}NMR (C₆D₆, 202.3 MHz): δ 35.60 (d, 2JPP) 25.49 Hz, NP}, −7.46 (d, 2J_{PP}) 25.49 Hz, PMe₃}. ³¹P-{¹H}NMR (THF, 80.953 MHz): δ 35.25 (d, 2J_{PP}) 29.95 Hz, NP}, −6.26 (d, 2J_{PP}) 29.95 Hz, PMe₃}. ¹³C{¹H} NMR (C₆D₆, 125.678 MHz): 56 δ 28.55 (s, CHMe₂), 25.62 (s, CHMe₂), 24.65 (s, CHMe₂), 17.03 (dd, 1J_{CP}) 30 Hz, 3J_{CP}} 5 Hz, PMe₃}, 11.13 (dd, 2J_{CP} PMe₃) 38.84 Hz, 2J_{CP} NP} 58.69 Hz, NiMe}. Spectroscopic data for the minor isomer: ¹H NMR (C₆D₆, 500 MHz): 56 δ 3.84 (septet, 2, CHMe₂), 1.30 (d, 6, CHMe₂), 1.18 (d, 6, CHMe₂), 0.55 (dd, 9, 2J_{HP}) 7 Hz, 4J_{HP}} 1 Hz, PMe₃}, −0.42 (dd, 3, 3J_{HP} NP) 12 Hz, 3J_{HP} PMe₃} 7.5 Hz, NiMe}. ³¹P{¹H}NMR (C₆D₆, 202.3 MHz): δ 38.95 (d, 2J_{PP}) 301.04 Hz, NP), −17.96 (d, 2J_{PP}) 301.04 Hz, PMe₃}. ³¹P{¹H}NMR (THF, 80.953 MHz): δ 38.66 (d, 2J_{PP}) 302.3 Hz, NP), −17.10 (d, 2J_{PP}) 302.3 Hz, PMe₃}. 13C{¹H} NMR (C₆D₆, 125.678 MHz): 56 δ 28.85 (s, CHMe₂), 24.96 (s, CHMe₂), 24.21 (s, CHMe₂), 13.45 (d, 1J_{CP}) 23 Hz, PMe₃), NiMe not found. Anal. Calcd for C₃₄H₄₃—NNiP₂: C, 69.65; H, 7.39; N, 2.39. Found: C, 69.32; H, 7.35; N, 2.37.

Synthesis of [ⁱPr—NP]NiPh(PMe₃). Solid [ⁱPr—NP]NiCl—(PMe₃) (110 mg, 0.181 mmol) was dissolved in THF (6 mL) and cooled to −35° C. To this was added PhMgCl (0.09 mL, 2.05 M in THF, Strem, 0.181 mmol) dropwise. The reaction mixture was naturally warmed to room temperature and stirred overnight. All volatiles were removed in vacuo. The red solid residue was extracted with benzene (3 mL) and filtered through a pad of Celite, which was further washed with benzene (1 mL_{—}2) until the washings became colorless. Solvent was removed in vacuo to give the product as a brownish red solid; yield 100.8 mg (86%). Crystals suitable for X-ray analysis were grown by layering pentane on a concentrated diethyl ether solution at −35° C. ¹H NMR (C₆D₆, 500 MHz): δ 7.65 (m, 4, Ar), 7.46 (m, 1, Ar), 7.22 (m, 6, Ar), 7.04 (m, 6, Ar), 6.87 (td, 1, Ar), 6.65 (t, 2, Ar), 6.24 (t, 1, Ar), 5.99 (dd, 1, Ar), 4.11 (septet, 2, CHMe₂), 1.44 (d, 6, CHMe₂), 1.25 (d, 6, CHMe₂), 0.38 (d, 9, 2J_{HP}) 8, PMe₃). ³¹P{¹H}NMR (C₆D₆, 202.3 MHz): δ 33.00 (d, 2J_{PP}) 288, NP), −22.32 (d, 2J_{PP}) 288, PMe₃). ³¹P{¹H}NMR (THF, 121.42 MHz): δ 33.16 (d, 2J_{PP}) 286, NP), −21.24 (d, 2J_{PP}) 293, PMe₃}. ¹³C{¹H}NMR (C₆D₆, 125.679 MHz): δ 168.56 (d, J_{CP}) 33.68), 151.90 (dd, 2J_{CP}) 39.1, 2J_{CP}) 33.7, NiC), 147.99, 145.89, 139.00 (CH), 134.7 (CH), 133.72 (CH), 133.18 (CH), 132.98 (d, J_{CP}) 50.90), 130.19 (CH), 128.67 (CH), 128.20 (CH), 126.73 (CH), 124.95 (CH), 121.97 (CH), 115.14 (d, J_{CP}) 44.62), 114.53 (d, J_{CP}) 12.69, CH), 112.54 (d, J_{CP}) 7.29, CH), 29.13 (CHMe₂), 25.04 (CHMe₂), 24.31 (CHMe₂), 13.45 (d, 1J_{CP}) 23.6, PMe₃).

Synthesis of [ⁱPr—NP]Ni(η₃—CH₂Ph). Method 1: Solid [ⁱ—Pr—NP]NiCl₂ (500 mg, 0.47 mmol) was dissolved in THF (5 mL) and cooled to −35° C. To this was added dropwise a solution of PhCH₂MgCl (0.94 mL, 1.0MEt₂O solution, Aldrich, 0.94 mmol, 1 equiv per nickel). The reaction mixture was stirred at room temperature overnight and evaporated to dryness. The resulting residue was dissolved in CH₂Cl₂ (5 mL) and filtered through a pad of Celite. All volatiles were removed in vacuo to give a brownish red solid; yield 519 mg (94%). Method 2: Solid [ⁱPr—NP]NiCl(PMe₃) (76.6 mg, 0.126 mmol) was dissolved in THF (2 mL) and cooled to −35° C. To this was added dropwise a solution of PhCH₂MgCl (0.13 mL, 1.0MEt₂O solution, Aldrich, 0.13 mmol). The reaction mixture was stirred at room temperature overnight and evaporated to dryness under reduced pressure. The resulting residue was dissolved in benzene (5 mL) and filtered through a pad of Celite. All volatiles were removed in vacuo to give a brownish red solid; yield 63.8 mg (86%). Method 3: A solid mixture of [ⁱPr—NP]-Li(THF)₂ (200 mg, 0.341 mmol) and Ni(COD)₂ (93.72 mg, 0.341 mmol) was dissolved in THF (6 mL) at room temperature. To this was added a toluene solution of PhCH₂Cl (3.41 mL, 0.1 M, 0.341 mmol) at room temperature. After being stirred at room temperature for 3 h, the reaction mixture was evaporated to dryness under reduced pressure. The reddish brown solid residue was extracted with benzene (6 mL) and filtered through a pad of Celite. Solvent was removed in vacuo to afford the product as a brownish red solid; yield 178.5 mg (89%). Crystals suitable for X-ray diffraction analysis were grown by slow evaporation of a concentrated benzene solution at room temperature. ¹H NMR (C₆D₆, 500 MHz): δ 7.67 (m, 4, Ar), 7.22 (m, 3, Ar), 7.06 (m, 7, Ar), 6.85 (t, 1, Ar), 6.66 (t, 1, Ar), 6.57 (t, 2, Ar), 6.24 (t, 1, Ar), 6.14 (d, 2, Ar), 6.04 (t, 1, Ar), 3.46 (septet, 2, CHMe₂), 1.56 (d, 2, 3J_{HP}) 4, NiCH₂Ph), 1.12 (d, 12, CHMe₂). ¹H NMR (toluene-d8, 500 MHz): δ 7.64 (m, 4, Ar), 7.14 (m, 4, Ar), 7.07 (m, 4, Ar), 7.00 (m, 2, Ar), 6.80 (t, 1, Ar), 6.63 (m, 1, Ar), 6.55 (t, 2, Ar), 6.18 (t, 1, Ar), 6.11 (d, 2, Ar), 5.96 (t, 1, Ar), 3.41 (septet, 2, J) 7.5, CHMe₂), 1.52 (d, 2, 3J_{HP}) 3.5, NiCH₂), 1.12 (d, 6, J) 7.5, CHMe₂), 1.09 (d, 6, J) 7.5, CHMe₂). ³¹P-{¹H}NMR (C₆D₆, 202.5 MHz): δ 36.24. ³¹P{¹H}NMR (THF, 121.4 MHz): δ 36.27. ¹³C NMR (C₆D₆, 125.5 MHz): δ 168.11, 150.87, 145.36, 134.58 (CH), 134.35, 134.12, 133.30 (CH), 133.21 (CH), 130.62 (CH), 129.24 (J_{CP}). 9.91, CH), 126.82 (CH), 124.42 (CH), 123.97 (CH), 117.45, 114.82 (CH), 114.73 (CH), 112.42 (J_{CP}) 7.28, CH), 110.28 (J_{CP}) 5.52, CH), 28.71 (CHMe₂), 28.53 (2J_{CP}) 9.04, 1J_{CH}) 152, NiCH₂Ph), 24.26 (CHMe₂). Anal. Calcd for C₃₇H₃₈NNiP: C, 75.79; H, 6.53; N, 2.39. Found: C, 75.76; H, 6.75; N, 2.33.

Synthesis of [Me-NP]Ni(η₃-CH₂Ph). Diethyl ether (6 mL) was added to a solid mixture of [Me-NP]Li(THF)₂ (200 mg, 0.38 mmol) and Ni(COD)₂ (103.5 mg, 0.38 mmol). To this suspension was added PhCH₂Cl (3.8 mL, 0.1 M stock solution in diethyl ether, 0.38 mmol) at room temperature. The reaction mixture was stirred at room temperature for 3 h. All volatiles were removed in vacuo. The product was extracted from the resulting solid residue with benzene (3 mL_{—}2). The deep brown solution was filtered through a pad of Celite, which was further washed with benzene (2 mL) until the washings were colorless. The combined filtrate was evaporated to dryness in vacuo to afford the product as a red solid; yield 188.2 mg (100%). Crystals suitable for X-ray diffraction analysis were grown by slow evaporation of a concentrated benzene solution at room temperature. ¹H NMR (C₆D₆, 500 MHz): δ 7.76-7.80 (m, 4, Ar), 7.23 (d, 2, Ar), 7.12-7.20 (m, 7, Ar), 7.07 (t, 1, Ar), 6.92 (m, 1, Ar), 6.65 (m, 1, Ar), 6.56 (t, 2, Ar), 6.32 (t, 1, Ar), 6.10 (dd, 1, Ar), 6.06 (d, 2, Ar), 2.17 (s, 6, CH₃), 1.55 (d, 2, 3J_{HP}) 4, NiCH₂Ph). ³¹P{C₆D₆}NMR (C₆D₆, 121.5 MHz): δ 34.84. ¹³C NMR (C₆D₆, 125.5 MHz): δ 166.67 (J_{CP}) 26.13), 151.91, 135.73, 134.63 (J_{CP}) 50.5), 134.06 (CH), 133.93 (CH), 133.49 (CH), 133.20 (J_{CP}) 11.75, CH), 130.57 (J_{CP}) 2.75, CH), 129.31 (J_{CP}) 10.75, CH), 128.68 (CH), 127.11 (J_{CP}) 2.63, CH), 123.42 (CH), 116.00, 114.69 (J_{CP}) 50.5), 112.50 (J_{CP}) 26.13, CH), 112.48 (J_{CP}) 8.13, CH), 110.60 (J_{CP}) 6.25, CH), 28.24 (2J_{CP}) 9.13, ¹J_{CH}) 154, NiCH₂Ph), 18.92 (1J_{CH}) 122, CH₃). Anal. Calcd for C₃₃H₃₀NNiP: C, 74.75; H, 5.70; N, 2.64. Found: C, 73.73; H, 5.87; N, 2.63.

### EXAMPLE 4

Synthesis of [MeNP]AlZ or [ⁱPr—NP]AlZ

General Procedures. Unless otherwise specified, all experiments were performed under nitrogen using standard Schlenk or glovebox techniques. All solvents were reagent grade or better and purified by standard methods. The NMR spectra were recorded on Varian instruments. Chemical shifts (δ) are listed as parts per million downfield from tetramethylsilane, and coupling constants (J) and peak widths at half-height (Δν_{1/2}) are in hertz. ¹H NMR spectra are referenced using the residual solvent peak at δ 7.16 for C₆D₆, δ 7.27 for CDCl₃, and δ 2.09 for toluene-d8 (the most upfield resonance). ¹³C NMR spectra are referenced using the residual solvent peak at δ 128.39 for C₆D₆ and δ 77.23 for CDCl₃. The assignment of the carbon atoms for all new compounds is based on DEPT ¹³C NMR spectroscopy. ¹⁹F, ³¹P, and ²⁷Al NMR spectra are referenced externally using CFCl₃ in CHCl₃ at δ 0, 85% H₃PO₄ at δ 0, and AlCl₃ in D₂O at δ 0, respectively. Routine coupling constants are not listed. All NMR spectra were recorded at room temperature in specified solvents unless otherwise noted. The ¹H-³¹P correlation experiments were carried out on a Varian Inova 500 MHz instrument using HMBC sequence. The NOE data were obtained with a ¹H NMR NOEDIF experimental apparatus. Elemental analysis was performed on a Heraeus CHN—O Rapid analyzer. For some aluminum complexes, we were not able to obtain satisfactory analysis due to extreme air and moisture sensitivity of these compounds.

Materials. Compounds N-(2-fluorophenyl)-2,6-diisopropylaniline, N-(2-diphenylphosphinophenyl)-2,6-diisopropylaniline (H[ⁱPr—NP]), and [ⁱPr—NP]Li(THF)₂ were prepared according to the procedures reported previously. All other chemicals were obtained from commercial vendors and used as received.

X-ray Crystallography. Data for compounds H[Me-NP] and [Me-NP]AlCl₂(THF) were collected on a Bruker SMART 1000 CCD diffractometer with graphite monochromated Mo Kα radiation (\grave{ι}) 0.7107 Å). Structures were solved by direct methods and refined by full-matrix least-squares procedures against F² using SHELXTL. All full-weight nonhydrogen atoms were refined anisotropically. Hydrogen atoms were placed in calculated positions. Data for compounds [Me—NP]AlEt₂ and [ⁱPr—NP]AlMe₂ were collected on a Bruker-Nonius Kappa CCD diffractometer with graphite monochromated Mo Kα radiation (ì) 0.7107 Å). Structures were solved by direct methods and refined by full-matrix least-squares procedures against F² using maXus. All full-weight non-hydrogen atoms were refined anisotropically. Hydrogen atoms were placed in calculated positions. The crystals of [Me—NP]AlEt₂ were of poor quality but sufficient to establish the identity of this molecule. The data set contains too many weak reflections, resulting in relatively high R-values.

Synthesis of N-(2-Fluorophenyl)-2,6-dimethylaniline. A 100-mL Schlenk flask was charged with 1-bromo-2-fluorobenzene (15.584 g, 89.05 mmol), 2,6-dimethylaniline (13.034 g, 107.56 mmol, 1.2 equiv), Pd(OAc)₂ (0.100 g, 0.445 mmol, 0.5% equiv), bis[2-(diphenylphosphino)phenyl]ether (DPEphos, 0.36 g, 0.668 mmol, 0.75% equiv), NaO^{t}Bu (12.0 g, 125 mmol, 1.4 equiv), and toluene (30 mL) under nitrogen. The reaction mixture was heated to reflux for 1 day. Toluene was removed in vacuo, and the reaction was quenched with deionized water (150 mL). The product was extracted with CH₂Cl₂ (200 mL), and the organic portion was separated from the aqueous layer, which was further extracted with CH₂Cl₂ (15 mL_{—}2). The combined organic solution was dried over MgSO₄ and filtered. All volatiles were removed in vacuo to yield orange viscous oil, which was subjected to flash column chromatography on silica gel (9:1 hexanes/Et₂O). The first band (pale yellow) was collected. Solvents were removed in vacuo to give a yellowish orange solid; yield 12.23 g (64%). ¹H NMR (CDCl₃, 200 MHz) δ 7.07-7.13 (m, 4, Ar), 6.87 (t, 1, Ar), 6.65 (m, 1, Ar), 6.22 (t, 1, Ar), 5.35 (br s, 1, NH), 2.22 (s, 6, CH₃). ¹⁹F NMR (CDCl₃, 470.5 MHz) δ −138.42. ¹³C NMR (CDCl₃, 125.5 MHz) δ 151.5 (J_{CF}) 237.4, CF), 137.2, 136.3, 134.7 (J_{CF}) 10.9, FCCN), 128.6 (CH), 126.3 (CH), 124.4 (J_{CF}) 2.8, CH), 117.4 (J_{CF}) 7.3, CH), 114.7 (J_{CF}) 18.1, CH), 113.1 (J_{CF}) 3.6, CH), 18.2 (CH₃). Anal. Calcd for C₁₄H₁₄FN: C, 78.11; H, 6.56; N, 6.51. Found: C, 77.88; H, 6.61; N, 6.48.

Synthesis of N-(2-Diphenylphosphinophenyl)-2,6-dimethylaniline, H[Me-NP]. A 100-mL Schlenk flask equipped with a condenser was flashed with nitrogen thoroughly. To this flask was added KPPh2 (110 mL, 0.5 M in THF solution, Aldrich, 55.0 mmol). THF was removed in vacuo, and a solution of −(2-fluorophenyl)-2,6-dimethylaniline (10.6 g, 49.26 mmol) in DME (50 mL) was added with a syringe. The transparent, ruby reaction solution was heated to reflux for 2 days, during which time the reaction condition was monitored by ³¹P{¹H}NMR spectroscopy. All volatiles were removed from the resulting orange solution under reduced pressure, and degassed deionized water (140 mL) was added. The product was extracted with deoxygenated dichloromethane (100 mL). The dichloromethane solution was separated from the aqueous layer, from which the product was further extracted with dichloromethane (20 mL_{—}2). The combined organic solution was dried over MgSO4 and filtered. All volatiles were removed in vacuo to yield a yellow solid. The yellow solid was purified by washing it with boiling MeOH (40 mL_{—}3) until it became a white powder; yield 15.98 g (85%). ¹H NMR (CDCl₃, 200 MHz) δ 7.41-7.60 (m, 10, PC₆H₅), 7.07-7.14 (m, 4, Ar), 6.89 (t, 1, Ar), 6.71 (t, 1, Ar), 6.20 (m, 1, Ar), 5.90 (d, 1, NH), 2.03 (s, 6, CH₃). ¹H NMR (C₆D₆, 500 MHz) δ 7.47 (m, 4, Ar), 7.11 (td, 1, Ar), 7.06 (m, 6, Ar), 6.94 (m, 4, Ar), 6.61 (t, 1, Ar), 6.31 (m, 1, Ar), 6.04 (d, 1, J_{HP}) 7, NH}, 1.98 (s, 6, CH₃). ³¹P{¹H}NMR (C₆D₆, 202 MHz) δ −19.3. ³¹P{¹H}NMR (Et₂O, 121.5 MHz) δ −18.9. ³¹P{¹H}NMR (CDCl₃, 121.5 MHz) δ −19.1. ¹³C{¹H}NMR (CDCl₃, 75.3 MHz) δ 148.6 (J_{CP}) 17.0), 138.2, 135.8, 135.2, 135.1, 134.1, 133.8, 130.3, 128.8 (Jcp) 18.8), 128.5 (Jcp) 13.5), 125.6, 119.9 (J_{CP}) 9.1), 118.2, 111.8, 18.2 (CH₃). Anal. Calcd for C₂₆H₂₄NP: C, 81.87; H, 6.34; N, 3.67. Found: C, 81.45; H, 6.42; N, 3.61

General Procedures for the Synthesis of [Me-NP]AlR₂ and [IPr—NP]AlR₂ (R=Me, Et). A Teflon-sealed reaction vessel was charged with a toluene solution containing an appropriate ligand precursor and 1 equiv of AlMe₃ (Aldrich, 2.0 M in toluene) or AlEt₃ (TCI, 15% in toluene). The colorless solution was heated to 110° C. for 2 days. Evaporation of the resulting yellow solution to dryness under reduced pressure afforded the product as pale-yellow microcrystals, which were recrystallized from 1:1 THF/Et₂O to give pale-yellow crystals.

Synthesis of [Me-NP]AlMe₂. Yield 93%. ¹H NMR (C₆D₆, 500 MHz) δ 7.40 (m, 4, Ar), 6.97-7.20 (m, 11, Ar), 6.42 (t, 1, Ar), 6.23 (t, 1, Ar), 2.22 (s, 6, C₆H₃Me₂), −0.24 (d, 6, AlCH₃, 3 J_{HP}=4). ¹³C{¹H}NMR (C₆D₆, 125.70 MHz) δ 160.8 (d, J_{CP}=20.1, C), 144.5 (d, J_{CP}=4.5, C), 137.5 (C), 135.2 (CH), 134.9 (CH), 134.0 (d, J_{CP}=12.8, CH), 131.1 (d, J_{CP}=1.8, CH), 129.7 (CH), 129.6 (d, J_{CP}=9.9, CH), 125.7 (CH), 116.1 (d, J_{CP}=5.5, CH), 114.7 (d, J_{CP}=6.4, CH), 110.9 (C), 110.6 (C), 19.3 (Ar CH₃), −8.7 (d, 2 J_{CP}=22, AlCH₃). ³¹P{¹H}NMR (C₆D₆, 202.31 MHz) δ−24.1 (Δν_{1/2}) 6 Hz). ²⁷Al NMR (C₆D₆, 130.22 MHz) δ 158 (Δv_{1/2}) 10 289 Hz). LRMS (EI) Calcd for C₂₈H₂₉AlNP m/z 437, found m/z 437. Anal. Calcd for C₂₈H₂₉AlNP: C, 76.87; H, 6.68; N, 3.20. Found: C, 73.95; H, 6.53; N, 3.22.

Synthesis of [ⁱPr—NP]AlMe₂. Yield 96%. ¹H NMR (C₆D₆, 500 MHz) δ7.38 (m, 4, Ar), 7.22 (m, 3, Ar), 7.01 (m, 7, Ar), 6.90 (t, 1, Ar), 6.40 (t, 1, Ar), 6.23 (t, 1, Ar), 3.35 (septet, 2, CHMe₂), 1.12 (d, 6, CHMe₂), 1.04 (d, 6, CHMe₂), −0.23 (d, 6, Al CH₃, 3 J_{HP}=4). ¹³C{¹H}NMR (C₆D₆, 125.70 MHz) δ 162.2 (d, J_{CP}=19.1, C), 148.0 (C), 141.9 (d, J_{CP}=4.5, C), 134.8 (CH), 134.7 (CH), 134.1 (CH), 131.1 (d, J_{CP}=1.8, CH), 129.5 (d, J_{CP}=10.0, CH), 12.7 (CH), 125.0 (CH), 117.1 (d, J_{CP}=6.4, CH), 116.6 (d, J_{CP}=6.4, CH), 112.0 (C), 111.6 (C), 28.4 (CH Me₂), 25.6 (CHMe₂), 25.2 (CHMe₂), −9.1 (d, 2 J_{CP}=20, AlCH₃). ³¹P{¹H}NMR (C₆D₆, 202.31 MHz) δ −21.6 (Δv_{1/2}) 7 Hz). 27Al NMR (C6D6, 130.22 MHz) δ 151 (Δν_{1/2}) 10 023 Hz). Anal. Calcd for C₃₂H₃₇AlNP: C, 77.87; H, 7.56; N, 2.84. Found: C, 77.19; H, 7.53; N, 2.88.

Synthesis of [Me-NP]AlEt₂. Yield 98%. ¹H NMR (C₆D₆, 500 MHz) δ 7.46 (m, 4, Ar), 7.10 (m, 2, Ar), 7.06 (m, 1, Ar), 6.97-7.04 (m, 7, Ar), 6.94 (m, 1, Ar), 6.42 (t, 1, Ar), 6.23 (t, 1, Ar), 2.23 (s, 6, C₆H₃Me₂), 1.20 (t, 6, AlCH₂CH₃), 0.43 (m, 4, AlCH₂). ¹H NMR (C7D8, 500 MHz) δ 7.35 (m, 4, Ar), 6.91 (m, 10, Ar), 6.80 (t, 1, Ar), 6.30 (t, 1, Ar), 6.07 (t, 1, Ar), 2.09 (s, 6, C₆H₃Me₂), 1.05 (t, 6, AlCH₂CH₃), 0.28 (m, 4, AlCH₂). ¹³C{¹H}NMR (C₆D₆, 125.70 MHz) δ 161.1 (d, J_{CP}=20.8, C), 144.8 (d, J_{CP}=4.5, C), 137.3 (C), 135.1 (CH), 134.8 (CH), 133.9 (d, J_{CP}=12.7, CH), 131.1 (d, J_{CP}=2.8, CH), 129.6 (CH), 129.5 (CH), 126.7 (CH), 116.2 (d, J_{CP}=6.4, CH), 114.8 (d, J_{CP}=6.4, CH), 110.7 (C), 110.4 (C), 19.2 (ArCH₃), 9.8 (d, 3 J_{CP}=1.9, 1CH₂CH₃), 0.9 (d, 2 J_{CP}=18, AlCH₂). ³¹P{¹H}NMR (C₆D₆, 202.31 MHz) δ −24.0 (Δν_{1/2}) 4 Hz}. 27AlNMR (C₆D₆, 130.22 MHz) δ 158 (Δν_{1/2}) 12 763 Hz}.

Synthesis of [ⁱPr—NP]AlEt₂. Yield 92%. ¹H NMR (C₆D₆, 500 MHz) δ 7.39 (m, 4, Ar), 7.16 (m, 3, Ar), 6.95-7.00 (m, 7, Ar), 6.84 (m, 1, Ar), 6.36 (t, 1, Ar), 6.18 (t, 1, Ar), 3.28 (septet, 2, CHMe₂), 1.18 (t, 6, AlCH₂CH₃), 1.10 (d, 6, CHMe₂), 0.98 (d, 6, CHMe₂), 0.48 (m, 2, AlCHAHB, 2J_{HH}=15), 0.37 (m, 2, AlCHAHB, 3 J_{HP}=7, 2J_{HH}=15). ¹H NMR (C7D8, 500 MHz) δ 7.44 (m, 4, Ar), 7.21 (m, 3, Ar), 7.02 (m, 7, Ar), 6.89 (t, 1, Ar), 6.41 (t, 1, Ar), 6.24 (t, 1, Ar), 3.32 (septet, 2, CHMe₂), 1.22 (t, 6, AlCH₂CH₃), 1.15 (d, 6, CHMe₂), 1.03 (d, 6, CHMe₂), 0.53 (m, 2, AlCHAHB), 0.42 (m, 2, AlCHAHB). ¹³C{¹H}NMR (C₆D₆, 125.70 MHz) δ162.5 (d, J_{CP}=20.0, C), 147.7 (C), 142.4 (d, J_{CP}) 4.5, C}, 134.7 (CH), 134.7 (CH), 134.0 (CH), 131.1 (d, J_{CP}=1.8, CH), 129.5 (d, J_{CP}=10.0, CH), 129.5 (CH), 126.6 (CH), 125.0 (CH), 117.3 (d, J_{CP}=5.4, CH), 116.6 (d, J_{CP}=5.4, CH), 111.8 (C), 111.5 (C), 28.4 (CHMe₂), 25.8 (CHMe₂), 24.9 (CHMe₂), 9.8 (d, 3 J_{CP}) 1.8, AlCH₂CH₃}, 0.2 (d, 2 J_{CP}=20, AlCH2). ³¹P{¹H}NMR (C₆D₆, 202.31 MHz) δ −21.4 (Δν_{1/2}) 4 Hz). 27Al NMR (C₆D₆, 130.22 MHz) δ 151.8 (Δν_{1/2}) 12 565 Hz). The coupling constants 2J_{HH} and 3 J_{HP} were determined by ¹H NMR spectroscopy with selective decoupling of â-hydrogen atoms. LRMS (EI) Calcd for C₃₄H₄₁AlNP m/z 521, found m/z 521.

Synthesis of [Me-NP]AlCl₂. To a solution of H[Me-NP] (2.0 g, 5.24 mmol) in THF (15 mL) at −35° C. was added n-BuLi (3.3 mL, 5.24 mmol, 1 equiv). The reaction mixture was naturally warmed to room temperature and stirred for 3 h. All volatiles were removed in vacuo. The red viscous residue was triturated with pentane (15 mL) to yield a yellow solid. The yellow solid was isolated from the orange solution, washed with pentane (5 mL_{—}3), and dried in vacuo to give [Me-NP]Li(THF)₂ as indicated by 1H¹H NMR spectroscopy; yield 2.67 g (99%). ¹H NMR (C₆D₆, 500 MHz) δ 7.58 (m, 4, Ar), 7.23 (d, 2, Ar), 7.07-7.16 (m, 8, Ar), 6.97 (m, 1, Ar), 6.38 (m, 1, Ar), 6.33 (m, 1, Ar), 3.23 (m, 8, OCH₂—CH₂), 2.26 (s, 6, CH₃), 1.19 (m, 8, OCH₂CH₂). Solid AlCl₃ (2.600 g, 1.950 mmol) was added in portions to a solution of [Me-NP]Li(THF)₂ (1.00 g, 1.881 mmol) in toluene (15 mL) at −35° C. The reaction mixture was stirred at room temperature for 4 days and filtered through a pad of Celite. Solvent was stripped from the filtrate to afford an off-white solid; yield 905 mg (100%). ¹H NMR (C₆D₆, 500 MHz) δ 7.53 (m, 4, Ar), 6.94-7.04 (m, 10, Ar), 6.89 (t, 1, Ar), 6.44 (t, 1, Ar), 6.22 (t, 1, Ar), 2.32 (s, 6, CH₃). ¹³C{¹H} NMR (C₆D₆, 125.5 MHz) δ 159.2 (d, J_{CP}=16.4, C), 143.0 (d, J_{CP}=5.4, C), 138.0 (C), 135.2 (CH), 134.4 (CH), 134.4 (CH), 131.7 (d, J_{CP}=2.8, CH), 129.8 (CH), 129.7 (d, J_{CP}=3.6, CH), 126.6 (CH), 126.2 (C), 118.2 (d, J_{CP}=6.3, CH), 115.2 (d, J_{CP}=5.4, CH), 110.4 (d, J_{CP}=46.3, C), 19.4 (Me). ³¹P{¹H} NMR (C₆D₆, 121.5 MHz) δ −36.1 (Δν_{1/2}) 137 Hz}. ²⁷Al NMR (C₆D₆, 130.22 MHz) δ94 (Δν_{1/2}) 293 Hz}. Recrystallization of [Me-NP]AlCl₂ from THF at −35° C. produced the solvated compound [Me-NP]—AlCl₂(THF) as colorless crystals suitable for X-ray crystallography. The recrystallization yield is typically 70%. ¹H NMR (C₆D₆, 500 MHz) δ 7.76 (m, 4, Ar), 7.14 (m, 1, Ar), 7.04 (m, 6, Ar), 6.97 (m, 2, Ar), 6.92 (m, 2, Ar), 6.50 (t, 1, Ar), 6.18 (t, 1, Ar), 3.58 (m, 4, OCH₂CH₂), 2.30 (s, 6, CH₃), 1.12 (m, 4, OCH₂CH₂). ¹³C{H}NMR (C₆D₆, 125.5 MHz) δ 159.2 (d, J_{CP}=20.3, C), 146.2 (d, J_{CP}=6.4, C), 138.5 (C), 135.9 (CH), 134.6 (d, J_{CP}=11.3, CH), 134.1 (CH), 130.8 (C), 130.5 (CH), 129.5 (CH), 129.1 (d, J_{CP}=9.5, CH), 126.0 (CH), 118.0 (d, J_{CP}=5.0, CH), 115.1 (d, J_{CP}=5.9, CH), 113.3 (d, J_{CP}=35.3, C), 71.1 (OCH₂CH₂), 25.3 (OCH₂CH₂), 19.3 (Me). ³¹P{¹H} NMR (C₆D₆, 121.5 MHz) δ −34.8 (Δν_{1/2}) 54 Hz). 27Al NMR (C₆D₆, 130.22 MHz) δ 74 (Δν_{1/2}) 351 Hz}.

Synthesis of [ⁱPr—NP]AlCl₂. Solid AlCl₃ (250 mg, 1.8749 mmol) was added in portions to a solution of [ⁱPr—NP]Li(THF)₂ (1.0658 g, 1.8157 mmol) in toluene (15 mL) at −35° C. The reaction mixture was stirred at room temperature for 4 days and filtered through a pad of Celite. Concentration of the filtrate under reduced pressure afforded [ⁱPr—NP]AlCl₂ as colorless crystals which were isolated by filtration and dried in vacuo; yied 951 mg (98.1%). ¹H NMR (C₆D₆, 500 MHz) δ7.38 (m, 4, Ar), 7.13 (m, 3, Ar), 6.95 (m, 2, Ar), 6.89 (m, 4, Ar), 6.79 (m, 2, Ar), 6.34 (t, 1, Ar), 6.22 (t, 1, Ar); 3.38 (septet, 2, CHMe₂), 1.18 (d, 6, CHMe₂), 0.95 (d, 6, CHMe₂). ¹³C{¹H}NMR (C₆D₆, 125.70 MHz) δ 160.5 (d, J_{CP}=14.6, C), 148.2 (C), 139.0 (d, J_{CP}=3.6, C), 135.1 (CH), 134.5 (CH), 134.5 (CH), 132.2 (d, J_{CP}=2.8, CH), 129.8 (d, J_{CP}=10.8, CH), 127.7 (CH), 125.3 (CH), 124.4 (d, J_{CP}=51.8, C), 118.7 (d, J_{CP}=6.3, CH), 117.6 (d, J_{CP}=5.4, CH), 109.9 (d, J_{CP}=51.0, C), 28.7 (CHMe₂), 25.5 (CHMe₂), 25.3 (CHMe₂). ³¹P{¹H}NMR (C₆D₆, 202.31 MHz) δ −34.4 (Δν_{1/2}) 180 Hz}. 27Al NMR (C₆D₆, 130.22 MHz) δ 99 (Δv_{1/2}) 295 Hz}. Recrystallization of [ⁱPr—NP]AlCl₂ from THF at −35° C. afforded [ⁱPr—NP]AlCl₂(THF) as colorless crystals. ¹H NMR (C₆D₆, 500 MHz) δ7.55 (m, 4, Ar), 7.16 (m, 5, Ar), 7.02 (m, 5, Ar), 6.93 (t, 1, Ar), 6.42 (t, 1, Ar), 6.19 (t, 1, Ar), 3.88 (m, 4, OCH₂CH₂) 3.44 (septet, 2, CHMe₂), 1.19 (m, 4, OCH₂CH₂), 1.14 (d, 6, CHMe₂), 0.97 (d, 6, CHMe₂). ¹³C{¹H}NMR (C₆D₆, 125.70 MHz) δ 159.8 (d, J_{CP}=17.2, C), 147.8 (C), 140.2 (d, J_{CP}=4.5, C), 134.2 (CH), 134.0 (CH), 133.9 (CH), 130.8 (d, J_{CP}=2.6, CH), 128.8 (d, J_{CP}=10.0, CH), 126.8 (CH), 124.6 (CH), 117.8 (d, J_{CP}) 6.4, CH}, 117.0 (d, J_{CP}=5.5, CH), 110.9 (C), 110.5 (C), 71.1 (OCH₂CH₂), 27.9 (CHMe₂), 25.1 (CHMe₂), 24.8 (OCH₂CH₂), 24.2 (CHMe₂). ³¹P{¹H}NMR (C₆D₆, 202.31 MHz) δ −33.7 (Δν_{1/2}) 85 Hz). ²⁷Al NMR (C₆D₆, 130.22 MHz) δ 69 (Δν_{1/2}) 387 Hz). Anal. Calcd for C₃₀H₃₁AlCl₂NP: C, 67.42; H, 5.85; N, 2.62. Found: C, 66.99; H, 7.07; N, 2.47.

Synthesis of [Me-NP]Al(CH₂SiMe₃)₂. A pentane solution of LiCH₂SiMe₃ (1.1 mL, 1 M in pentane, Aldrich, 1.10 mmol, 2 equiv) was added dropwise to a solution of [Me-NP]AlCl₂ (300 mg, 0.55 mmol) in toluene (10 mL) at −35° C. The reaction mixture was stirred at room temperature for 2 days. The insoluble materials thus produced were removed by filtration with a short column of Celite. Solvent was stripped and the product was obtained as a pale yellow solid; yield 286 mg (90%). Recrystallization from diethyl ether afforded colorless crystals. ¹H NMR (C₆D₆, 500 MHz) δ7.46 (m, 4, Ar), 7.09 (m, 2, Ar), 7.02 (m, 8, Ar), 6.94 (m, 1, Ar), 6.43 (t, 1, Ar), 6.18 (t, 1, Ar), 2.21 (s, 6, C₆H₃Me₂), 0.028 (s, 18, SiMe3), −0.30 (d, 2, AlCHAHB, 2J_{HH}=13), −0.39 (dd, 2, AlCHAHB, 3 J_{HP}=7, 2 J_{HH}=13). ¹³C{¹H}NMR (C₆D₆, 125.70 MHz) δ 161.5 (d, J_{CP}=20.0, C), 145.0 (d, J_{CP}=5.5, C), 137.8 (C), 135.5 (CH), 134.9 (CH), 133.9 (d, J_{CP}=11.8, CH), 131.2 (d, J_{CP}=1.9, CH), 129.9 (CH), 129.6 (d, J_{CP}=10.0, CH), 126.0 (CH), 116.3 (d, J_{CP}=5.4, CH), 115.0 (d, J_{CP}=6.4, CH), 111.1 (C), 110.7 (C), 19.7 (ArCH₃), 3.4 (SiMe), −2.2 (d, 2 J_{CP}=16, AlCH₂). ³¹P{¹H}NMR (C₆D₆, 202.31 MHz) δ −24.2 (Δν_{1/2}) 5 Hz). ²⁷Al NMR (C₆D₆, 130.22 MHz) δ 159 (Δν_{1/2}) 13 712 Hz). Anal. Calcd for C₃₄H₄₅ AlNPSi₂: C, 70.18; H, 7.80; N, 2.41. Found: C, 67.64; H, 6.99; N, 2.59.

### EXAMPLE 5

Synthesis of [PNP]PdZ

General Procedures. Unless otherwise specified, all experiments were performed under nitrogen using standard Schlenk or glovebox techniques. All solvents were reagent grade or better and were purified by standard methods. The compound [PNP]Li(THF)₂ was prepared as above. All other chemicals were used as received from commercial vendors. The NMR spectra were recorded on Varian instruments. Chemical shifts (δ) are listed as parts per million downfield from tetramethylsilane, and coupling constants (J) are in hertz. ¹H NMR spectra are referenced using the residual solvent peak at δ 7.16 for C₆D₆ and δ 7.27 for CDCl₃. ¹³C NMR spectra are referenced using the residual solvent peak at δ 128.39 for C₆D₆ and δ 77.23 for CDCl₃. The assignment of the carbon atoms for all compounds is based on DEPT ¹³C NMR spectroscopy. ³¹P NMR spectra are referenced externally using 85% H₃PO₄ at δ 0. Routine coupling constants are not listed. All NMR spectra were recorded at room temperature in specified solvents. Mass spectra were recorded on a Finnigan MAT 95XL mass spectrometer. Elemental analysis was performed on a Heraeus CHN—O Rapid analyzer. The Heck coupling reactions were analyzed by GC on a Varian Chrompack CP-3800 instrument equipped with a CP-Sil 5 CB Chrompack capillary column and the yields calculated versus aryl halides or dodecane as an internal standard. The identity of the products was confirmed by comparison with authentic samples.

X-ray Crystallography. Data for [PNP]PdCl (3a) were collected on a Bruker-Nonius Kappa CCD diffractometer with graphite-monochromated Mo Kα radiation (\grave{ι}) 0.7107 Å). Structures were solved by direct methods and refined by fullmatrix least-squares procedures against F² using maXus. All full-weight non-hydrogen atoms were refined anisotropically. Hydrogen atoms were placed in calculated positions.

Synthesis of [PNP]PdCl. Solid PdCl₂(PhCN)₂ (100 mg, 0.261 mmol) was dissolved in THF (4 mL) and cooled to −35° C. To this was added dropwise a cold THF solution (4 mL) of [PNP]Li(THF)₂ (180 mg, 0.267 mmol) at −35° C. The reaction mixture was stirred at room temperature for 1 h and evaporated to dryness under reduced pressure. The residue was triturated with pentane (9 mL), extracted with CH₂Cl₂ (10 mL), and filtered through a pad of Celite. Solvent was removed in vacuo. The residue was washed with pentane (15 mL) and dried in vacuo to yield the product as a brick red solid; yield 149 mg (84%). Single crystals suitable for X-ray crystallography were grown from a concentrated benzene solution at room temperature. ¹H NMR (C₆D₆, 500 MHz): δ 7.86 (m, 8, Ar), 7.78 (d, 2, Ar), 7.06 (m, 2, Ar), 6.93-6.99 (m, 10, Ar), 6.88 (t, 2, Ar), 6.63 (t, 2, Ar), 6.40 (t, 2, Ar). ³¹P{¹H}NMR (C₆D₆, 202.31 MHz): δ 29.79. ³¹P{¹H} NMR (THF, 80.95 MHz): δ 29.36. ¹³C{¹H} NMR (C₆D₆, 125.70 MHz): δ 163.18 (t, J_{CP} 12.70, C), 136.15 (s, CH), 134.51 (t, J_{CP}) 6.79, CH), 132.52 (s, CH), 132.33 (t, J_{CP}) 5.40, C), 131.15 (t, J_{CP}) 11.82, CH), 129.33 (t, J_{CP}) 5.47, CH), 122.23 (t, J_{CP}) 23.19, C), 119.03 (br s, CH), 117.65 (t, J_{CP}) 6.85, CH). Anal. Calcd for C₃₆H₂₈ClNPdP₂: C, 63.73; H, 4.16; N, 2.06. Found: C, 63.14; H, 4.36; N, 2.10.

Synthesis of [PNP]Pd(OAc) (3b). Solid Pd(OAc)₂ (50 mg, 0.223 mmol) was dissolved in THF (4 mL) and cooled to −35° C. To this was added dropwise a cold THF solution (4 mL) of [PNP]Li(THF)₂ (153 mg, 0.223 mmol) at −35° C. The reaction mixture was stirred at room temperature for 1 h and evaporated to dryness under reduced pressure. The residue was triturated with pentane (9 mL), extracted with CH₂Cl₂ (10 mL), and filtered through a pad of Celite. Solvent was removed in vacuo. The residue was washed with pentane (15 mL) and dried in vacuo to yield the product as a brick red solid; yield 114 mg (73%). ¹H NMR (C₆D₆, 500 MHz): δ 7.97 (m, 8, Ar), 7.66 (d, 2, Ar), 6.99-7.08 (m, 14, Ar), 6.83 (t, 2, Ar), 6.38 (t, 2, Ar), 1.93 (s, 3, CH₃). ³¹P{¹H}NMR (C₆D₆, 202.31 MHz): δ29.12. ³¹P{¹H}NMR (THF, 80.95 MHz): δ 28.63. ¹³C{¹H}NMR (C₆D₆, 125.70 MHz): δ 175.43 (s, CdO), 162.89 (t, J_{CP}) 12.26, C), 135.26 (s, CH), 134.58 (t, J_{CP}) 7.29, CH), 132.38 (s, CH), 131.60 (t, J_{CP}) 24.51, C), 131.09 (s, CH), 129.26 (t, J_{CP}) 5.41, CH), 123.66 (t, J_{CP}) 23.13, C), 118.80 (br s, CH), 117.74 (t, J_{CP}) 5.91, CH), 23.24 (s, CH₃). Anal. Calcd for C₃₈H₃₁NO₂PdP₂: C, 65.01; H, 4.45; N, 2.00. Found: C, 63.77; H, 4.77; N, 1.95.

### EXAMPLE 6

### Synthesis of H[PNN]

General Procedures. Unless otherwise specified, all experiments were performed under nitrogen using standard Schlenk or glovebox techniques. All solvents were reagent grade or better and purified by standard methods. The trialkylaluminium complexes were obtained in solutions from Tokyo Chemical Industry (TCI) company. All other chemicals were obtained from commercial vendors (Aldrich, Strem) and used as received. The NMR spectra were recorded on Varian instruments. Chemical shifts (δ) are listed as parts per million downfield fromtetramethylsilane, and coupling constants (J) and peak widths at half-height (Δν_{1/2}) are in hertz. ¹H NMR spectra are referenced using the residual solvent peak at δ 7.16 for C₆D₆ and δ 7.27 for CDCl₃. ¹³C NMR spectra are referenced using the residual solvent peak at δ 128.39 for C₆D₆ and δ 77.23 for CDCl₃. The assignment of the carbon atoms for all new compounds is based on DEPT ¹³C NMR spectroscopy. ¹⁹F, ³¹P, and ²⁷ Al NMR spectra are referenced externally using CFCl₃ in CHCl₃ at δ 0, 85% H₃PO₄ at δ 0, and AlCl₃ in D₂O at δ 0, respectively. Routine coupling constants are not listed. All NMR spectra were recorded at room temperature in specified solvents. Elemental analysis was performed on a Heraeus CHN—O Rapid analyzer.

X-Ray crystallography. Data were collected on a Bruker-Nonius Kappa CCD diffractometer with graphite monochromated Mo-Karadiation (λ=0.7107 Å). Structures were solved by direct methods and refined by full matrix least squares procedures against F² using maXus or WinGX crystallographic software package. All full-weight non-hydrogen atoms were refined anisotropically. Hydrogen atoms were placed in calculated positions.

CCDC reference numbers 264438-264441.

See http://www.rsc.org/suppdata/dt/b5/b502873f/for crystallographic data in CIF or other electronic format.

Synthesis of N-(dimethylaminoethyl)-2-fluoroaniline. A Schlenk flask was sequentially charged with tris(dibenzylideneacetone) dipalladium (Pd₂(dba)₃, 26 mg, 0.028 mmol 0.49% equiv), racemic-2,2′-bis(diphenylphosphino)-1,1′-binaphthyl (rac-BINAP, 27 mg, 0.043 mmol, 0.75% equiv), sodium tert-butoxide (0.770 g, 8.00 mmol, 1.4 equiv), N,N-dimethylethylenediamine (0.503 g, 5.71 mmol), 1-bromo-2-fluorobenzene (1.000 g, 5.71 mmol), and toluene (25 mL) under nitrogen. The reaction mixture was heated to reflux with stirring for 2 d. Toluene was removed in vacuo and the reaction was quenched with deionized water (25 mL). The product was extracted with CH₂Cl₂ (25 mL) and the organic portion was separated from the aqueous layer, which was further extracted with CH₂Cl₂ (10 mL×3). The combined organic solution was dried over MgSO₄ and filtered. All volatiles were removed in vacuo to yield a viscous, tan oil that was directly used for the subsequent nucleophilic phosphanylation without further purification, yield 0.948 g (91.1%). ¹HNMR (CDCl₃, 500 MHz) δ 7.03 (t, 1, Ar), 6.99 (d, 1, Ar), 6.72 (t, 1, Ar), 6.65 (dq, 1, Ar), 4.57 (br s, 1, NH), 3.19 (t, 2, NCH₂CH₂), 2.59 (t, 2, NCH₂CH₂), 2.29 (s, 6, NMe₂). ¹⁹F NMR (CDCl₃, 470.5 MHz) δ −137.64. ¹³C{¹H} NMR (CDCl₃, 125.5 MHz) δ 151.4 (d, CF, ¹J_{CF}=238.3 Hz), 136.8 (d, FCCN, ²J_{CF}=11.8 Hz), 124.3 (d, CH, J_{CF}=3.1 Hz), 116.1 (d, CH, J_{CF}=6.8 Hz), 114.0 (d, CH, J_{CF}=18.2 Hz), 111.8 (d, CH, J_{CF}=3.6 Hz), 57.6 (s, NCH₂), 44.9 (s, NMe₂), 40.6 (s, NCH₂).

Synthesis of N-(dimethylaminoethyl)-2-diphenylphosphinoaniline, H[PNN]. A 250-mL Schlenk flask equipped with a condenser was flushed with nitrogen thoroughly. To this flask was added KPPh₂ (89 mL, 0.5 Min THF solution, Aldrich, 44.5 mmol). THF was removed in vacuo and a solution of N-(dimethylaminoethyl)-2-fluoroaniline (8.119 g, 44.5 mmol) in 1,4-dioxane (60 mL) was added with a syringe. The transparent, ruby reaction solution was heated to reflux for 7 d, during which time the reaction condition was monitored by ³¹P{¹H} NMR spectroscopy. All volatiles were removed from the resulting orange solution under reduced pressure and degassed deionized water (30 mL) was added. The product was extracted with deoxygenated dichloromethane (30 mL). The dichloromethane solution was separated from the aqueous layer, from which the product was further extracted with dichloromethane (15 mL×2). The combined organic solution was dried over MgSO₄ and filtered. All volatiles were removed in vacuo to yield a reddish brown oil. Diethyl ether (20 mL) was added resulting in a pale yellow solution containing a black precipitate. The diethyl ether solution was passed through a pad of Celite to remove the insoluble solid, which was further washed with diethyl ether (20 mL×2) until the washings were colorless. Pentane (10 mL) was added to the combined diethyl ether solutions (total volume 60 mL) and the solution was cooled to −35° C. for 1d to afford the product as colorless crystals, which were isolated and dried in vacuo; yield 1.237 g (79.8%). ¹HNMR (C₆D₆, 500 MHz) δ 7.47 (m, 4, Ar), 7.27 (td, 1, Ar), 7.14 (td, 1, Ar), 7.06 (m, 6, Ar), 6.68 (t, 1, Ar), 6.62 (dd, 1, Ar), 5.58 (d, 1, J_{HP}=6 Hz, NH), 2.86 (td, 2, NCH₂), 2.14 (t, 2, NCH₂), 1.86 (s, 6, NMe₂). ³¹P{¹H} NMR (C₆D₆, 202.3 MHz) d −19.3. ³¹P{¹H}NMR (THF, 80.953 MHz) d −19.0. ³¹P{¹H} NMR (pentane, 80.953 MHz) d −17.4. ³¹P{¹H} NMR (Et₂O, 80.953 MHz) d −18.3. 13C{1H} NMR (C₆D₆, 125.5 MHz) δ 152.1 (d, J_{CP}=17.2 Hz, C), 137.0 (d, J_{CP}=9.9 Hz, C), 135.3 (d, J_{CP}=3.6 Hz, CH), 134.7 (s, CH), 134.5 (s, CH), 131.4 (s, CH), 129.1 (d, J_{CP}=3.5 Hz, CH), 120.1 (d, J_{CP}=9.2 Hz, C), 117.7 (d, J_{CP}=1.8 Hz, CH), 110.9 (d, J_{CP}=2.6 Hz, CH), 57.9 (s, NCH₂), 45.1 (s, NMe₂), 41.7 (s, NCH₂). Anal. Calcd. for C₂₂H₂₅N₂P: C, 75.82; H, 7.24; N, 8.04. Found: C, 75.47; H, 7.24; N, 7.93%.

### EXAMPLE 7

Synthesis of Ligand Represented by Formula Ie

General Procedures. Unless otherwise specified, all experiments were performed under nitrogen using standard Schlenk or glovebox techniques. All solvents were reagent grade or better and purified by standard methods. The NMR spectra were recorded on Varian Unity or Bruker AV instruments. Chemical shifts (δ) are listed as parts per million downfield from tetramethylsilane, and coupling constants (J) are in hertz. ¹H NMR spectra are referenced using the residual solvent peak at δ 7.16 for C₆D₆ and δ 7.27 for CDCl₃. ¹³C NMR spectra are referenced using the residual solvent peak at δ 128.39 for C₆D₆, and δ 77.23 for CDCl₃. The assignment of the carbon atoms is based on the DEPT ¹³C NMR spectroscopy. ³¹P NMR spectra are referenced externally using 85% H₃PO₄ at a 0. Routine coupling constants are not listed. All NMR spectra were recorded at room temperature in specified solvents unless otherwise noted. Elemental analysis was performed on a Heraeus CHN—O Rapid analyzer.

Materials. Compound prop-2-ynyltriphenylphosphonium bromide (Schweizer et al. Org. Chem. 1977, 42, 200-205; Schweizer and Goff, J. Org. Chem. 1978, 43, 2972-2976) was prepared according to the literature procedures. All other chemicals were obtained from commercial vendors and used as received.

X-ray Crystallography. Data were collected on a Bruker-Nonius Kappa CCD diffractometer or a SMART CCD diffractometer with graphite-monochromated Mo Kα radiation (λ) 0.7107 Å). Structures were solved by direct methods and refined by full-matrix least-squares procedures against F² using WinGX crystallographic software package or SHELXL-97. All full-weight non-hydrogen atoms were refined anisotropically. Hydrogen atoms were placed in calculated positions.

Synthesis of 2-(2,6-Diisopropylanilino)-prop-1-enyltriphenylphosphonium Bromide (1a). A solution of 2,6-dimethylaniline (505 mg, 2.62 mmol) in acetonitrile (10 mL) was added via a syringe to a Schlenk flask containing solid prop-2-ynyltriphenylphosphonium bromide (1.0 g, 2.62 mmol) under nitrogen. The reaction solution was stirred and heated to reflux overnight. After being cooled to room temperature, the solution was evaporated to dryness under reduced pressure. The solid thus obtained was dissolved in a minimal amount of CH₂Cl₂ (15 mL), and ethyl acetate (10 mL) was added. The solution was stirred at room temperature for 30 min, resulting in the formation of white precipitate, which was collected on a frit by filtration and dried in vacuo; yield 1.26 g (86%). Colorless crystals suitable for X-ray diffraction analysis were grown from a concentrated CH₂Cl₂ solution at room temperature; yield 1.16 g (79%). ¹H NMR (CDCl₃, 500 MHz) δ 10.16 (br d, 1, J_{HP}) 4 Hz, NH), 7.69 (t, 3, Ar), 7.57 (m, 6, Ar), 7.45 (m, 6, Ar), 7.25 (t, 1, Ar), 7.15 (d, 2, Ar), 3.41 (d, 1, ²J_{HP}=16 Hz, MeC═CH), 3.24 (septet, 2, CHMe₂), 2.16 (s, 3, MeC═CH), 1.25 (d, 6, J_{HH}=7 Hz, CHMe₂), 1.16 (d, 6, J_{HH}=7 Hz, CHMe₂). ³¹P-{¹H} NMR (CDCl₃, 202.31 MHz) δ 17.10. ¹³C{¹H} NMR (CDCl₃, 125.5 MHz) δ 167.63 (d, ²J_{CP}=15.44 Hz, MeC═CH), 146.40 (s, ortho-NAr), 133.90 (d, ⁴J_{CP}=2.76 Hz, para-PC₆H₅), 132.62 (d, 3J_{CP}) 9.92 Hz, meta-PC₆H₅), 129.95 (d, ²J_{CP}) 12.68 Hz, ortho-PC₆H₅), 128.63 (s, para-NAr), 123.94 (s, meta-NAr), 123.34 (d, ¹J_{CP}) 91.62, ipso-PC₆H₅), 56.62 (d, J_{CP}=121.36 Hz, MeC═CH), 28.56 (s, CHMe₂), 24.73 (s, CHMe₂), 23.81 (s, CHMe₂), 21.66 (d, ³J_{CP}) 5.40 Hz, MeCdCH). Anal. Calcd for C₃₃H₃₇BrNP: C, 70.96; H, 6.68; N, 2.51. Found: C, 70.63; H, 6.68; N, 2.57.

Synthesis of 2-(2,6-Dimethylanilino)-prop-1-enyltriphenylphosphonium Bromide (1b). A solution of 2,6-dimethylaniline (318 mg, 2.62 mmol) in acetonitrile (10 mL) was added via a syringe to a Schlenk flask containing solid prop-2-ynyltriphenylphosphonium bromide (1.0 g, 2.62 mmol) under nitrogen. The reaction solution was stirred and heated to reflux overnight. After being cooled to room temperature, the solution was evaporated to dryness under reduced pressure. The solid thus obtained was dissolved in a minimal amount of CH₂Cl₂ (10 mL), and ethyl acetate (15 mL) was added. The solution was stirred at room temperature for 30 min, resulting in the formation of white precipitate, which was collected on a frit by filtration and dried in vacuo; yield 1.087 g (83%). Colorless crystals suitable for X-ray diffraction analysis were grown by slow evaporation of a concentrated CH₂Cl₂ solution at room temperature; yield 1.054 g (80%). ¹H NMR (CDCl₃, 500 MHz) δ 10.26 (br d, 1, J_{HP}=4.0 Hz, NH), 7.70 (t, 3, Ar), 7.59 (m, 6, Ar), 7.50 (m, 6, Ar), 7.08 (m, 3, Ar), 3.47 (d, 1, ²J_{PH}=16.5 Hz, MeC═CH), 2.39 (s, 6, ArCH₃), 2.20 (s, 3, MeC═CH). ³¹P-{¹H} NMR (CDCl₃, 202.31 MHz) δ 17.23. ¹³C{¹H} NMR (CDCl₃, 125.5 MHz) δ 166.27 (d, ²J_{CP}=15.44 Hz, MeC═CH), 135.96 (s, ortho-NAr), 135.23 (s, ipso-NAr), 133.89 (s, para-PC₆H₅), 132.76 (d, ³J_{CP}) 9.92, meta-PC₆H₅), 129.99 (d, ²J_{CP}=12.68, ortho-PC₆H₅), 128.51 (s, meta-NAr), 127.80 (s, para-NAr), 123.61 (d, ¹J_{CP}=91.62, ipso-PC₆H₅), 55.24 (d, ¹J_{CP}=122.36 Hz, MeC═CH), 21.86 (d, ³J_{CP}=4.52 Hz, MeC═CH), 18.61 (s, ArMe). Anal. Calcd for C₂₉H₂₉BrNP: C, 69.33; H, 5.82; N, 2.79. Found: C, 69.02; H, 5.84; N, 2.74.

Synthesis of 2-Anilinoprop-1-enyltriphenylphosphonium Bromide (1c). A solution of aniline (244 mg, 2.62 mmol) in acetonitrile (10 mL) was added via a syringe to a Schlenk flask containing solid prop-2-ynyltriphenylphosphonium bromide (1.0 g, 2.62 mmol) under nitrogen. The reaction solution was stirred and heated to reflux overnight. After being cooled to room temperature, the solution was evaporated to dryness under reduced pressure. The solid thus obtained was dissolved in a minimal amount of CH2Cl2 (8 mL), and ethyl acetate (15 mL) was added. The solution was stirred at room temperature for 30 min, resulting in the formation of white precipitate, which was collected on a frit by filtration and dried in vacuo; yield 560 mg (90%). ¹H NMR (CDCl₃, 200 MHz) δ 10.36 (br s, 1, NH), 7.02-7.36 (m, 15, Ar), 6.77-6.98 (m, 5, Ar), 4.38 (d, 1, CH), 1.23 (s, 3, CH₃). ³¹P{¹H} NMR (CDCl₃, 80.95 MHz) δ 17.32. The NMR spectroscopic data are identical to those reported previously (Schweizer et al. Org. Chem. 1977, 42, 200-205).

Synthesis of 2-(tert-Butylamino)-prop-1-enyltriphenylphosphonium Bromide (1d). A solution of tert-butylamine (0.28 mL, 2.62 mmol) in acetonitrile (10 mL) was added via a syringe to a Schlenk flask containing solid prop-2-ynyltriphenylphosphonium bromide (1.0 g, 2.62 mmol) under nitrogen. The reaction solution was stirred and heated to reflux overnight. After being cooled to room temperature, the solution was evaporated to dryness under reduced pressure. The solid thus obtained was dissolved in a minimal amount of CH₂Cl₂ (10 mL), and ethyl acetate (15 mL) was added. The solution was stirred at room temperature for 30 min, resulting in the formation of orange precipitate, which was collected on a frit by filtration and dried in vacuo; yield 1.02 g (86%). Orange crystals suitable for X-ray diffraction analysis were grown from a concentrated CH₂Cl₂/Et₂O solution at room temperature; yield 0.95 g (80%). ¹H NMR (CDCl₃, 500 MHz) δ 7.94 (br d, 1, J_{HP}=4.0 Hz, NH), 7.67 (t, 3, Ar), 7.57 (m, 9, Ar), 7.53 (t, 3, Ar), 3.85 (d, 1, ²J_{HP}=15.5 Hz, MeC═CH), 1.92 (s, 3, MeC═CH), 1.47 (s, 9, CMe₃). ³¹P{¹H} NMR (CDCl₃, 202.31 MHz) δ 16.27. ¹³C{¹H} NMR (CDCl₃, 125.5 MHz) δ 164.15 (d, ²J_{CP}=12.55 Hz, MeC═CH), 133.72 (d, ⁴J_{CP}=2.64 Hz, para-PC₆H₅), 132.65 (d, ²J_{CP}=10.67 Hz, meta-PC₆H₅), 129.89 (d, ³J_{CP}=12.43 Hz, ortho-PC6H5), 123.66 (d, ¹J_{CP}=91.11 Hz, ipso-PC₆H₅), 56.23 (d, ¹J_{CP}=121.48 Hz, MeC═CH), 52.98 (s, CMe₃), 28.51 (s, CMe₃), 24.21 (d, 3J_{CP}=6.15 Hz, MeC═CH). Anal. Calcd for (C₂₅H₂₉— BrNP)₄(H₂O): C, 65.41; H, 6.48; N, 3.05. Found: C, 65.33; H, 6.43; N, 2.95. Incorporation of water is confirmed by X-ray crystallography. Complete removal of the water molecules from recrystallized samples was not successful.

Deprotonation of 2-(2,6-Diisopropylanilino)-prop-1-enyltriphenylphosphonium Bromide (1a): Synthesis of 2a. Solid NaH (50 mg, 2.08 mmol, 3.9 equiv) was added to a solution of 2-(2,6-diisopropylanilino)-prop-1-enyltriphenylphosphonium bromide (300.4 mg, 0.538 mmol) dissolved in THF (15 mL) at −35° C. After being stirred at room temperature overnight, the reaction mixture was filtered through a pad of Celite to remove the excess amount of NaH, which was further washed with THF (5 mL) until the washings became colorless. The filtrate and washings were combined, and THF was removed in vacuo. The pale yellow solid residue was extracted with benzene (10 mL). The benzene solution was filtered through a pad of Celite and evaporated to dryness under reduced pressure, affording the product as a pale yellow solid; yield 215 mg (84%). Yellow crystals suitable for X-ray diffraction analysis were grown from a concentrated THF/benzene solution at room temperature. ¹H NMR (C₆D₆, 500 MHz) δ 7.76 (dd, 6, Ar), 7.17 (d, 2, Ar), 6.98-7.09 (m, 10, Ar), 3.05 (d, 1, ²J_{HP}=25.5 Hz, HC═PPh₃), 2.92 (septet, 2, ³J_{HH}=7 Hz, CHMe₂), 1.92 (d, 3, ⁴J_{PH}=2.0 Hz, MeC═NAr), 1.20 (d, 6, ³J_{HH}=7 Hz, CHMe₂), 0.98 (d, 6, ³J_{HH}=7 Hz, CHMe₂). ³¹P{¹H} NMR (C₆D₆, 202.31 MHz) δ 13.50. ¹³C{¹H} NMR (C₆D₆, 125.5 MHz) δ 166.39 (d, 2J_{CP}=3.64 Hz, MeC═NAr), 150.89 (s, C), 140.37 (s, C), 133.95 (d, J_{CP}=10.04 Hz, CH), 131.75 (d, J_{CP}=2.76 Hz, CH), 130.58 (d, ¹J_{CP}=88.98 Hz, ipso-PC₆H₅), 128.92 (d, J_{CH}=11.80 Hz, CH), 123.28 (s, CH), 121.99 (s, CH), 40.54 (d, ¹J_{CP}=115.34 Hz, HC═PPh₃), 28.23 (s, CHMe₂), 24.87 (s, CHMe₂), 24.47 (s, CHMe₂), 22.13 (d, ³J_{CP}=16.32 Hz, MeC═NAr). Anal. Calcd for C₃₃H₃₆NP: C, 82.99; H, 7.60; N, 2.93. Found: C, 83.00; H, 7.57; N, 2.89.

Deprotonation of 2-(2,6-Dimethylanilino)-prop-1-enyltriphenylphosphonium Bromide (1b): Synthesis of 2b. Solid NaH (108 mg, 4.51 mmol, 7.4 equiv) was added to a solution of 2-(2,6-dimethylanilino)-prop-1-enyltriphenylphosphonium bromide (307.6 mg, 0.61 mmol) dissolved in THF (15 mL) at −35° C. After being stirred at room temperature for 4 h, the reaction mixture was filtered through a pad of Celite to remove the excess amount of NaH, which was further washed with THF (4 mL) until the washings became colorless. The filtrate and washings were combined, and THF was removed in vacuo. The pale yellow solid residue was extracted with benzene (10 mL). The benzene solution was filtered through a pad of Celite and evaporated to dryness under reduced pressure, affording the product as a pale yellow solid; yield 235 mg (91%). Yellow crystals suitable for X-ray diffraction analysis were grown from a concentrated THF/benzene solution at room temperature. ¹H NMR (C₆D₆, 500 MHz) δ 7.81 (dd, 6, Ar), 7.10 (d, 2, Ar), 7.06 (d, 2, Ar), 7.00 (m, 7, Ar), 6.89 (t, 1, Ar), 3.11 (d, 1, ²J_{HP}=26.5 Hz, HC═PPh₃), 1.96 (s, 6, ArCH₃), 1.88 (d, 3, ⁴J_{HP}=1.5 Hz, MeC═NAr). ³¹P{¹H} NMR (C₆D₆, 202.31 MHz) δ 13.75. ¹³C{¹H} NMR (C₆D₆, 125.5 MHz) δ 165.36 (d, ²J_{CP}=4.02 Hz, MeC═NAr), 153.85 (s, C), 134.08 (d, J_{CP}=10.04 Hz, CH), 131.67 (d, J_{CP}=2.76 Hz, CH), 130.10 (d, ¹J_{CP}=89.98 Hz, ipso-PC₆H₅), 129.84 (s, C), 128.78 (d, J_{CP}=11.80 Hz, CH), 128.30 (s, CH), 120.95 (s, CH), 39.64 (d, ¹J_{CP}=116.21 Hz, HC═PPh₃), 21.70 (d, ³J_{CP}=16.82 Hz, MeC═NAr), 19.52 (s, ArMe). Anal. Calcd for C₂₉H₂₈NP: C, 82.63; H, 6.70; N, 3.32. Found: C, 82.39; H, 6.73; N, 3.26.

Deprotonation of 2-Anilinoprop-1-enyltriphenylphosphonium Bromide (1c): Synthesis of 2c. Solid NaH (12 mg, 0.5 mmol, 1.58 equiv) was added to a solution of 2-anilinoprop-1-enyltriphenylphosphonium bromide (150 mg, 0.316 mmol) dissolved in THF (10 mL) at −35° C. After being stirred at room temperature for 4 h, the reaction mixture was filtered through a pad of Celite to remove the excess amount of NaH, which was further washed with THF (2 mL) until the washings became colorless. The filtrate and washings were combined, and THF was removed in vacuo. The pale yellow solid residue was extracted with benzene (10 mL). The benzene solution was filtered through a pad of Celite and evaporated to dryness under reduced pressure, affording the product as a pale yellow solid; yield 66 mg (53%). Yellow crystals suitable for X-ray diffraction analysis were grown from a concentrated THF/benzene solution at room temperature. ¹H NMR (C₆D₆, 500 MHz) δ 7.79 (dd, 6, Ar), 7.20 (t, 2, Ar), 7.02 (m, 9, Ar), 6.87 (t, 1, Ar), 6.75 (d, 2, Ar), 3.12 (d, 1, ²JHp=28.5 Hz, HC═PPh₃), 2.13 (d, 3, ⁴J_{HP}=2.5 Hz, MeC═NAr). ³¹P{¹H} NMR (C₆D₆, 202.31 MHz) δ 14.01. ¹³C{¹H} NMR (C₆D₆, 125.5 MHz) δ 166.00 (s, MeC═NPh), 155.33 (s, C), 133.89 (d, J_{CP}=9.41 Hz, CH), 131.58 (s, CH), 130.09 (d, J_{CP}=90.74 Hz, ipso-PC₆H₅), 129.01 (s, CH), 128.84 (s, CH), 123.23 (s, CH), 120.56 (s, CH), 43.06 (d, ¹J_{CP}=115.34 Hz, HC═PPh₃), 20.49 (d, ³J_{CP}=16.06 Hz, MeC═NPh). LRMS (EI) calcd for C₂₇H₂₄NP m/z 393, found m/z 393. Anal. Calcd for (C₂₇H₂₄—NP)₃(C₄H₈O): C, 81.50; H, 6.44; N, 3.36. Found: C, 81.36; H, 6.11; N, 3.02.

Deprotonation of 2-(tert-Butylamino)-prop-1-enyltriphenylphosphonium Bromide (1d): Synthesis of 2d. Solid NaH (43 mg, 1.69 mmol, 4.0 equiv) was added to a solution of 2-(tertbutylamino)-prop-1-enyltriphenylphosphonium bromide (191.8 mg, 0.422 mmol) dissolved in THF (10 mL) at −35° C. After being stirred at room temperature for 4 h, the reaction mixture was filtered through a pad of Celite to remove the excess amount of NaH, which was further washed with THF (2 mL) until the washings became colorless. The filtrate and washings were combined, and THF was removed in vacuo. The orange, oily residue was extracted with benzene (10 mL). The benzene solution was filtered through a pad of Celite and evaporated to dryness under reduced pressure, affording the product as reddish orange viscous oil; yield 142 mg (90%). ¹H NMR (C₆D₆, 500 MHz) δ 7.80 (dd, 6, Ar), 7.03-7.09 (m, 9, Ar), 2.79 (d, 1, ²J_{HP}=31.5 Hz, HC═PPh₃), 2.14 (d, 3, ⁴J_{HP}=3.0 Hz, MeC═NCMe₃), 1.14 (s, 9, CMe₃). ³¹P{¹H} NMR (C₆D₆, 202.31 MHz) δ 11.64. ¹³C{¹H} NMR (C₆D₆, 125.5 MHz) δ 164.25 (d, ²J_{CP}) 2.76 Hz, MeC═NCMe₃), 133.82 (d, J_{CP}=9.54 Hz, CH), 132.03 (d, ¹J_{CP}=90.36 Hz, ipso-PC₆H₅), 131.00 (d, J_{CP}=2.76 Hz, CH), 128.48 (d, J_{CP}=11.80 Hz, CH), 54.00 (s, CMe₃), 41.18 (d, ¹J_{CP}=120.36 Hz, HC═PPh₃), 32.34 (s, CMe₃), 21.79 (d, ³J_{CP}=16.32 Hz, MeC═NCMe₃). HRMS (EI) calcd for C₂₅H₂₈—NP m/z 373.1959, found m/z 373.1956.

Synthesis of the ligand represented by formula If (3d). Attempts to crystallize the oily 2d from a concentrated diethyl ether/benzene solution at room temperature led to colorless cubes of 3d suitable for X-ray diffraction analysis. Alternatively, hydrolysis of 2d in THF at room temperature also afforded 3d on the basis of NMR studies. ¹H NMR (C₆D₆, 500 MHz) δ 8.06 (m, 4, Ar), 7.09 (m, 6, Ar), 5.37 (br s, 1, NH), 4.66 (d, 1, ²J_{HP}=19, MeC═CH), 2.18 (s, 3, MeC═CH), 1.17 (s, 9, CMe₃). ³¹P{¹H} NMR (C₆D₆, 202.31 MHz) δ 21.39. ¹³C{¹H} NMR (C₆D₆, 125.5 MHz) δ 158.10 (d, ²J_{CP}=19.8 Hz, MeC═CH), 140.06 (d, ¹J_{CP}=104.4 Hz, ipso-PC₆H₅), 131.73 (d, J_{CP}=9.0 Hz, CH), 130.85 (d, J_{CP}=29.1 Hz, CH), 128.88 (d, J_{CP}=10.8 Hz, CH), 81.18 (d, ¹J_{CP}=128.5 Hz, MeC═CH), 51.32 (s, CMe₃), 29.00 (s, CMe₃), 22.41 (d, J_{CP}=7.3 Hz, MeC═CH).

### EXAMPLE 8

Synthesis of H[ⁱPr—PNP] and H[Cy-PNP]

General Procedures. Unless otherwise specified, all experiments were performed under nitrogen using standard Schlenk or glovebox techniques. All solvents were reagent grade or better and purified by standard methods. The NMR spectra were recorded on Varian instruments. Chemical shifts (δ) are listed as parts per million downfield from tetramethylsilane and coupling constants (J) in hertz. ¹H NMR spectra are referenced using the residual solvent peak at δ 7.16 for C₆D₆ and δ 2.09 for toluene-d8 (the most upfield resonance). ¹³C NMR spectra are referenced using the residual solvent peak at δ 128.39 for C₆D₆. The assignment of the carbon atoms for all new compounds is based on the DEPT ¹³C NMR spectroscopy. ³¹P and ⁷Li NMR spectra are referenced externally using 85% H₃PO₄ at δ 0, and LiCl in D₂O at δ 0, respectively. Routine coupling constants are not listed. All NMR spectra were recorded at room temperature in specified solvents unless otherwise noted. Elemental analysis was performed on a Heraeus CHN—O Rapid analyzer.

Materials. All chemicals were obtained from commercial vendors and used as received.

X-ray Crystallography. Data were collected on a Bruker-Nonius Kappa CCD or a Bruker AXS SMART APEX CCD diffractometer with graphite-monochromated Mo Kα radiation (λ) 0.7107 Å). Structures were solved by direct methods and refined by full matrix least squares procedures against F2 using the maXus or WinGX crystallographic software package. All full-weight non-hydrogen atoms were refined anisotropically. Hydrogen atoms were placed in calculated positions.

Synthesis of Di(2-fluorophenyl)amine. A Schlenk flask was charged with 2-fluoroaniline (5.55 g, 50 mmol), 1-bromo-2-fluorobenzene (8.75 g, 50 mmol), Pd(OAc)₂ (0.020 g, 0.089 mmol, 0.5% equiv), DPEPhos (0.216 g, 0.401 mmol, 0.75% equiv), NaO^{t}Bu (7.185 g, 74.84 mmol, 1.4 equiv), and toluene (45 mL) under nitrogen. The reaction mixture was heated to reflux with stirring. The reaction was monitored by GC, which showed complete formation of the desired product in 1 day. After being cooled to room temperature, the reaction was quenched with deionized water (45 mL). The organic portion was separated from the aqueous layer, which was further extracted with toluene (10 mL×2). The combined organic solution was dried over MgSO₄ and filtered. All volatiles were removed in vacuo to yield a red oil, which was directly used for the subsequent reaction; yield 9.38 g (91.4%). ¹H NMR (CDCl₃, 500 MHz): δ 7.42 (m, 2, Ar), 7.25 (m, 2, Ar), 7.20 (m, 2, Ar), 7.04 (m, 2, Ar), 6.03 (br s, 1, NH). ¹⁹F NMR (CDCl₃, 470.5 MHz): δ −133.07. ¹³C {¹H}NMR (CDCl₃, 125 MHz): δ 153.45 (t, J_{CF}=241, CF), 130.45 (t, J_{CF}=11.75, CN), 124.14 (t, J_{CF}=3.63, CH), 121.38 (t, J_{CF}=7.25, CH), 117.98 (s, CH), 115.45 (t, J_{CF}=19.00, CH). LR-MS (EI): calcd for C₁₂H₉F₂N m/z 205, found m/z 205. Anal. Calcd for C₁₂H₉F₂N: C, 70.24; H, 4.42; N, 6.83. Found: C, 70.13; H, 4.52; N, 6.69.

Synthesis of Di(2-bromophenyl)amine. A Schlenk flask was charged with 2-bromoaniline (5.26 g, 30.58 mmol), 1-bromo-2-iodobenzene (8.65 g, 30.58 mmol), Pd(OAc)₂ (0.034 g, 0.15 mmol, 0.5% equiv), DPEPhos (0.123 g, 0.23 mmol, 0.75% equiv), NaO^{t}Bu (4.11 g, 42.81 mmol, 1.4 equiv), and toluene (20 mL) under nitrogen. In the absence of light, the reaction mixture was heated to reflux with stirring. The reaction was monitored by GC-MS, which showed quantitative formation of the desired product in 15 h. After being cooled to room temperature, the reaction mixture was evaporated to dryness under reduced pressure. The solid residue was dissolved in deionized water (30 mL) and CH₂Cl₂ (60 mL). The organic portion was separated from the aqueous layer, which was further extracted with dichloromethane (40 mL×2). The combined organic solution was dried over MgSO₄ and filtered. The solvent was removed in vacuo to yield a dark brown oil, which was subjected to flash column chromatography on neutral Al₂O₃ using Et₂O as the eluant. The first band (pale yellow) was collected and solvent was removed in vacuo, affording the product as pale yellow oil; yield 9.21 g (92%). ¹H NMR (CDCl₃, 500 MHz): δ 7.59 (dd, 2, Ar), 7.30 (dd, 2, Ar), 7.22 (td, 2, Ar), 6.85 (td, 2, Ar), 6.48 (br s, 1, NH). ¹³C{¹H}NMR (CDCl₃, 125.70 MHz): δ 139.87 (s, C), 133.13 (s, CH), 128.00 (s, CH), 122.44 (s, CH), 117.82 (s, CH), 114.16 (s, C). HRMS (EI): Calcd for C₁₂H₉Br₂N m/z 324.9102, found m/z 324.9101. Anal. Calcd for C₁₂H₉Br₂N: C, 44.07; H, 2.77; N, 4.28. Found: C, 44.21; H, 2.80; N, 4.27.

Synthesis of Bis(2-diisopropylphosphinophenyl)amine (H[ⁱPr—PNP]). n-BuLi (2.9 mL, 1.6 M in hexane, 4.68 mmol, 3 equiv) was added dropwise to a solution of di(2-bromophenyl)amine (510 mg, 1.56 mmol) in diethyl ether (13 mL) at −35° C. The reaction solution was naturally warmed to room temperature and stirred for 1 h, providing a pale yellow solution along with a significant amount of off-white precipitate. The reaction mixture was cooled to −35° C. again, and chlorodiisopropylphosphine (0.5 mL, 3.12 mmol, 2 equiv) was added dropwise. The reaction mixture was stirred at room temperature for 16 h. Degassed deionized water (10 mL) and diethyl ether (10 mL) were added. The diethyl ether portion was separated from the aqueous solution, which was further extracted with diethyl ether (5 mL×2). The diethyl ether solutions were combined, dried over MgSO₄, and evaporated to dryness under reduced pressure to afford a yellow oil. The yellow oil was dissolved in degassed ethanol (1 mL) and cooled to −40° C. to give the product as an off-white crystalline solid; yield 344 mg (55%). ¹H NMR (C₆D₆, 500 MHz): δ 8.48 (t, 1, J_{HP}=8.3, NH), 7.41 (d, 2, Ar), 7.26 (d, 2, Ar), 7.06 (t, 2, Ar), 6.82 (t, 2, Ar), 1.97 (m, 4, CHMe₂), 1.09 (dd, 12, CHMe₂), 0.93 (dd, 12, CHMe₂). ³¹P{¹H} NMR (Et₂O, 80.95 MHz): δ −11.86. ³¹P{¹H} NMR (THF, 80.95 MHz): δ−12.07. ³¹P{¹H} NMR (toluene, 80.95 MHz): δ −13.07. ³¹P{¹H} NMR (C₆D₆, 202.31 MHz): δ −13.31. ¹³C{¹H} NMR (C₆D₆, 125.70 MHz): δ149.55 (d, J_{CP}=20.1, C), 134.14 (s, CH), 130.14 (s, CH), 123.79 (d, J_{CP}=16.6, C), 120.74 (s, CH), 117.36 (s, CH), 23.73 (d, J_{CP}=11.1, CHMe₂), 20.70 (d, J_{CP}=19.4, CHMe₂), 19.44 (d, J_{CP}=9.2, CHMe₂). Anal. Calcd for C₂₄H₃₇NP₂: C, 71.79; H, 9.29; N, 3.49. Found: C, 71.50; H, 9.15; N, 3.56.

Synthesis of Bis(2-dicyclohexylphosphinophenyl)amine (H[Cy-PNP]). n-BuLi (5.8 mL, 1.6 M in hexane, 9.3 mmol, 3 equiv) was added dropwise to a solution of di(2-bromophenyl)amine (1.0 g, 3.1 mmol) in diethyl ether (30 mL) at −35° C. The reaction solution was naturally warmed to room temperature and stirred for 1 h, providing a pale yellow solution along with a significant amount of off-white precipitate. The reaction mixture was cooled to −35° C. again, and a diethyl ether solution (3 mL) of chlorodiisopropylphosphine (933 mg, 6.1 mmol, 2 equiv) was added dropwise. The reaction mixture was stirred at room temperature for 16 h and evaporated to dryness under reduced pressure to give an orange viscous oil. Degassed deionized water (30 mL) and dichloromethane (50 mL) were added. The dichloromethane portion was separated from the aqueous solution, which was further extracted with dichloromethane (20 mL×2). The dichloromethane solutions were combined, dried over MgSO₄, and evaporated to dryness under reduced pressure to afford a white cloudy oil. Pentane (5 mL) was added. The solution was vigorously stirred at room temperature to give the product as an off-white solid, which was isolated by decantation of the solution and dried in vacuo; yield 1.32 g (77%). ¹H NMR (C₆D₆, 500 MHz): δ 8.51 (t, 1, J_{HP}=7.3, NH), 7.48 (dd, 2, Ar), 7.40 (d, 2, Ar), 7.09 (td, 2, Ar), 6.85 (td, 2, Ar), 2.00 (m, 8, Cy), 1.70 (t, 8, Cy), 1.60 (d, 4, Cy), 1.53 (d, 4, Cy), 1.36 (qt, 4, Cy), 1.23 (m, 8, Cy), 1.15 (dt, 4, Cy), 1.07 (tt, 4, Cy). ³¹P-{¹H} NMR (THF, 80.95 MHz): δ −19.56. ³¹P{¹H} NMR (toluene, 80.95 MHz): δ −20.86. ³¹P{¹H} NMR (Et₂O, 80.95 MHz): δ −20.62. ³¹P{¹H} NMR (C₆D₆, 202.31 MHz): δ −22.04 (Δν_{1/2}=491 Hz). ¹³C{¹H} NMR (C₆D₆, 125.70 MHz): δ 149.75 (d, J_{CP}=19.2, C), 134.68 (s, CH), 130.13 (s, CH), 123.76 (d, J_{CP}=16.2, C), 120.78 (s, CH), 117.46 (s, CH), 33.96 (d, J_{CP}=11.4, CH), 31.31 (d, J_{CP}=17.4, CH₂), 29.72 (d, J_{CP}=8.2, CH₂), 27.86 (d, J_{CP}=10.4, CH₂), 27.67 (d, J_{CP}=7.4, CH₂), 27.10 (s, CH₂). Anal. Calcd for C₃₆H₅₃NP₂: C, 76.97; H, 9.51; N, 2.49. Found: C, 77.43; H, 9.69; N, 2.06.

### EXAMPLE 9

### Synthesis of H[Ph-PNP-ⁱPr]

General Procedures. Unless otherwise specified, all experiments were performed under nitrogen using standard Schlenk or glovebox techniques. All solvents were reagent grade or better and purified by standard methods. The NMR spectra were recorded on Varian instruments. Chemical shifts (δ) are listed as parts per million downfield from tetramethylsilane. Coupling constants (J) and peak widths at half-height (Δν_{1/2}) are listed in hertz. ¹H and ¹³C NMR spectra are referenced using the residual solvent peaks at δ 7.16 and 128.39, respectively, for C₆D₆. The assignment of the carbon atoms for all new compounds is based on DEPT ¹³C NMR spectroscopy. ³¹P NMR spectra are referenced externally using 85% H₃PO₄ at δ 0. Routine coupling constants are not listed. All NMR spectra were recorded at room temperature in specified solvents unless otherwise noted. Elemental analysis was performed on a Heraeus CHN—O Rapid analyzer.

Materials. All other chemicals were obtained from commercial vendors and used as received.

X-ray Crystallography. Data were collected on a Bruker-Nonius Kappa CCD diffractometer with graphitemonochromated Mo Kα radiation (λ=0.7107 Å). Structures were solved by direct methods and refined by full matrix least-squares procedures against F2 using the maXus or WinGX crystallographic software package. All full-weight non-hydrogen atoms were refined anisotropically. Hydrogen atoms were placed in calculated positions.

Synthesis of H[Ph-PNP-iPr]. n-BuLi (1.94 mL, 1.6 M in hexane solution, 311 mmol, 2 equiv) was added dropwise to a diethyl ether solution (50 mL) of bis(2-bromophenyl)amine (508 mg, 155 mmol) at −35° C. The reaction solution was stirred at room temperature for 3 h and cooled to −35° C. again. To this was added dropwise a cold diethyl ether solution (2 mL) of chlorodiisopropylphosphine (237 mg, 155 mmol) at −35° C. The reaction mixture was stirred at room temperature overnight and cooled to −35° C. before addition of n-BuLi (0.97 mL, 1.6 M in hexane, 155 mmol) dropwise. The solution was stirred at room temperature for 3 h and cooled to −35° C. again, and a cold (−35° C.) diethyl ether solution (2 mL) of chlorodiphenylphosphine (324 mg, 155 mmol) was added dropwise. The reaction solution was subsequently stirred at room temperature overnight, filtered through a pad of Celite, and evaporated to dryness under reduced pressure. The resulting solid residue was dissolved in diethyl ether (15 mL), and deionized water (10 mL) was added at room temperature. The solution was then dried over MgSO₄, filtered, and evaporated to dryness under reduced pressure. The oily residue thus obtained was dissolved in a mixture of diethyl ether (5 mL) and pentane (1 mL). The solution was cooled to −35° C. to afford the product as a pale yellow solid, which was isolated and dried in vacuo. Crystals suitable for X-ray diffraction analysis were grown from a concentrated diethyl ether solution at −35° C.: yield 390 mg (53%). ¹H NMR (C₆D₆, 500 MHz): δ 7.99 (dd, 1, J_{HP}=10.5 and 3.5, NH), 7.56 (m, 5, Ar), 7.39 (dd, 1, Ar), 7.28 (m, 5, Ar), 7.14 (m, 6, Ar), 6.87 (dt, 2, Ar), 1.95 (m, 2, CHMe₂), 1.10 (dd, 6, CHMe₂), 0.95 (dd, 6, CHMe₂). ³¹P {¹H} NMR (C₆D₆, 202.3 MHz): 63-14.79 (br s, PiPr₂), −16.66 (d, J_{PP}=9.10, PPh₂). ¹³C {¹H} NMR (C₆D₆, 125.5 MHz): δ 149.96 (d, J_{CP}=19.20, C), 147.20 (d, J_{CP}=19.20, C), 137.13 (d, J_{CP}=10.4, C), 134.99 (s, CH), 134.85 (d, J_{CP}=20.08, CH), 133.95 (s, CH), 130.29 (d, J_{CP}=16.44, CH), 129.31 (d, J_{CP}=6.40, CH), 129.24 (s, CH), 129.13 (d, J_{CP}=10.92, C), 128.68 (s, CH), 122.77 (s, CH), 122.60 (d, JCp=15.56, C), 120.46 (s, CH), 119.33 (s, CH), 117.04 (d, J_{CP}=2.76, CH), 23.71 (d, J_{CP}=10.92, CHMe₂), 20.63 (d, J_{CP}=19.20, CHMe₂), 19.38 (d, J_{CP}=9.16, CHMe₂). Anal. Calcd for C₃₀H₃₃NP₂: C, 76.74; H, 7.08; N, 2.98. Found: C, 77.03; H, 7.23; N, 3.03.

### EXAMPLE 10

### Synthesis of H[PNO]

Synthesis of N-(2-bromophenyl)-2-methoxyaniline. A Schlenk flask was charged with 2-iodoanisole (1.000 g, 4.272 mmol), 2-bromoaniline (735.0 mg, 4.272 mmol), Pd(OAc)₂ (4.8 mg, 0.021 mmol, 0.5% equiv), bis[2-(diphenylphosphino)phenyl]ether (DPEphos, 17.26 mg, 0.032 mmol, 0.75% equiv), sodium tert-butoxide (574.3 mg, 5.98 mmol, 1.4 equiv), and toluene (15 mL) under nitrogen. The flask was sealed with a rubber septum and heated to 95° C. with stirring for 1 d. Toluene was removed in vacuo and the reaction was quenched with deionized water (25 mL). The product was extracted with CH₂Cl₂ (25 mL) and the organic portion was separated from the aqueous layer, which was further extracted with CH₂Cl₂ (10 mL×2). The combined organic solution was dried over MgSO₄ and filtered. All volatiles were removed in vacuo to yield pale yellow, viscous oil; yield 1.0972 g (92.3%). ¹H NMR (CDCl₃, 500 MHz) δ 7.60 (dd, 1, Ar), 7.42 (dd, 1, Ar), 7.38 (d, 1, Ar), 7.24 (t, 1, Ar), 6.99 (m, 3, Ar), 6.81 (td, 1, Ar), 6.53 (br s, 1, NH), 3.94 (s, 3, OMe). ¹³C{¹H} NMR (CDCl₃, 125.68 MHz) δ 149.43 (s, C), 140.81 (s, C), 132.94 (s, CH), 131.22 (s, C), 127.93 (s, CH), 121.60 (s, CH), 121.04 (s, CH), 120.59 (s, CH), 117.01 (s, CH), 116.36 (s, CH), 113.20 (s, C), 110.81 (s, CH), 55.60 (s, OCH₃).

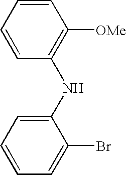

Synthesis of N-(2-diphenylphosphinophenyl)-2-methoxyaniline. To a solution of N-(2-bromophenyl)-2-methoxyaniline (450.6 mg, 1.62 mmol) in diethyl ether (15 mL) at −35° C. was added n-BuLi (2.03 mL, 1.6 M in hexane, Aldrich, 3.24 mmol, 2 equiv) dropwise. The reaction solution was naturally warmed to room temperature and stirred for 1 h. The orange solution was cooled to −35° C. again and chlorodiphenylphosphine (0.3 mL, 1.62 mmol) was added. After being stirred at room temperature overnight, the reaction solution was evaporated to dryness under reduced pressure. Degassed deionized water (10 mL) was added. The product was extracted with deoxygenated dichloromethane (10 mL) from the aqueous solution. The dichloromethane solution was separated from the aqueous layer, from which the product was further extracted with dichloromethane (5 mL×2). The combined organic solution was dried over MgSO₄ and filtered. All volatiles were removed in vacuo to yield the product as yellow viscous oil; yield 417.3 mg (67%). Crystals suitable for X-ray diffraction analysis were grown from a concentrated diethyl ether solution at −35° C. ¹H NMR (C₆D₆, 500 MHz) δ 7.48 (dd, 2, Ar), 7.44 (m, 3, Ar), 7.31 (dd, 1, Ar), 7.10 (m, 2, Ar), 7.02 (m, 6, Ar), 6.95 (d, 1, Ar), 6.75 (m, 3, Ar), 6.46 (dd, 1, Ar), 3.10 (s, 3, OMe). ³¹P{¹H} NMR (C₆D₆, 202.5 MHz) δ −16.80. ³¹P{¹H} NMR (diethyl ether, 80.95 MHz) δ−15.83. ¹³C{¹H} NMR (C₆D₆, 125.68 MHz) δ 149.64 (s, C), 146.92 (d, J_{CP}=18.1, C), 136.8 (d, J_{CP}=10.18, C), 135.06 (d, J_{CP}=2.51, CH), 134.73 (d, J_{CP}=19.58, CH), 133.38 (s, C), 130.55 (s, CH), 129.34 (s, CH), 129.26 (d, J_{CP}=7.03, CH), 127.22 (d, J_{CP}=10.05, C), 122.10 (d, J_{CP}=1.51, CH), 121.39 (s, CH), 121.01 (s, CH), 117.99 (d, J_{CP}=2.01, CH), 116.46 (s, CH), 111.38 (s, CH), 55.45 (s, OCH₃). Anal. Calcd for C₂₅H₂₂NOP: C, 78.30; H, 5.79; N, 3.65. Found: C, 78.16; H, 5.98; N, 3.48.

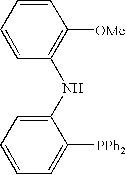

Synthesis of N-(2-diisopropylphosphinophenyl)-2-methoxyaniline. To a solution of N-(2-bromophenyl)-2-methoxyaniline (524.0 mg, 1.88 mmol) in diethyl ether (12 mL) at −35° C. was added n-BuLi (2.35 mL, 1.6 M in hexane, Aldrich, 3.76 mmol, 2 equiv) dropwise. The reaction mixture was naturally warmed and stirred at room temperature for 1 h. The solution was cooled to −35° C. again and neat chlorodiisopropylphosphine (0.3 mL, 1.88 mmol) was added. The reaction solution was stirred at room temperature overnight and evaporated to dryness under reduced pressure. Degassed deionized water (10 mL) was added. The product was extracted with deoxygenated dichloromethane (10 mL) from the aqueous solution. The dichloromethane solution was separated from the aqueous layer, from which the product was further extracted with dichloromethane (5 mL×2). The combined organic solution was dried over MgSO₄ and filtered. All volatiles were removed in vacuo to yield yellow viscous oil; yield 510.7 mg (86%). Crystals suitable for X-ray diffraction analysis were grown from a concentrated diethyl ether solution at −35° C. ¹H NMR (C₆D₆, 500 MHz) δ 7.89 (d, 1, Ar), 7.50 (dd, 1, Ar), 7.47 (dd, 1, Ar), 7.23 (dt, 1, Ar), 7.09 (td, 6, Ar), 6.82 (m, 3, Ar), 6.59 (dd, 1, Ar), 3.13 (s, 3, OMe), 1.94 (m, 2, CHMe₂), 1.06 (dd, 6, CHMe₂), 0.90 (dd, 6, CHMe₂). ³¹P {¹H} NMR (C₆D₆, 202.5 MHz) δ −14.58. ³¹P{¹H} NMR (diethyl ether, 80.95 MHz) δ −14.37. ¹³C{¹H} NMR (C₆D₆, 125.68 MHz) δ 150.08 (s, C), 149.33 (d, J_{CP}=18.32, C), 133.97 (d, J_{CP}=1.88, CH), 133.55 (s, C), 130.28 (s, CH), 122.61 (d, J_{CP}=15.56, C), 121.43 (s, CH), 120.90 (CH), 120.45 (s, CH), 117.18 (d, J_{CP}=2.76, CH), 115.69 (s, CH), 111.46 (s, CH), 55.62 (s, OCH₃), 23.44 (d, J_{CP}=11.06, CHMe₂), 20.58 (d, J_{CP}=18.32, CHMe₂), 19.18 (d, J_{CP}=8.28, CHMe₂). Anal. Calcd for C₁₉H₂₆NOP: C, 72.34; H, 8.31; N, 4.44. Found: C, 71.65; H, 7.96; N, 4.21.

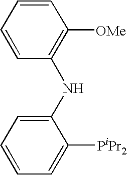

### EXAMPLE 11

### Synthesis of H[NP]

Synthesis of N-(2-bromophenyl)-2,6-dimethylaniline. A Schlenk flask was charged with 1-bromo-2-iodobenzene (10.082 g, 35.64 mmol), 2,6-dimethylaniline (4.318 g, 35.64 mmol), Pd(OAc)₂ (40 mg, 0.178 mmol, 0.5% equiv), bis[2-(diphenylphosphino)phenyl]ether (DPEphos, 144 mg, 0.267 mmol, 0.75% equiv), sodium tert-butoxide (4.795 g, 49.9 mmol, 1.4 equiv), and toluene (70 mL) under nitrogen. The flask was sealed with a rubber septum and heated to 95° C. with stirring for 3 d. After being cooled to room temperature, the reaction mixture was evaporated to dryness under reduced pressure. The solid residue was dissolved in deionized water (70 mL) and CH₂Cl₂ (100 mL). The organic portion was separated from the aqueous layer, which was further extracted with dichloromethane (40 mL×2). The combined organic solution was dried over MgSO₄ and filtered. The solvent was removed in vacuo to yield brown viscous oil, which was subjected to flash column chromatography on Al₂O₃ using Et₂O as the eluant. The first band (pale yellow) was collected and solvent was removed in vacuo, affording the product as pale yellow oil, which solidified upon standing at room temperature; yield 9.720 g (99%). ¹H NMR (CDCl₃, 500 MHz) δ 7.53 (dd, 1, Ar), 7.18 (m, 3, Ar), 7.06 (t, 1, Ar), 6.64 (td, 1, Ar), 6.21 (dd, 1, Ar), 5.75 (br s, 1, NH), 2.25 (d, 6, CH₃). ¹³C{¹H} NMR (CDCl₃, 125.5 MHz) δ 143.26 (s, C), 137.49 (s, C), 136.50 (s, C), 132.41 (s, CH), 128.53 (s, CH), 128.27 (s, CH), 126.48 (s, CH), 118.55 (s, CH), 112.47 (s, CH), 109.45 (s, C), 18.14 (s, CH₃). Anal. Calcd for C₁₄H₁₄BrN: C, 60.89; H, 5.11; N, 5.07. Found: C, 61.19; H, 5.47; N, 5.15.

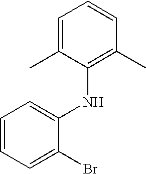

Synthesis of N-(2-diisopropylphosphinophenyl)-2,6-dimethylaniline. To a solution of N-(2-bromophenyl)-2,6-dimethylaniline (2.000 g, 7.24 mmol) in diethyl ether (40 mL) at −35° C. was added n-BuLi (9.05 mL, 1.6 M in Hexane, Aldrich, 14.48 mmol, 2 equiv). The reaction solution was naturally warmed to room temperature with stirring. After being stirred at room temperature for 1 h, the reaction mixture was cooled to −35° C. and chlorodiisopropylphosphine (1.105 g, 7.24 mmol) was added. The reaction solution was stirred at room temperature overnight and quenched with degassed deionized water (10 mL). The product was extracted with deoxygenated dichloromethane (50 mL). The organic solution was separated from the aqueous portion, from which the product was further extracted with dichloromethane (15 mL×2). The combined organic solution was dried over MgSO₄ and filtered. All volatiles were removed in vacuo, affording the product as yellow viscous oil; yield 2.173 g (96%). ¹H NMR (C₆D₆, 500 MHz) δ 7.22 (ddd, 1, Ar), 7.07 (d, 1, J_{HP}=12, NH), 7.01 (s, 3, Ar), 6.96 (td, 1, Ar), 6.70 (td, 1, Ar), 6.26 (dd, 1, Ar), 2.17 (s, 6, CH₃), 2.01 (septet of doublets, 2, PCHMe₂), 1.14 (dd, 6, PCHMe₂), 0.98 (dd, 6, PCHMe₂). ³¹P{¹H} NMR (C₆D₆, 202.31 MHz) δ −17.41. ³¹P{¹H} NMR (Et₂O, 80.95 MHz) δ −8.67. ¹³C{¹H} NMR (C₆D₆, 125.5 MHz) δ 152.87 (d, J_{CP}=19.23, C), 139.78 (d, J_{CP}=2.39, C), 137.20 (s, C), 133.76 (d, J_{CP}=2.76, CH), 131.01 (s, CH), 129.17 (s, CH), 126.63 (s, CH), 117.87 (s, CH), 117.29 (d, J_{CP}=13.70, C), 111.60 (d, J_{CP}=2.76, CH), 24.08 (d, ¹J_{CP}=9.67, CHMe₂), 20.80 (d, ²J_{CP}=18.73, CHMe₂), 19.45 (d, ²J_{CP}=8.67, CHMe₂), 18.86 (s, ArMe). Anal. Calcd for C₂₀H₂₈NP: C, 76.63; H, 9.01; N, 4.47. Found: C, 76.66; H, 9.28; N, 4.18.

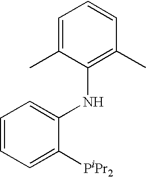

Synthesis of N-(4-fluorophenyl)-2,4,6-trimethylaniline. A Schlenk flask was charged with 4-fluoroaniline (99.0 mg, 0.89 mmol), 2,4,6-trimethylphenyl bromide (177.2 mg, 0.89 mmol), Pd(OAc)₂ (1.0 mg, 4.5 μmol, 0.5% equiv), racemic-2,2′-bis(diphenylphosphino)-1,1′-binaphthyl (rac-BINAP, 4.2 mg, 6.7 μmol, 0.75% equiv), sodium tert-butoxide (119.8 mg, 1.25 mmol, 1.4 equiv), and toluene (5 mL) under nitrogen. The flask was sealed with a rubber septum. The reaction mixture was heated with stirring to 95° C. in an oil bath for 3 d. Toluene was removed in vacuo and the reaction was quenched with deionized water (10 mL). The product was extracted with CH₂Cl₂ (5 mL) and the organic portion was separated from the aqueous layer, which was further treated with CH₂Cl₂ (3 mL×2) to extract product. The combined organic solution was dried over MgSO₄ and filtered. Removal of all volatiles in vacuo yielded the product as reddish brown, viscous oil; yield 181.6 mg (89%). ¹H NMR (C₆D₆, 500 MHz) δ 6.80 (s, 2, Ar), 6.74 (t, 2, Ar), 6.13 (m, 2, Ar), 4.35 (s, 1, NH), 2.17 (s, 3, para-ArCH₃), 2.01 (s, 6, ortho-ArCH₃). ¹H NMR (CDCl₃, 200 MHz) δ 7.01 (s, 2, Ar), 6.91 (t, 2, Ar), 6.49 (m, 2, Ar), 5.07 (s, 1, NH), 2.38 (s, 3, para-ArCH₃), 2.24 (s, 6, ortho-ArCH₃). ¹⁹F NMR (C₆D₆, 188.15 MHz) δ −128.42. ¹⁹F NMR (CDCl₃, 188.15 MHz) δ −128.48. ¹⁹F NMR (toluene, 188.15 MHz) δ −128.30. ¹³C{¹H} NMR (C₆D₆, 125.5 MHz) δ 156.92 (d, ¹J_{CF}=235.02, CF), 143.76 (d, J_{CF}=1.76, C), 136.60 (s, C), 136.37 (s, C), 135.79 (s, C), 130.01 (s, CH), 116.33 (d, J_{CF}=21.99, CH), 114.53 (d, J_{CF}=7.29, CH), 21.32 (s, para-ArCH₃), 18.50 (s, ortho-ArCH₃).

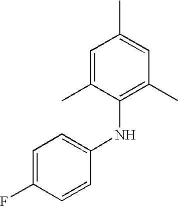

Synthesis of N-(2-bromo-4-fluorophenyl)-2,4,6-trimethylaniline. In air, N-bromosuccinimide (2328.67 mg, 13.084 mmol) was added in portions over a period of 30 min to a stirred solution of N-(4-fluorophenyl)-2,4,6-trimethylaniline (3.00 g, 13.084 mmol) in CH₃CN (20 mL) at 0° C. The reaction solution was warmed to room temperature and stirred at room temperature for 30 min. A saturated aqueous solution of NaHCO₃ (20 mL) was added. The solution was filtered through a pad of Celite to remove insoluble materials, which was further washed with diethyl ether (15 mL×2). The filtrates were combined and evaporated to dryness under reduced pressure to afford the product as a tan solid. Recrystallization of the tan solid from a concentrated acetone solution at ca −10° C. gave colorless crystals; yield 2.927 g (73%). ¹H NMR (CDCl₃, 500 MHz) δ 7.26 (dd, 1, Ar), 6.96 (s, 2, Ar), 6.77 (td, 1, Ar), 6.09 (dd, 1, Ar), 5.46 (s, 1, NH), 2.32 (s, 3, para-ArCH₃), 2.15 (s, 6, ortho-ArCH₃). ¹⁹F NMR (CDCl₃, 188.15 MHz) δ −127.61. ¹⁹F NMR (CH₃CN, 188.15 MHz) δ −128.38. ¹³C{¹H} NMR (CDCl₃, 125.5 MHz) δ 177.42 (s, C), 154.78 (d, J_{CF}=238.95, C), 140.35 (d, J_{CF}=2.26, C), 136.23 (s, C), 135.61 (d, J_{CF}=136.49, C), 129.31 (s, CH), 119.28 (d, J_{CF}=25.64, CH), 114.93 (d, J_{CF}=21.87, CH), 112.39 (d, J_{CF}=7.54, CH), 108.32 (d, J_{CF}=10.05, C), 20.91 (s, para-ArCH₃), 17.98 (s, ortho-ArCH₃).

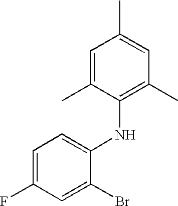

Synthesis of N-(2-diphenylphosphino-4-fluorophenyl)-2,4,6 trimethylaniline, H[Mes-NP-Ph]^{F}. To a solution of N-(2-bromo-4-fluorophenyl)-2,4,6-trimethylaniline (300 mg, 0.97 mmol) in diethyl ether (10 mL) at −35° C. was added n-BuLi (1.22 mL, 1.95 mmol, 2 equiv). The reaction mixture was naturally warmed to room temperature and stirred for 1 h. The solution was cooled to −35° C. and chlorodiphenylphosphine (214.8 mg, 0.97 mmol) was added. The reaction solution was stirred at room temperature overnight and MeOH (43 mg, 1.4 equiv) was added. The solution was filtered through a pad of Celite, which was further washed with diethyl ether (4 mL). The filtrate and washings were combined and evaporated to dryness under reduced pressure. The pale yellow oily residue thus obtained was dissolved in diethyl ether (2 mL) and cooled to −35° C., affording the product as pale yellow crystals suitable for X-ray diffraction analysis; yield 223.7 mg (56%). ¹H NMR (C₆D₆, 500 MHz) δ 7.39 (m, 4; Ar), 7.04 (m, 6, Ar), 6.89 (td, 1, Ar), 6.76 (s, 2, Ar), 6.68 (td, 1, Ar), 6.16 (m, 1, Ar), 5.72 (d, J_{HP}=6, NH), 2.15 (s, 3, para-ArCH₃), 1.95 (s, 6, ortho-ArCH₃). ¹⁹FNMR (C₆D₆, 188.15 MHz) δ −127.00. ³¹P{¹H} NMR (C₆D₆, 202.5 MHz) δ −18.36. ¹³C{¹H} NMR (C₆D₆, 125.5 MHz) δ 157.10 (dd, J_{CF}=238.0, J_{CP}=1.9, CF), 146.16 (dd, J=17.3, J=1.8, C), 136.70 (d, J_{CP}=1.8, C), 135.98 (s, C), 135.64 (s, C), 135.57 (d, J=8.80, C), 134.71 (d, J=19.7, CH), 130.00 (s, CH), 129.74 (s, CH), 129.42 (d, J=7.3, CH), 123.08 (dd, J_{CP}=12.8, 4.1, C), 120.63 (dd, J_{CP}=22.8, 3.3, CH), 117.62 (d, J_{CP}=22.5, CH), 113.56 (dd, J_{CP}=6.8, 2.8, CH), 21.21 (s, CH₃), 18.45 (s, CH₃).

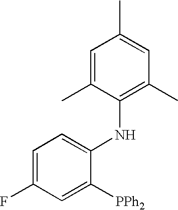

Synthesis of N-(2-diisopropylphosphino-4-fluorophenyl)-2,4,6-trimethylaniline, H[Mes-NP-ⁱPr]^{F}. Methanol (30 mg, 0.94 mmol) was added to a diethyl ether solution (10 mL) of [Mes-NP-ⁱPr]FLi(OEt₂) (137 mg, 0.32 mmol) at room temperature. The reaction solution was stirred at room temperature for 5 min and filtered through a pad of Celite. The filtrate was evaporated to dryness under reduced pressure to afford the product as yellow oil; yield 100.4 mg (90%). Crystals suitable for X-ray diffraction analysis were grown from a concentrated diethyl ether solution at −35° C. ¹H NMR (C₆D₆, 500 MHz) δ 7.07 (dt, 1, Ar), 6.81 (s, 2, Ar), 6.78 (d, 1, Ar), 6.68 (td, 1, Ar), 6.09 (dt, 1, Ar), 2.18 (s, 3, para-ArCH₃), 2.13 (s, 6, ortho-ArCH₃), 1.84 (m, 2, CHMe₂), 1.06 (dd, 6, CHMe₂), 0.90 (dd, 6, CHMe₂). ¹⁹F NMR (C₆D₆, 188.15 MHz) δ −129.87. ¹⁹F NMR (diethyl ether, 188.15 MHz) δ −130.27. ³¹P{¹H} NMR (C₆D₆, 202.5 MHz) δ −16.15. ³¹P{¹H} NMR (diethyl ether, 80.95 MHz) δ −15.90. ¹³C{¹H} NMR (C₆D₆, 125.5 MHz) δ 156.23 (d, ¹J_{CF}=236.94, CF), 149.60 (d, J_{CP}=18.20, C), 137.28 (d, J=2.76, C), 136.86 (s, C), 135.91 (s, C), 129.99 (s, CH), 119.54 (dd, J=2.76 and 21.08, CH), 119.03 (dd, J=3.64 and 17.32, C), 117.64 (d, J=21.96, CH), 112.29 (dd, J=2.76 and 6.40, CH), 24.13 (d, J_{CP}=10.04, CHMe₂), 21.37 (s, para-ArMe), 20.60 (d, J_{CP}=18.20, CHMe₂), 19.33 (d, J_{CP}=9.16, CHMe₂), 18.68 (s, ortho-ArMe).

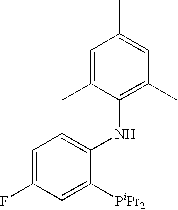

Synthesis of N-(2-bromophenyl)-2,6-diisopropylaniline, H[ⁱPr—NBr]. A Schlenk flask was charged with 1-bromo-2-iodobenzene (1.000 g, 3.54 mmol), 2,6-diisopropylaniline (0.627 g, 3.54 mmol), Pd(OAc)₂ (4 mg, 0.018 mmol, 0.5% equiv), bis[2-(diphenylphosphino)phenyl]ether (DPEphos, 14.3 mg, 0.027 mmol, 0.75% equiv), sodium tert-butoxide (0.475 g, 4.95 mmol, 1.4 equiv), and toluene (25 mL) under nitrogen. The flask was sealed with a rubber septum and heated to 95° C. with stirring for 7 d. After being cooled to room temperature, the reaction mixture was evaporated to dryness under reduced pressure. The solid residue was dissolved in deionized water (25 mL) and CH₂Cl₂ (25 mL). The organic portion was separated from the aqueous layer, which was further extracted with dichloromethane (10 mL×2). The combined organic solution was dried over MgSO₄ and filtered. The solvent was removed in vacuo to yield brown viscous oil, which was subjected to flash column chromatography on Al₂O₃ using Et₂O as the eluant. The first band (pale yellow) was collected and solvent was removed in vacuo, affording the product as pale yellow oil; yield 1.100 g (94%). ¹H NMR (CDCl₃, 500 MHz) δ 7.39 (dd, 1, Ar), 7.24 (m, 1, Ar), 7.16 (m, 2, Ar), 6.91 (td, 1, Ar), 6.48 (td, 1, Ar), 6.07 (dd, 1, Ar), 5.61 (s, 1, NH), 3.02 (septet, 2, CHMe₂), 1.10 (d, 6, CHMe₂), 1.03 (d, 6, CHMe₂). ¹³C{¹H} NMR (CDCl₃, 125.5 MHz) δ 147.67 (s, C), 144.87 (s, C), 134.62 (s, C), 132.32 (s, CH), 128.24 (s, CH), 127.75 (s, CH), 123.92 (s, CH), 118.25 (s, CH), 112.58 (s, CH), 108.83 (s, C), 28.30 (s, CHMe₂), 24.64 (s, CHMe₂), 23.00 (s, CHMe₂).

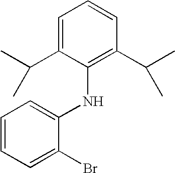

Synthesis of H[ⁱPr—NP-ⁱPr]. To a solution of N-(2-bromophenyl)-2,6-diisopropylaniline (207.7 mg, 0.625 mmol) in diethyl ether (6 mL) at −35° C. was added n-BuLi (0.8 mL, 1.6 M in Hexane, Aldrich, 1.28 mmol, 2 equiv). The reaction solution was naturally warmed to room temperature with stirring. After being stirred at room temperature for 1 h, the reaction mixture was cooled to −35° C. and chlorodiisopropylphosphine (0.1 mL, 0.625 mmol) was added. The reaction solution was stirred at room temperature overnight and quenched with degassed deionized water (10 mL). The product was extracted with deoxygenated dichloromethane (10 mL). The organic solution was separated from the aqueous portion, from which the product was further extracted with dichloromethane (5 mL×2). The combined organic solution was dried over MgSO₄ and filtered. All volatiles were removed in vacuo, affording the product as yellow viscous oil; yield 210.4 mg (91%). ¹H NMR (C₆D₆, 500 MHz) δ 7.24 (d, 1, J_{HP}=8.5, NH), 7.20 (m, 3, Ar), 7.15 (t, 1, Ar), 6.96 (td, 1, Ar), 6.67 (td, 1, Ar), 6.30 (ddd, 1, Ar), 3.36 (septet, 2, ArCHMe₂), 2.02 (septet of doublets, 2, PCHMe₂), 1.19 (d, 6, ArCHMe₂), 1.16 (dd, 6, PCHMe₂), 1.13 (d, 6, ArCHMe₂), 1.10 (dd, 6, PCHMe₂). ³¹P{¹H} NMR (C₆D₆, 202.31 MHz) δ −17.15. ³¹P{¹H} NMR (Et₂O, 80.95 MHz) δ −8.37. ¹³C{¹H} NMR (C₆D₆, 125.5 MHz) δ 154.69 (d, J_{CP}=19.23, C), 148.21 (s, C), 137.28 (d, J_{CP}=2.76, C), 133.71 (d, J_{CP}=3.27, CH), 131.00 (s, CH), 128.00 (s, CH), 124.55 (s, CH), 117.79 (s, CH), 116.68 (d, J_{CP}=12.82, C), 111.92 (d, J_{CP}=2.76, CH), 29.33 (s, ArCHMe₂), 25.34 (s, ArHMe₂), 24.07 (d, ¹J_{CP}=9.17, PCHMe₂), 23.35 (s, ArCHMe₂), 20.72 (d, ²J_{CP}=18.73, PCHMe₂), 19.39 (d, ²J_{CP}=8.67, PCHMe₂).

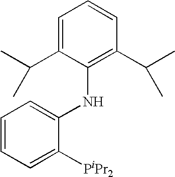

### EXAMPLE 12

### Synthesis of H[NPN]

Synthesis of {Li[Mes-NPN]}₂(μ-DME){Li(DME)₃}₂. To a solution of N-(2-bromo-4-fluorophenyl)-2,4,6-trimethylaniline (500 mg, 1.62 mmol) in diethyl ether (30 mL) at −35° C. was added n-BuLi (1.3 mL, 2.5 M in hexane, 3.25 mmol, 2 equiv). The reaction mixture was naturally warmed to room temperature with stirring for 1 h and then cooled to −35° C. again. Dichlorophenylphosphine (145.2 mg, 0.81 mmol, 0.5 equiv) was added. The reaction solution was stirred at room temperature overnight and filtered through a pad of Celite, which was further washed with diethyl ether (10 mL×2). The filtrates were combined and dimethoxyethane (730 mg, 8.1 mmol, 5 equiv) was added. The solution was concentrated under reduced pressure to ca. 2 mL, and cooled to −35° C. to afford the product as yellow crystals suitable for X-ray diffraction analysis; yield 924.8 mg (64%). ¹H NMR (C₆D₆, 500 MHz) δ 7.61 (t, 4, Ar), 7.47 (quintet, 4, Ar), 7.07 (td, 4, Ar), 6.98 (t, 2, Ar), 6.94 (s, 4, Ar), 6.93 (s, 4, Ar), 6.75 (td, 4, Ar), 6.29 (m, 4, Ar), 2.86 (s, 28, OCH2), 2.84 (s, 42, OMe), 2.30 (s, 12, ArCH₃), 2.28 (s, 12, ArCH₃), 2.22 (s, 12, ArCH₃). ¹⁹F NMR (C₆D₆, 188.15 MHz) δ −133.19. ¹⁹F NMR (diethyl ether, 188.15 MHz) δ −132.26. ³¹P{¹H} NMR (C₆D₆, 202.5 MHz) δ −34.55. ³¹P{¹H} NMR (diethyl ether, 80.95 MHz) δ −33.48. ⁷Li{¹H} NMR (C₆D₆, 194.20 MHz) δ 1.17. ¹³C{¹H} NMR (C₆D₆, 125.5 MHz) δ 161.05 (d, J_{CP}=27.4, C), 154.36 (d, J_{CF}=232.9, CF), 152.20 (s, C), 139.86 (s, C), 134.23 (s, C), 133.12 (s, C), 132.50 (d, J_{CP}=14.2, CH), 131.22 (s, CH), 129.61 (s, C), 129.53 (s, CH), 128.93 (d, J_{CP}=4.5, CH), 127.34 (s, CH), 120.37 (dd, J_{CP}=19.7 and 1.9, CH), 119.39 (t, J_{CP}=5.5, C), 118.76 (d, J_{CP}=22.5, CH), 117.61 (s, CH), 71.48 (s, OCH₂), 59.14 (s, OCH₃), 21.31 (s, CH₃), 20.40 (s, CH₃), 20.22 (s, CH₃). Anal. Calcd for C₁₀₀H₁₃₆F₄Li₄N₄O₁₄P₂: C, 67.30; H, 7.69; N, 3.14. Found: C, 67.03; H, 7.42; N, 2.90.

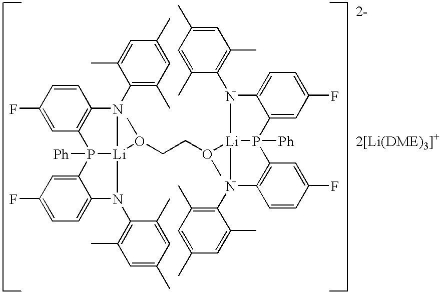

Synthesis of H₂[Mes-NPN]. Methanol (1.35 mg, 0.042 mmol, 1.5 equiv) was added to a diethyl ether (4 mL) solution of {Li-[Mes-NPN]}₂(μ-DME){Li(DME)₃}₂ (50 mg, 0.028 mmol) at room temperature. The reaction solution was stirred at room temperature for 10 min and filtered through a pad of Celite, which was further washed with diethyl ether (1 mL×2). The filtrate and washings were combined and evaporated to dryness under reduced pressure to afford the product as an off-white solid; yield 15.7 mg (99%). ¹H NMR (C₆D₆, 500 MHz) δ 7.42 (td, 2, Ar), 7.06 (m, 2, Ar), 7.02 (m, 3, Ar), 6.74 (br s, 2, Ar), 6.70 (td, 4, Ar), 6.16 (m, =2, Ar), 5.74 (d, 2, ⁴J_{HP}=5.5, NH), 2.12 (s, 6, CH₃), 1.97 (s, 6, CH₃), 1.92 (s, 6, CH₃). ¹⁹F NMR (C₆D₆, 188.15 MHz) δ −126.68. ³¹P{¹H} NMR (C₆D₆, 202.5 MHz) δ −30.94. ¹³C{¹H} NMR (C₆D₆, 125.5 MHz) δ 157.16 (dd, J_{CF}=236.1, J_{CP}=2.8, C), 146.43 (s, C), 146.29 (s, C), 136.50 (s, C), 135.83 (s, C), 135.76 (s, C), 135.02 (s, CH), 134.86 (s, CH), 132.83 (d, J=4.5, C), 130.26 (s, CH), 130.05 (s, CH), 129.74 (d, J=7.4, CH), 120.72 (dd, J=22.8 and 3.6, CH), 119.95 (dd, J=9.2 and 4.6, C), 118.25 (d, J=22.8, CH), 114.07 (dd, J=6.4, 2.8, CH), 21.26 (s, CH₃), 18.44 (s, CH₃), 18.32 (s, CH₃). Anal. Calcd for C₃₆H₃₅F₂N₂P: C, 76.56; H, 6.25; N, 4.96. Found: C, 76.99; H, 6.54; N, 4.43.

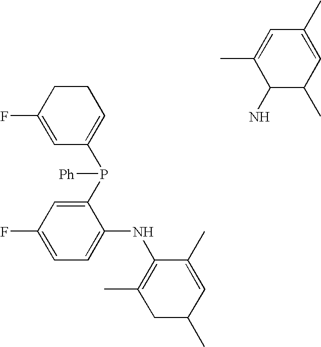

### EXAMPLE 13

### Carbon-Carbon Bond Formation Catalyzed by the Complex

General Procedures of Heck Reactions of aryl halides with styrene. A 100-mL Schlenk flask was sequentially charged with [PNP]PdCl (1.0 mg, 0.00147 mmol, 0.2% with respect to the halide), 1 equiv of aryl halide, MeNCy₂ (160.0 mg, 0.8190 mmol, 1.1 equiv), styrene (85.0 mg, 0.8161 mmol, 1.1 equiv), NMP (2 mL) and a magnetic stir bar. The flask was capped with a stopper and the reaction mixture was stirred in a 160° C. oil bath for 12 h. A reaction aliquot was taken and analyzed with GC, which showed quantitative formation of the olefinated product. After the reaction was cooled to room temperature, hydrochloric acid (1 M, 6 mL) was added to the reaction mixture and the product was extracted with diethyl ether (15 mL×3). After being separated from the aqueous layer, the diethyl ether solution was further washed with deionized water (15 mL×3), dried over MgSO₄, and evaporated to dryness under reduced pressure. The residue was then washed with hexane (5 mL×3) and dried in vacuo to afford the product. The ¹H and ¹³C NMR spectroscopic data of the coupled product are identical to those reported previously (Djakovitch, L.; Koehler, K. J. Am. Chem. Soc. 2001, 123, 5990-5999.).

### REPRESENTATIVE EXAMPLE

### Synthesis of 4-Acetylstilbene

A 100-mL Schlenk flask was sequentially charged with [PNP]PdCl (1.0 mg, 0.00147 mmol, 0.2% with respect to the bromide), 4-bromoacetophenone (147.0 mg, 0.7385 mmol, 1 equiv), MeNCy₂ (160.0 mg, 0.8190 mmol, 1.1 equiv), styrene (85.0 mg, 0.8161 mmol, 1.1 equiv), NMP (2 mL) and a magnetic stir bar. The flask was capped with a stopper and the reaction mixture was stirred in a 160° C. oil bath for 12 h. A reaction aliquot was taken and analyzed with GC, which showed quantitative formation of the olefinated product. After the reaction was cooled to room temperature, hydrochloric acid (1 M, 6 mL) was added to the reaction mixture and the product was extracted with diethyl ether (15 mL×3). After being separated from the aqueous layer, the diethyl ether solution was further washed with deionized water (15 mL×3), dried over MgSO₄, and evaporated to dryness under reduced pressure. The residue was then washed with hexane (5 mL×3) and dried in vacuo to afford the product as a colorless solid; yield 137.4 mg (83%). ¹H NMR (CDCl₃, 500 MHz) δ 7.93 (d, 2, o-C₆H₄COMe, J_{HH}=8), 7.54 (d, 2, m-C₆H₄COMe, J_{HH}=8), 7.52 (d, 2, o-C₆H₅, J_{HH}=8), 7.37 (t, 2, m-C₆H₅, J_{HH}=7.5), 7.30 (t, 1, p-C₆H₅, J_{HH}=7), 7.19 (d, 1, vinyl-C₆H₅, J_{HH}=16.5), 7.09 (d, 2, vinyl-C₆H₅, J_{HH}=16.5), 2.57 (s, 3, COMe). ¹³C{¹H} NMR (CDCl₃, 125.70 MHz) δ 197.18 (s, COMe, C), 141.70 (s, p-C₆H₄COMe, C), 136.43 (s, C₆H₄COMe, COMe), 135.66 (s, C₆H₅, C), 131.17 (s, m-C₆H₅, CH), 128.63 (s, m-C₆H₄COMe, CH), 128.58 (s, o-C₆H₄COMe, CH), 128.10 (s, p-C₆H₅, CH), 127.16 (s, o-C₆H₅, CH), 126.63 (s, C═C, CH), 126.27 (s, C═C, CH), 26.33 (s, COMe, CH₃).

Synthesis of Stilbene. ¹H NMR (CDCl₃, 500 MHz) δ 7.62 (d, 4, o-C₆H₅, J_{HH}=7.5), 7.46 (t, 4, M-C₆H₅, J_{HH}=7.5), 7.36 (t, 2, p-C₆H₅, J_{HH}=7.5), 7.22 (s, 2, vinyl-C₆H₅). ¹³C{¹H} NMR (CDCl₃, 125.70 MHz) δ 137.26 (s, C₆H₅, C), 128.64 (s, C═C, CH), 128.63 (s, m-C₆H₅, CH), 127.56 (s, p-C₆H₅, CH), 126.47 (s, o-C₆H₅CH).

Synthesis of 4-Nitrostilbene. ¹H NMR (CDCl₃, 500 MHz) δ 8.21 (d, 2, o-C₆H₄NO₂, J_{HH}=8.5), 7.62 (d, 2, m-C₆H₄NO₂, J_{HH}=8.5), 7.56 (d, 4, o-C₆H₅, J_{HH}=7.5), 7.41 (t, 2, m-C₆H₅, J_{HH}=7.5), 7.35 (t, 1, p-C₆H₅, J_{HH}=7), 7.27 (d, 1, vinyl-C₆H₅, J_{HH}=16), 7.14 (d, 2, vinyl-C₆H₅, J_{HH}=16.5). ¹³C{¹H} NMR (CDCl₃, 125.70 MHz) δ 146.65 (s, C₆H₄NO₂, C—N), 143.76 (s, p-C₆H₄NO₂, C), 136.09 (s, C₆H₅, C), 133.21 (s, m-C₆H₅, CH), 128.82 (s, o-C₆H₄NO₂, CH), 128.77 (s, p-C₆H₅, CH), 126.95 (s, C═C, CH), 126.77 (s, C═C, CH), 126.18 (s, o-C₆H₅, CH), 124.05 (s, m-C₆H₄NO₂, CH).

Synthesis of 4-Stilbenecarboxaldehyde. ¹H NMR (CDCl₃, 500 MHz) δ 9.98 (s, 1, COH), 7.86 (d, 2, o-C₆H₄COH, J_{HH}=8.5), 7.63 (d, 2, m-C₆H₄COH, J_{HH}=8.5), 7.54 (d, 2, o-C₆H₅, J_{HH}=7.5), 7.39 (t, 2, m-C₆H₅, J_{HH}=7.5), 7.32 (t, 1, p-C₆H₅, J_{HH}=7), 7.24 (d, 1, vinyl-C₆H₅, J_{HH}=16.5), 7.12 (d, 2, vinyl-C₆H₅, J_{HH}=16.5). ¹³C{¹H} NMR (CDCl₃, 125.70 MHz) δ 191.47 (s, COH, C), 143.22 (s, p-C₆H₄COH, C), 136.37 (s, C₆H₄COH, COH), 135.14 (s, C₆H₅ C), 132.01 (s, m-C₆H₅, CH), 130.07 (s, m-C₆H₄COH, CH), 128.69 (s, o-C₆H₄COH, CH), 128.37 (s, p-C₆H₅, CH), 127.14 (s, o-C₆H₅, CH), 126.78 (s, C═C, CH), 126.75 (s, C═C, CH).

General Procedures for the Heck Reactions. A Schlenk flask was charged with 3a or 3b (1.0 mg for each single experiment) along with an appropriate amount of aryl halide (1.0 equiv), styrene (1.1 equiv), MeNCy2 (1.1 equiv), and NMP (2 mL) and a magnetic stir bar. The flask was capped with a stopper and heated in an oil bath at 160° C. with stirring for a specified period of time. After the reaction mixture was cooled to room temperature, hydrochloric acid (1M, 6 mL) was added and the product was extracted with diethyl ether (15 mL_{—}3). The aqueous solution was separated from the organic layer. The diethyl ether solution was washed with deionized water (15 mL_{—}3), dried over MgSO₄, and evaporated to dryness under reduced pressure to afford the desired product, which was then washed with hexane (5 mL_{—}3) or subject to flash column chromatography on silica gel. For experiments with low catalyst loading (entries 2-5), stock solutions of appropriate concentrations were prepared by dissolving 1.0 mg of [PNP]PdCl in appropriate amounts of NMP and used for each independent run.

trans-Stilbene (Y═H). ¹H NMR (CDCl₃, 500 MHz): δ 7.62 (d, 4, J_{HH}) 7.5, o-C6H5), 7.46 (t, 4, J_{HH}) 7.5, m-C₆H₅), 7.36 (t, 2, J_{HH}) 7.5, p-C₆H₅), 7.22 (s, 2, CHdCH). ¹³C NMR (CDCl₃, 125.70 MHz): δ 137.26 (ipso-C₆H₅), 128.64 (CHdCH), 128.63 (m-C₆H₅), 127.56 (p-C₆H₅), 126.47 (o-C₆H₅). LRMS (EI): calcd for C₁₄H₁₂ m/z 180, found m/z 180.

4-Acetylstilbene (Y═C(O)Me). ¹H NMR (CDCl₃, 500 MHz): δ 7.93 (d, 2, o-C₆H₄C(O)Me, J_{HH}) 8), 7.54 (d, 2, J_{HH}=8), 7.52 (d, 2, J_{HH}=8), 7.37 (t, 2, m-C₆H₅, J_{HH}=7.5), 7.30 (t, 1, p-C₆H₅, J_{HH}=7), 7.19 (d, 1, CHdCH, 3 J_{HH}=16.5), 7.09 (d, 1, CHdCH, 3 J_{HH}=16.5), 2.57 (s, 3, Me). ¹³C NMR (CDCl₃, 125.70 MHz): δ 197.18 (CdO), 141.70 (C), 136.43 (C), 135.66 (C), 131.17 (CH), 128.63 (CH), 128.58 (CH), 128.10 (CH), 127.16 (CH), 126.63 (CH), 126.27 (CH), 26.33 (CH₃). Anal. Calcd for C₁₆H₁₄O: C, 86.45; H, 6.35. Found: C, 86.12; H, 6.40.

4-Nitrostilbene (Y═NO2). ¹H NMR (CDCl₃, 500 MHz): δ8.21 (d, 2, o-C6H4NO2, J_{HH}=8.5), 7.62 (d, 2, m-C6H4NO2, J_{HH}=8.5), 7.56 (d, 2, o-C6H5CHdCH, J_{HH}=7.5), 7.41 (t, 2, m-C6H5CHdCH, J_{HH}=7.5), 7.35 (t, 1, p-C6H5CHdCH, J_{HH}=7), 7.27 (d, 1, CHdCH, 3 J_{HH}=16), 7.14 (d, 1, CHdCH, 3 J_{HH}=16). ¹³C NMR (CDCl₃, 125.70 MHz): δ 146.65 (CNO2), 143.76 (C), 136.09 (C), 133.21 (CH), 128.82 (CH), 128.77 (CH), 126.95 (CH), 126.77 (CH), 126.18 (CH), 124.05 (CH). LRMS (EI): calcd for C₁₄H₁₁NO₂ m/z 225, found m/z 225. Anal. Calcd for C₁₄H₁₁NO₂: C, 74.65; H, 4.92; N, 6.22. Found: C, 74.35; H, 4.98; N, 6.16.

4-Stilbenecarboxaldehyde (Y═CHO). ¹H NMR (CDCl₃, 500 MHz): δ 9.98 (s, 1, CHO), 7.86 (d, 2, o-C₆H₄CHO, J_{HH}=8.5), 7.63 (d, 2, m-C₆H₄CHO, J_{HH}=8.5), 7.54 (d, 2, o-C₆H₅CHdCH, J_{HH}=7.5), 7.39 (t, 2, m-C₆H₅CHdCH, J_{HH}=7.5), 7.32 (t, 1, p-C₆H₅CHdCH, J_{HH}=7), 7.24 (d, 1, CHdCH, J_{HH}=16.5), 7.12 (d, 1, CHdCH, J_{HH}=16.5). ¹³C NMR (CDCl₃, 125.70 MHz): δ 191.47 (CHO), 143.22 (C), 136.37 (C), 135.14 (C), 132.01 (CH), 130.07 (CH), 128.69 (CH), 128.37 (CH), 127.14 (CH), 126.78 (CH), 126.75 (CH). LRMS (EI): Calcd for C₁₅H₁₂O m/z 208, found m/z 208.

While embodiments of the present invention have been illustrated and described, various modifications and improvements can be made by persons skilled in the art. The embodiments of the present invention are therefore described in an illustrative but not restrictive sense. It is intended that the present invention is not limited to the particular forms as illustrated, and that all the modifications not departing from the spirit and scope of the present invention are within the scope as defined in the appended claims.

1. A ligand L represented by the following general formula I 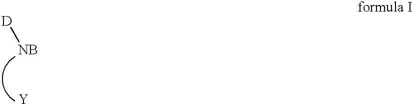
wherein:
B represents H or a bond;
D represents A ring or t-butyl group;
A represents a ring or a heterocyclic ring, and said ring or heterocyclic ring is unsubstituted or substituted with Xⁿ;
Xⁿ for each occurrence independently represents one or more groups selected from the group consisting of hydrocarbons, PR¹R², NR¹R², OR¹, SR¹, and AsR¹R²;
Y represents a group selected from the group consisting of PR¹R², PR¹R²R⁹, P(═O)R¹R², NR¹R², OR¹, SR¹, and AsR¹R²;
n represents an integer larger than or equal to 1;
R¹, R² and R⁹ for each occurrence independently represent saturated or unsaturated hydrocarbon or aromatic groups with or without heteroatoms of O, S, N, P or As; and
the linkage between N—Y is a saturated or unsaturated hydrocarbon or aromatic group with or without substituents; and
wherein; the ligand L is not (a) bis(2-diphenylphosphinophenyl)amine represented by the following formula Ia: 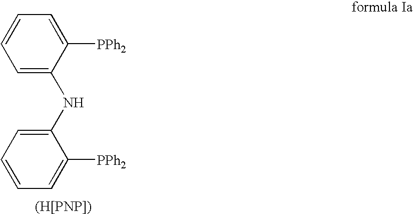
wherein Ph represents phenyl group; or
the ligand L is not (b)
N-(2-diphenylphosphinophenyl)-2,6-diisopropylaniline or
N-(2-diphenylphosphinophenyl)-2,6-dimethylaniline represented by the following formula Ib: 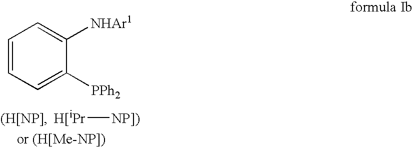
wherein:
Ar¹ represents 2,6-C₆H₃ⁱPr₂ or 2,6-C₆H₃Me₂;
Ph represents phenyl group;
ⁱPr represents isopropyl group; and
Me represents methyl group; or
the ligand L is not (c) represented by the following formula Ic: 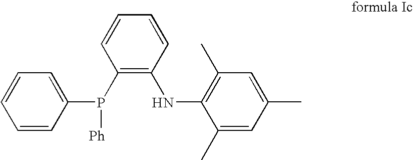
wherein Ph represents phenyl group.

2. The ligand according to claim 1, wherein D is A ring.

3. The ligand according to claim 1, wherein A is an unsubstituted or substituted heterocyclic ring comprising N, O, S, or P atom.

4. The ligand according to claim 1, wherein A is a five or six membered ring or a five or six membered heterocyclic ring.

5. The ligand according to claim 1, wherein A is an unsubstituted or substituted aromatic ring.

6. The ligand according to claim 5, wherein A is an unsubstituted or substituted phenyl group.

7. The ligand according to claim 1, wherein A is substituted with halogen.

8. The ligand according to claim 1, wherein A is an unsubstituted ring.

9. The ligand according to claim 1, wherein Xⁿ is PR¹R² or OR¹.

10. The ligand according to claim 1, wherein Y is PR¹R² or NR¹R².

11. The ligand according to claim 1, wherein R¹, R² and R⁹ for each occurrence independently represent phenyl group with or without substituents or alkyl group having one to four carbon atoms.

12. The ligand according to claim 1, wherein R¹, R² or R⁹ is substituted with halogen.

13. The ligand according to claim 1, wherein n is 1.

14. The ligand according to claim 1, wherein the linkage between N—Y is alkyl with or without substituents.

15. The ligand according to claim 1, wherein the linkage between N—Y is ethyl, propyl or phenyl group with or without substituent.

16. The ligand according to claim 1, wherein the linkage between N—Y is substituted with halogen.

17. The ligand according to claim 1, wherein the ligand is a monoanion when B represents a bond.

18. The ligand according to claim 1, wherein the ligand is represented by the formula selected from the group consisting of formulae Id, Ie, If, Ig, Ih, Ii, Ij, Ik, Il, Im, In, and Io; 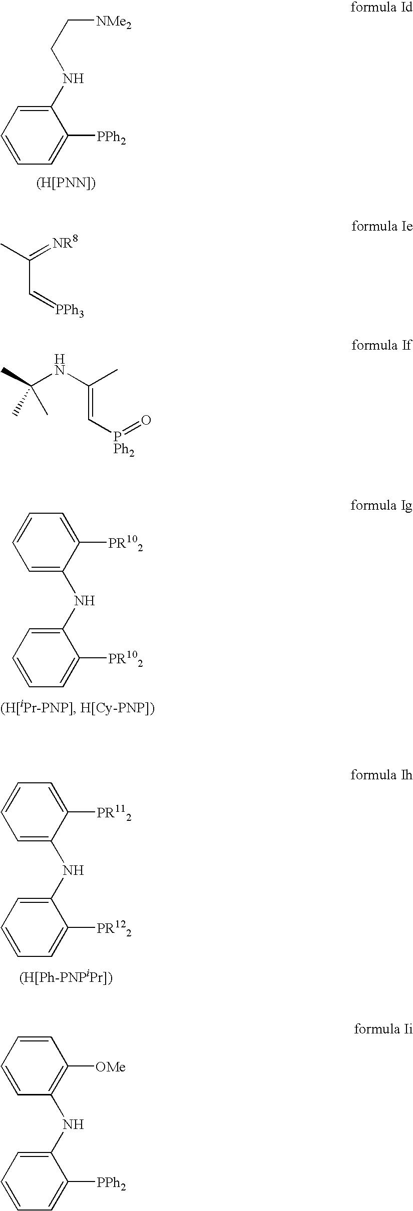 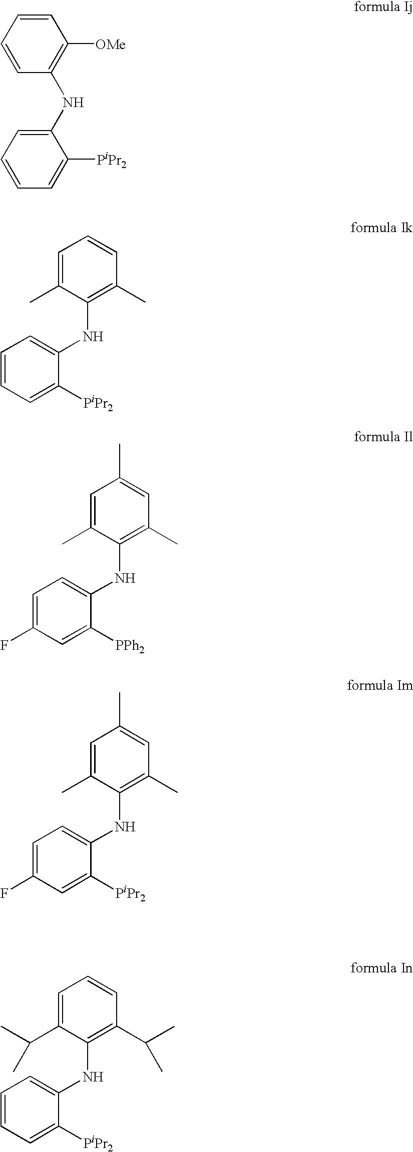 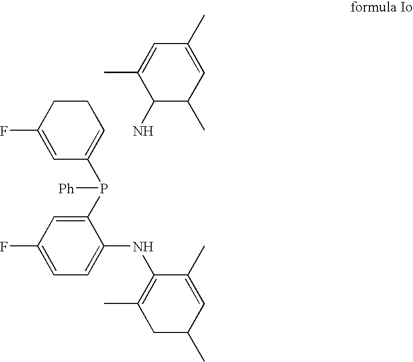
wherein:
R⁸ is selected from the group consisting of 2,6-C₆H₃ⁱPr₂, 2,6-C₆H₃Me₂, Ph, and t-butyl group;
R¹⁰ is selected from the group consisting of isopropyl group and cyclohexyl group;
R¹¹ represents isopropyl group;
R¹² represents phenyl group; and
Me represents methyl group.

19. A method for synthesizing the ligand according to claim 1 comprising the steps of:
(a1) conducting a cross-coupling reaction of a bromine, iodine or chlorine substituted fluoride and a fluorine substituted amine to form an amine with multiple fluorine substituents; or 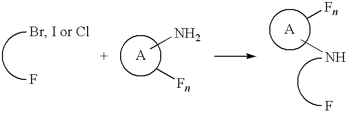
(a2) conducting a cross-coupling reaction of an iodine or chlorine substituted bromide and a bromine substituted amine to form an amine with multiple bromine substituents; and 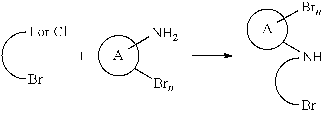
(b) conducting a nucleophilic reaction of the amine with multiple fluorine in (a1) or bromine substituents (a2), M²Xⁿ and M²Y to form the ligand represented by the formula I;
wherein:
the linkage between fluorine and bromine, iodine or chlorine of the fluoride in (a1), or the linkage between iodine or chlorine substituted bromide in (a2), is a saturated or unsaturated hydrocarbon or aromatic group with or without substituents;
M² is a metal selected from the group consisting of Li, Na and K; and
A, n, Xⁿ and Y are as defined in claim 1.

20. The method according to claim 19, wherein M² represents K.

21. The method according to claim 19 comprising the steps depicted below:

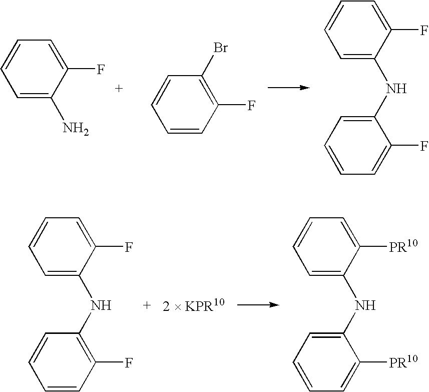

22. The method according to claim 19 comprising the steps depicted below:

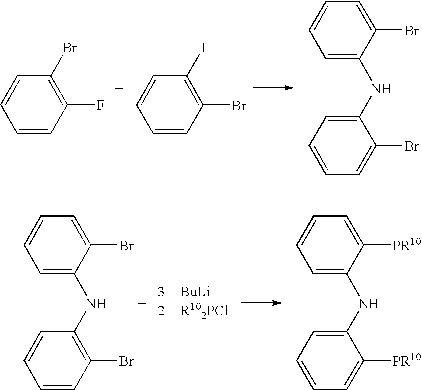

23. The method according to claim 19 comprising the steps depicted below:

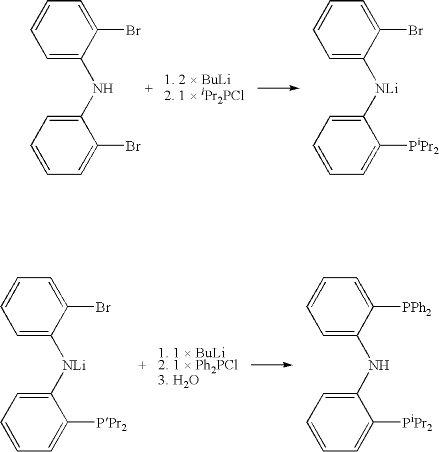

24. A method for synthesizing the ligand according to claim 1 comprising the steps of:
(a) conducting a cross-coupling reaction of a bromine, iodine or chlorine substituted fluoride represented by the following formula IX and a substituted amine represented by the following formula X to form a compound represented by the following formula XI according to scheme IV; and 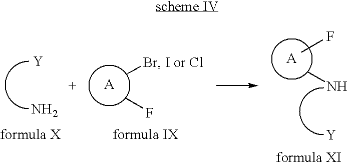
(b) conducting a nucleophilic reaction of the compound represented by the general formula XI, M²Xⁿ and M²Y to form the ligand represented by the formula I;
wherein:
the linkage between Y and NH₂ of the amine represented by formula X is a saturated or unsaturated hydrocarbon or aromatic group with or without substituents;
M² is a metal selected from the group consisting of Li, Na and K; and wherein preferably is K; and
A, n, Xⁿ and Y are as defined in claim 1.

25. The method according to claim 24 comprising the steps of:
(a) conducting a cross-coupling reaction of 1-bromo-2-fluorobenzene and N,N-dimethylethylenediamine to form N-(dimethylaminoethyl)-2-fluoroaniline; and
(b) reacting N-(dimethylaminoethyl)-2-fluoroaniline and KPPh₂ to form the ligand N-(dimethylaminoethyl)-2-diphenylphosphinoaniline;
wherein Ph represents phenyl group.

26. A method for synthesizing the ligand according to claim 1 comprising the steps of:
(a) conducting a cross-coupling reaction of a compound represented by the following formula XII and a compound represented by the following formula XIII to form a compound represented by the following formula XIV according to scheme V; and 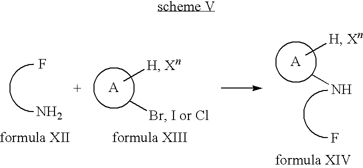
(b) conducting a nucleophilic reaction of the compound represented by the general formula XIV and M²Y to form the ligand represented by the formula I;
wherein:
the linkage between F and NH₂ of the compound represented by formula XII is a saturated or unsaturated hydrocarbon or aromatic group with or without substituents;
M² is a metal selected from the group consisting of Li, Na and K; and
A, n, Xⁿ and Y are as defined in claim 1.

27. A method for synthesizing the ligand according to claim 1 comprising the steps of:
(a) conducting a cross-coupling reaction of a substituted amine represented by the following formula X and a compound represented by the following formula XV to form a compound represented by the following formula XVI according to scheme VI; and 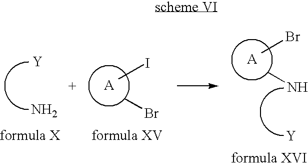
(b) reacting the compound represented by the general formula XVI with a base and then with Hal⁵Xⁿ to form the ligand represented by the formula I;
wherein:
the linkage between Y and NH₂ of the amine represented by formula X is a saturated or unsaturated hydrocarbon or aromatic group with or without substituents;
Hal⁵ represents halogen; and
A, n, Xⁿ and Y are as defined in claim 1.

28. The method according to claim 27, wherein the base is BuLi, ⁱPrMgCl or Mg, wherein ⁱPr represents isopropyl.

29. A method for synthesizing the ligand according to claim 1 comprising the steps depicted below:

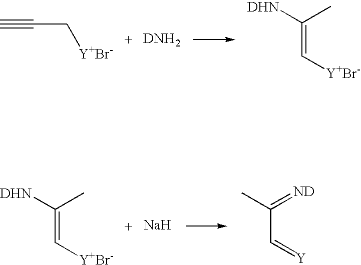

30. The method according to claim 29 comprising the steps depicted below: 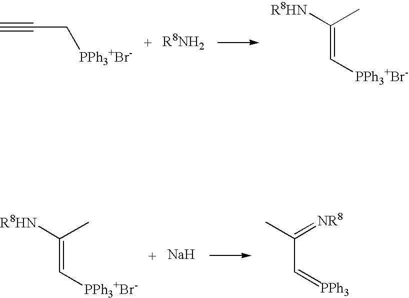
wherein R⁸ is selected from the group consisting of 2,6-C₆H₃ⁱPr₂, 2,6-C₆H₃Me₂, Ph, and t-butyl group.

31. The method according to claim 30 further comprising the steps depicted below: [chemical structure]
